(19) United States
(12) Patent Application Publication
(10) Pub. No.: US 2011/0105346 A1
(43) Pub. Date: May 5, 2011

(54) Universal fingerprinting chips and uses thereof

(76) Inventors: Kenneth L. Beattie, Crossville, TN (US); Rogelio Maldonado-Rodriguez, Mexico City (MX); Alfonso Mendez-Tenorio, Mexico City (MX); Armando Guerra-Trejo, Mexico City (MX); Emma Reyes-Rosales, Mexico City (MX)

(21) Appl. No.: 11/884,390

(22) PCT Filed: Feb. 14, 2006
(86) PCT No.: PCT/US06/05161

§ 371 Date: Aug. 14, 2007

Related U.S. Application Data
(60) Provisional application No. 60/652,832, filed on Feb. 14, 2005.

(51) Int. Cl. C40B 30/04; C40B 50/00; C40B 40/06

(52) U.S. Cl. 506/9; 506/23; 506/16

(57) ABSTRACT

The present invention discloses a designing strategy for constructing a set of probes useful for analyzing all or most prokaryotic and eukaryotic genomes. A set of capture probes with optimal fingerprinting properties and highly representative of all possible sequences of an organism can be selected by six sequential steps. Fingerprinting potential of such probes is validated by phylogenetic analysis, which generates results that strongly correlate with phylogenetic trees produced by sequence alignment. The probes generated by the instant methods can be used for detecting an organism, for establishing phylogenetic relationships between different organisms, for detection of single nucleotide polymorphisms and a wide variety of other applications that require genetic analysis.

### CROSS-REFERENCE TO RELATED APPLICATIONS

This U.S. national stage application is filed under 35 U.S.C. 363 and claims benefit of priority under 35 U.S.C. 365 of international application PCT/US2006/005161, filed Feb. 14, 2006, now abandoned, which claims benefit of priority under 35 U.S.C. 119(e) of provisional U.S. Ser. No. 60/652,832, filed Feb. 14, 2005, now abandoned.

Computer program listings are submitted on compact disc in compliance with 37 C.F.R. §1.96 and are incorporated by reference herein. A total of two (2) compact discs (including duplicates) are submitted herein. The files on each compact disc are listed below, but are in text format:

| Files | Size (KB) | Date Created |
|---|---|---|
| Universal Probe Designer | | |
| BinMasks.pas | 8 | May 13, 2006 |
| Combin. pas | 8 | May 13, 2006 |
| Hash. pas | 12 | Aug. 10, 2007 |
| InitialVal.dat | 4 | May 13, 2006 |
| NNdata.dat | 4 | May 13, 2006 |
| OlgClass. pas | 48 | Aug. 10, 2007 |
| OOPlist. pas | 8 | May 13, 2006 |
| Tools. pas | 12 | Aug. 10, 2007 |
| UniProbe.pas | 32 | Apr. 11, 2007 |
| Universal3.dpr | 16 | Aug. 10, 2007 |
| Probe Resizing | | |
| OlgClass. pas | 48 | Aug. 10, 2007 |
| Resizing1.dpr | 8 | Aug. 10, 2007 |
| Tools. pas | 12 | Aug. 10, 2007 |

### BACKGROUND OF THE INVENTION

1. Field of the Invention

The present invention relates generally to design of microarrays. More specifically, the present invention provides a general strategy for intelligent design of universal fingerprinting chips useful for analyzing all or most prokaryotic and eukaryotic genomes.

2. Description of the Related Art

Microarrays have become indispensable tools for the analysis of genomic data. By means of hybridizing target nucleic acid molecules to arrays of probes tethered to a surface and analyzing the resultant hybridization patterns, comparative analysis of sequences such as detection of specific mutations, identification of microorganisms, fingerprinting of gene expression and verification of sequencing data can be conducted.

Fingerprinting techniques are typically aimed at determining an organism's identity. An effective fingerprinting system should (i) identify the same strain in independent isolates, (ii) identify microevolutionary changes in a strain, (iii) cluster moderately related isolates and (iv) identify completely unrelated isolates. To achieve this goal fingerprinting methods search for similarities and differences between organisms. This analysis can be performed at morphological, physiological, immunological, biochemical or genetic characteristics. Due to extraordinary advances in the knowledge of biological sequences and development of powerful molecular biology techniques, currently most fingerprinting studies are based in DNA analysis.

One group of DNA fingerprinting procedures searches for gel mobility differences between polymorphic sequences. Examples include gel-based single nucleotide polymorphism (SNP) analysis, restriction fragment length polymorphism (RFLP), amplified fragment length polymorphism (AFLP), pulsed field gel electrophoresis (PFGE), random amplified polymorphic DNA (RAPD), repetitive element PCR fingerprinting (Rep-PCR), single strand conformation polymorphism (SSCP), denaturing gradient gel electrophoresis (DGGE), and octamer-based genome scanning (OBGS).

RFLP has been applied to many organisms, including Candida, Cryptococcus, Histoplasma and A. fumigatus. A special class of microsatellite, the trinucleotide repeat sequences such as (CGG)ₙ was exploited in fingerprinting of M. tuberculosis isolates by southern analysis of RFLP. PCR-RFLP is fast, simple and economical but only searches a limited genomic region and does not tell about sequences contained inside the fragments, therefore it has low discrimination. AFLP is based in the polymorphic patterns of electrophoretic bands obtained from DNA restriction followed by ligation of DNA adapters and amplification. This technique is very sensitive and has excellent discriminatory power.

RAPD is a fast and economical fingerprinting method, but it is frequently affected by methodological variations such as the procedure to extract DNA, thermocycler, DNA concentration, annealing temperature, Mg++ concentration, etc. Therefore RAPD requires validation and optimization in each laboratory and for each type of sample.

Repetitive element PCR fingerprinting (Rep-PCR) uses primers directed toward repeated chromosomal sequences and the polymorphism is due to variation in the number of repeats and the distance between contiguous copies caused by DNA insertions or deletions. Amplicon fingerprints represent genomic segments lying between repetitive sequences. Its reproducibility and discriminatory power is inferior to pulsed field gel electrophoresis. A commercial Rep-PCR system that electrophoretically separates rep-PCR amplicons on microfluidic chips and provides computer-generated readouts of results has been adapted for use with Mycobacterium species.

Restriction endonuclease cleavage, followed by hybridization with probes against repeated sequences in bacteria, eg. rDNA probes, can generate relatively complex fingerprint patterns and have been the basis of relatively elegant automated ribotyping systems, such as the Riboprinter Microbial Characterization System marketed by Qualicon (Wilmington, Del.). Because ribosomal cistrons are dispersed throughout the single-chromosome genome of bacteria, endonuclease digests of bacterial DNA will contain multiple fragments of different sizes containing rDNA sequences. Microsatellite and minisatellite primers would be very effective for fingerprinting, since these sequences are usually dispersed throughout the genome. However, as with repeat sequence probes, variability due to high frequency of change in satellite DNA sequences may decrease the effectiveness of the method in clustering moderately related isolates. Amenable repeat sequences for this purpose are found in prokaryotes and eukaryotes. Probes recognizing these repetitive sequences are very useful to confidently reveal polymorphisms.

Octamer-based genome scanning (OBGS) based on PCR amplification of genomic segments that lie between over-represented, strand-biased octamers in the genome has been used to distinguish E. coli 0157:H7 strains in cattle.

Since the DNA fingerprinting methods listed above are looking at DNA fragment sizes, they yield a limited amount of information, with little relationship to full genomic sequences. Therefore information revealed by these methods is rather limited in fingerprinting applications aimed at genomic comparisons, such as establishment of evolutionary or phylogenetic relationships between organisms.

In a second type of DNA fingerprinting method, a library of cloned or PCR-amplified genomic or cDNA fragments is arrayed onto a surface (typically a membrane support), then subjected to multiple cycles of hybridization with labeled synthetic oligonucleotides. This approach was the basis of an early form of sequencing by hybridization, and has been useful for establishing overlapping clones (contigs), identifying new genes, profiling gene expression, and profiling of microbial communities in soil.

In a third type of DNA fingerprinting, the patterns of hybridization of DNA samples on arrays of surface-immobilized probes are compared. The arrayed probes can be sequence-targeted for analysis of known sequences or can be composed of untargeted or arbitrary sequences for analysis of unknown sequences. Such microarray-based methods are generally more informative than fragment length methods, since hybridizations are sequence dependent reactions, probes can sometimes be related to phenotypic characteristics, and thousands of DNA sites can be interrogated in a single assay.

When microarrays are designed for identifying specific groups of microorganisms, the probes are frequently derived from alignments of particular gene sequences from zones showing enough differences to specifically identify each organism. For example, oligonucleotide fingerprinting targeted to 16S rRNA genes has been used to distinguish between bacterial strains. Phylogenetic reconstructions from single sequences, however, may lead to incorrect conclusions about the taxonomy of the microorganisms. Indeed, new insights about taxonomy of microorganisms are currently drawing from complete genome sequences. Hence, microarrays aimed at investigating whole genomes will be of great utility.

In 1997, Beattie proposed the first genomic fingerprinting method using oligonucleotide arrays by a procedure named arbitrary sequence oligonucleotide fingerprinting (ASOF) (U.S. Pat. No. 6,156,502). The technique was based on hybridization of a specific collection of genomic sequences, such as PCR products, on an array of several hundred or a few thousand oligonucleotide probes of arbitrary sequence. DNA sequence polymorphisms would be seen as differences in hybridization fingerprint produced using genomic DNA from different individuals. Beattie and Maldonado-Rodriguez subsequently described a combination of the original ASOF concept with a tandem hybridization technique to enable whole genome or transcriptome fingerprinting (U.S. Pat. No. 6,268,147).

Salazar and Caetano-Anolles (1996) described a fingerprinting approach using arbitrary sequence 9mer probes to distinguish between different enterohemorrhagic isolates of E. coli. In similar work, Chandler's laboratory created an array of 47 nonamer oligonucleotides, selected from a list of 2,000 nonamer microarray capture probes, which were obtained by random computer selection based on the sequence of E. coli K-12 genome and accomplished using traditional composition criteria. These 47 probes occur (on average) 35 times each in the E. coli genome, with nearly the same possibility in both strands. Although only 10 of these probes had diagnostic value, they gave clear fingerprinting differences between 14 organisms tested, including several closely related Xanthomonas pathovars. This approach was subsequently extended using arrays of 192 nonamers to differentiate between S. enterica isolates. Although the arbitrary sequence arrays discussed above represent a good step toward achieving genomic fingerprinting of numerous species using one or a few “universal” microarrays, the probe selection methods used in design of these arrays were insufficiently sophisticated to yield fingerprints with optimal information content.

Belosludtsev et al. (2004) recently described a “universal microarray” consisting of 14,283 12mer and 13mer probes, which was able to differentiate a number of organisms through full genomic fingerprinting. DNA fingerprinting using this microarray probe set has been named Sequence-Independent Genomic Exploration (SIGEX). The SIGEX microarray is restricted in its fingerprinting power due to limitations in probe design. Probe selection based on restrictive [G+C] content (as done in the SIGEX set) rather than on thermodynamic prediction of duplex stability severely restricts sequence diversity represented within the probe set, introduces sequence biases depending on the genome under study, and reduces the specificity of the fingerprint, especially under the nonstringent hybridization conditions used with the SIGEX chip. Failure to apply entropic selection criteria, perform offset (displaced) alignment comparisons between probes, and ensure that base differences between the probes are internal and spaced, further reduces the information content of the SIGEX fingerprint.

Arrays can also be constructed using longer probes, including long synthetic oligonucleotides and amplified genomic DNA fragments. For example, fingerprinting of several Pseudomonas species has been accomplished using an array of 96 genomic fragments (1 to 2 kb long) obtained from four Pseudomonas reference strains. Similarly, an array of 10,000 70-mer oligonucleotides whose sequences were selected from every fully sequenced reference viral genome in GenBank (as of Aug. 15, 2002) was used to identify known and unknown viruses. Other DNA- or RNA-based arrays have been described for specific groups of organisms.

Although oligonucleotide arrays representing all sequences of a given length, such as the full set of 65,536 octamers proposed for sequencing by hybridization, could be regarded as the ultimate form of genomic fingerprinting chip, there are serious disadvantages of this approach. First, such large sets of probes are too expensive for routine, widespread analytical use. Second, in order to achieve unique fingerprints for genomic samples the probe length must be adjusted to accommodate the genetic complexity of a given type of target. For example, any given octamer probe would be expected to occur numerous times within a bacterial genome, and it would require a 12mer or 13mer chip to yield a single hybridization target, on average, for each probe when bacterial genomes are analyzed. It is not currently feasible to fabricate microarrays containing the full set of 4¹² (16,777,216) 12mers or 4¹³ (67,108,864) 13mers for microbial genome fingerprinting. The problem is much worse for fingerprinting of mammalian genomes. Furthermore, since full n-mer chips contain sequences that are repetitive in many genomes, and since their probes have a very wide range of thermal stabilities, additional difficulties in acquiring and interpreting meaningful fingerprints arise. Thus, full n-mer chips are not suitable for most types of DNA fingerprinting.

At present no DNA fingerprinting array containing a manageable number of probes has been designed using a comprehensive set of probe selection criteria that take advantage of latest knowledge of nucleic acid interactions and bioinformatic methods, thereby enabling acquisition of information-rich genomic fingerprints and creation of an optimized universal genomic profiling database. It is therefore desirable to create a series of Universal Fingerprinting Chips which could be used diagnostically in a wide variety of organisms, and provides useful information on phylogenetic or taxonomic relations derived from fingerprinting complete genomes instead of short fragments or partial genomic sequences. Accordingly, the present invention describes a strategy for designing, characterizing and validating such optimized universal fingerprinting chips.

### SUMMARY OF THE INVENTION

The present invention provides a convenient strategy for designing and validating a promising type of universal fingerprinting microarray useful for analyzing all or most prokaryotic and eukaryotic genomes. In one embodiment, there is provided a method of constructing a set of probes capable of analyzing the whole genomes of most prokaryotic and eukaryotic cells. The method comprises the steps of: selecting the length of probes that are appropriate for analyzing a nucleic acid analyte of given genetic complexity; generating a first list of sequences for the probes; selecting a set of desirable compositional parameters, thereby generating a second list of sequences. In general, desirable compositional parameters includes a value for a range of G+C content, lack of internal base repetition longer than a specific length, a value for a reasonable sequential entropy (an arbitrary measure of the sequence's disorder, which takes values from 0 to 1 which corresponds to the less and the more ordered sequence), avoiding the absence of any of the four bases, and avoiding sequences that form loops or dimers. Preferably, the G+C content is set at 35-65%, the sequential entropy value is greater than 0.5, and there is absence of internal base repetition longer than 2 nucleotides.

A strategy named substitution cluster is then applied to the second list of sequences to generate a third list of sequences. In one embodiment, the substitution cluster generates a set of probes that have at least 3 nucleotides differences between each other. After randomizing the third list of sequences, terminal mismatches are removed by a clustering method called block clustering, thereby generating a fourth list of sequences. In one embodiment (for 13-mer probes), the block cluster of such clustering has a block size of 10. After randomizing the fourth list of sequences, tandem mismatches are removed by a clustering method such as refining clustering, thereby generating a fifth list of sequences.

Base substitution is then applied to the fifth list of sequences to improve its mismatch discriminatory power, thereby generating a sixth list of sequences for the probes. In general, the base substitution results in sequences with the same G+C content but have a higher proportion of C and a lower proportion of G.

Thermodynamic principles are then applied to predict the Tm values of the probes when paired with their complements in the target. The sixth list of sequences may then be narrowed by removing sequences with low or high Tm values, thereby generating a seventh and final list of sequences for the probes in which Tm variation is preferably less than 20° C. Alternatively, the sixth list may be divided into subsets of probes with any desired Tm range, to generate list 7a, 7b, 7c, etc., which may be separately used with analyte nucleic acid under different hybridization conditions. Probes having different length but similar predicted Tm values may be combined to generate multilength probe sets with any desired Tm range.

Finally, any given probe set may be subjected to specialized sequence filter steps to remove abundant or repetitive sequence elements known to occur in any given biological sample. For example, it may be desirable to exclude probes that will hybridize with rRNA genes, mitochondrial or chloroplast DNA, Alu and LINE elements, insertion elements, bacterial Rep sequences, etc. Alternatively, probes able to detect species-specific abundant or repetitive sequences can be maintained in the UFC probe set. The final probe sequences can further be validated by virtual hybridization to predict hybridization patterns for a given combination of probes and target sequences. The present invention also encompasses microarrays comprising the probes designed according to the method described above.

In another embodiment, there is provided a method of using the probes generated according to the method disclosed herein to identify a biological sample. Hybridizing nucleic acids from a biological sample with the probes would generate a fingerprint image that can be compared with a database of fingerprints obtained from known samples, to provide identification for the biological sample.

In still another embodiment, there is provided a method of using the probes generated according to the method disclosed herein to define phylogenetic relationships. Nucleic acid samples extracted from a series of biological samples are hybridized with the probes to generate fingerprints, which are compared to each other to create taxonomic trees for the analyzed samples. Additional information relevant to organism identification and for phylogenetic purposes can be obtained by the analysis of G+C % content, A, C, T and G content, gene content, and codon usage reflected by the fingerprint.

In yet another embodiment, there is provided a method of differential gene expression profiling. Hybridizing nucleic acids from two biological samples with the universal fingerprinting probes of the present invention would generate fingerprint images that provide differential gene expression profiling.

In yet another embodiment, there is provided a method of using the fingerprinting probes generated according to the method of the present invention to detect a single base change in a target nucleic acid. Other and further aspects, features, and advantages of the present invention will be apparent from the following description of the presently preferred embodiments of the invention. These embodiments are given for the purpose of disclosure.

### BRIEF DESCRIPTION OF THE DRAWINGS

FIG. 1 shows distribution of the number of occurrences of 12-mers in the Escherichia coli genome. All 12-mer sequences that can be derived from the E. coli genome were generated and then the number of times that each 12-mer was found was counted. The graphic shows the number of 12-mers that were found at different frequencies of occurrence.

FIG. 2 shows the stages and parameters involved in the design of the 13-mer Universal Fingerprinting Chip (UFC-13). Detailed number of probes, design parameters and Tm ranges are described in each step of the design process.

FIG. 3 shows the distribution of Tm values at different stages of the 13-mer UFC design. The Tm range of the complete collection of 13-mer was 54° C. and it was reduced, to 24° C. before trimming and to 17° C. after trimming, in each successive stage of the design process. The Tm distribution was not normal. The Tm distribution of the whole complete set of 13-mer seems to be bimodal; however, at the last stages a distribution with four peaks emerged, which seems to be associated to the occurrence of 5, 6, 7 and 8 [G+C] out of 13, respectively.

FIG. 4 shows Tm distribution for the probes of the UFC13 whole set and the subsets a, b, c, and d. As it can be observed this particular distribution has four peaks. Subsets a (red), b (yellow), c (green) and d (blue) have a Tm distribution whose mean values coincide with the peaks of the whole UFC Tm distribution.

FIG. 5 shows Tm vs free energy for 13-mer probes of the UFC13 probe set. The colors correspond to subsets a, b, c and d. Each of these subsets has a Tm variation of approximately 4.3° C.

FIG. 6 shows the general steps of designing universal fingerprinting chips.

FIG. 7 depicts the strategy of substitution clustering. An available probe is designed as mark of the cluster. Then the substitution pattern is applied to this sequence. In this example, a substitution mask is used where 0 represents constant positions, and 1 the bases to be substituted. The base to be substituted is replaced by the IUPAC one letter code representing the complementary set of bases (in this case B={A, C, G}). Then a combinatorial approach calculates all combinations of sequences. All obtained sequences in this example have one base of difference with respect to the mark of the cluster, and then they are clustered with it.

FIG. 8 depicts the strategy of block clustering. An available probe is designed as mark of the cluster. A block of contiguous bases and specific length is defined (block C) and extracted. Then all combinations of probes of the same length that share this block are calculated. All obtained sequences in this example will have their differences with respect to the mark of the cluster located in the ends.

FIG. 9 depicts the strategy of refining clustering. As in other clustering strategies an available probe is designed as mark of the cluster. Then a rigorous comparison between the mark and available probes is performed. Sliding of the sequences is performed in order to find the maximum degree of similarity between the probes, which facilitates selection of probes in which the base differences between them are separated rather than occurring in tandem.

FIGS. 10A-10B show the distribution of 13-mer probes following ordered and randomized access to the list of probes. Each probe is identified by a unique numerical representation in base 10. There are 67,108,864 combinations of 13-mer probes. Each rectangle in the figure represents a section of the ordered list containing 1,000,000 of probes and each probe is represented by a blue line. There is a strong tendency of selecting mostly probes at the beginning of the list in the ordered process (FIG. 10A). The distribution of the probes in the randomized cluster is more homogeneous (FIG. 10B).

FIGS. 11A-11B show the distribution of 13-mer probes obtained by ordered (FIG. 11A) and randomized clustering (FIG. 11B). Each bar represents the number of selected probes counted at intervals of 500,000 in the whole list of combinations of probes using their numerical representation as ordering criterion. The red line represents the frequency of probes at the same intervals that was obtained after application of the compositional parameters and before applying the clustering steps.

FIG. 12 shows the effects of sequential entropy on the number of probes selected in the first design step for 9-mer probes. A previous pre-selection was performed to select only probes with 35 to 65% of G+C and to avoid sequences with internal repeats longer than 3 bases. The blue line indicates the number of available probes after selecting only those probes with sequential entropy equal or higher than the values specified in the x-axis. Red and green lines show the number of available probes after substitution cluster using ordered or randomized list of probes respectively.

FIG. 13 shows the Tm distribution of 8-mer probes generated according to the method described herein.

FIG. 14 shows the Tm distribution of 8-mer probes (set 8a) generated according to the method described herein.

FIG. 15 shows the Tm distribution of 9-mer probes generated according to the method described herein.

FIG. 16 shows the Tm distribution of 10-mer probes generated according to the method described herein.

FIG. 17 shows the Tm distribution of 11-mer probes generated according to the method described herein.

FIG. 18 shows the Tm distribution of 12-mer probes generated according to the method described herein.

FIG. 19 shows the filtration rules for inexact sequence comparison. In this example two sequences of the same length (L=13) are compared. The number 1 is used to represent matches between the sequences and 0 for mismatches. In this example the maximal number of allowed mismatches (x) is 3. Then, according to the first rule for filtering, these sequences will share at least a block of contiguous identical bases of size 3 (k-tuple). For the second rule, in a worst-case distribution of mismatches, these sequences share at least two of such k-tuples.

FIG. 20 shows the algorithm of locating potential hybridization sites. Target sequences are hashed to k-tuples and the positions of each k-tuple are stored in a lookup table. Probe sequence is also hashed to k-tuples. In order to calculate the beginning of the hybridization site, when there is a match between a k-tuple of the lookup table and a k-tuple of the probe, the start position of a potential hybridization site, and its binding energy, is calculated by start=j−i+1, where i is the position of the k-tuple in the probe, and j the position of the k-tuple in the target DNA sequence (which is consulted from the lookup table). In this example there are 3 k-tuples at positions (i) 2, 5 and 8 of the probe, which match with k-tuples of the target DNA sequence at positions (j) 6, 9 and 12. All of them give a start=5. Therefore there are 3 hits between k-tuples of the probe and k-tuples of the target in a site that starts at position 5. The hits are stored in a separate table of hits. When the number of hits equals or exceeds the cut-off values, these positions are stored separately as potential hybridization sites.

FIG. 21 shows the algorithm used to estimate secondary structure between probes and potential hybridization sites. M and N are used to designate each sequence. Both sequences are placed in an anti-parallel form in order to check the pairing properties between bases. m and n are used to identify positions in sequences M and N respectively. ParM and ParN designate nearest-neighbor doublets for sequences M and N. Match1 is the result for the comparison of the first base pair in a nearest-neighbor doublet, which can be true (match) or false (mismatch). Similarly Match2 is the result for the comparison of the second base pair. Matching patterns and their positions are used as flags to identify a particular substructure by means of a decision table, which is used to assign the correct free energy value associated to it. Here TableNN is the table of nearest-neighbor interactions values, and Len is the length of the duplex. It must be noted that the present algorithm does not consider bulges in the predicted structures, which can be produced when gaps are introduced in the alignment.

FIG. 22 shows predicted hybridization patterns produced with a program called MicroarrayPic. In the first panel the predicted signals of hybridization of a DNA sequence against an array of probes are showed with colored spots. The color intensity is proportional to the predicted free energy value. In order to compare two fingerprints, different colors are assigned to the reference sequence (green) and the test sequence (red) and then both images are superimposed. Signals shared by both fingerprints are showed as spots with the resultant mixture of colors (yellow in this case). Signals present only in the reference or in the test arrays will maintain their original color.

FIG. 23 shows the algorithm used to verify hybridization signals shared by two fingerprints of possible related sequences that are produced by binding of the probes at homologous sites. In this example, the probe 5′-TTCATCAGTGTC-3′ (SEQ ID NO: 1), hybridizes against positions 2314 and 2420 of sequences A and B respectively. Then the sequences of these sites are extended by a defined number of bases to the left and right sides (10 bases for each side in this example). If the number of matches in the whole resultant region exceeds a convenient threshold value, then the probe is considered to hybridize on homologous sites in both sequences (a convenient length for the extension can be estimated from proper statistical considerations).

FIG. 24 shows HPV phylogenetic tree reconstructed from virtual hybridization data with 13-mer probe subsets a, b, c and d (containing 3357, 4268, 4523 and 3116 probes, respectively). This is a consensus tree derived from the trees obtained with each probe subset. The numbers in the nodes indicate the reproducibility percentage of each branch in each of the phylogenetic trees.

FIG. 25 shows phylogenetic tree reconstructed from virtual hybridization data of an 11-mer probe set against HPV, SIV and HIV complete genome sequences. At the right, the HPV sequences are grouped in a perfectly separated group. The group to the left includes all HIV and SIV sequences that are known to be closely related. The 11-mer probe set used in this case contains 1820 probes and has a Tm range from 41° C. to 67° C. (calculated at [Na⁺]=0.115M and [oligo]=0.001M).

FIG. 26 is a flowchart protocol for molecular identification of organisms with the universal fingerprinting chip (UFC). Sample preparation can be done in several alternative pathways (A, B, C and D): A and B are routes for DNA samples while C and D are routes for mRNA samples.

FIG. 27 shows four types of fingerprints and applications of universal fingerprinting chip reference database (UFC-RDB). Four types of fingerprints can be acquired using the universal fingerprinting chip (UFC): (i) normal fingerprints; (ii) in silico substractive fingerprints which can be used to identify microorganisms in a sample contaminated with human DNA; (iii) additive fingerprints which is useful in identifying two microorganisms in a co-infected sample; and (iv) differential expression fingerprints which are associated with phenotypic differences or differential cellular responses due to the presence of disease, toxins, environment contaminants, drugs etc. At the bottom are some of the main areas of applications in which the UFC diagnostics potential can be applied, and for which specific reference databases should be constructed.

FIG. 28 shows detection of single nucleotide polymorphism (SNP) with the ZipCode (ZC) strategy. A SNP, such as C/T SNP is searched. Target DNA is used as template to ligate two oligonucleotides. The first oligonucleotide is a chimeric sequence containing a stretch of bases complementary to target sequence plus a sequence complementary to the ZipCode sequence (anti-ZipCode). A second fluorescent-labeled oligonucleotide hybridizes in tandem to the first oligonucleotide on target DNA. Base variations associated with the point mutations are placed at the end of the first chimeric oligonucleotide next to the junction with the labeled probe. Ligation and denaturing steps are consecutively done before incubating the resulting labeled probe to an array comprising the ZipCode sequence. Array positions at which fluorescent signal are detected will reveal the presence of homozygous or heterozygous SNP sequences. An important advantage of this procedure is the possibility to repeat the annealing, ligation and denaturing steps in multiple cycles prior to hybridization to the array to increase the amount of ligated (fluorescent) product and therefore to proportionally increase the sensitivity of the detection. Many different SNPs can be searched simultaneously without false detection reactions and without the need to label the target DNA. The huge collection of diverse sequences in the universal fingerprinting chip of the present invention could be used to search thousands of SNPs in a single assay.

FIG. 29 shows detection of DNA using universal fingerprinting probes as adapter on color-coded beads. A collection of different “color-coded” beads are joined to specific ZipCode (ZC) probe sequences. Specific target DNA sequences can be detected through respective anti-ZipCode-anti target oligonucleotides hybridization. Identity of the bound target sequence is then spectroscopically “decoding”.

FIG. 30 shows purification of DNA or RNA using ZipCoded beads. Beads upon which ZipCode (ZC) sequences are tethered are mixed with anti-ZipCode oligonucleotide annealed to sample containing target nucleic acid DNA to be purified. The bead/anti-ZipCode/DNA complex is separated from the mixture and washed, and finally the DNA is isolated by denaturation. Glass beads can be separated from the mixture by gravity; magnetic beads can be separated using a magnet; and other beads can be separated by filtration through a membrane or fitted material. Appropriate oligonucleotide lengths can be used to purify only the target DNA. By repeating the above procedure, many other different DNA sequences can be purified sequentially.

FIG. 31 shows simultaneous purification of numerous targets using zipcode and manifold. Arrays of many different ZipCode (ZC) oligonucleotides can be covalently attached to membranes or flitted materials, e.g. within individual regions in the 96-, 384- or 1536-well format. A sample containing many DNA sequences to be purified is incubated with the corresponding oligonucleotide adapters (chimeric oligonucleotides comprised of a sequence recognizing a specific target plus a particular anti-ZipCode (aZC) sequence). The product is incubated with the membrane under annealing conditions. After washing the DNAs can be eluted from isolated manifold cells under denaturing conditions.

FIG. 32 is a flow chart of selecting probes for a cluster associated fingerprinting chip.

FIG. 33 is a comparison between distances derived from extended score using different threshold values and distances derived from whole genome sequence alignments. Virtual hybridization was performed with UFC 8-mer and the distances were calculated from the extended scores using an alignment extension of 10 and thresholds values of 11 and 16. Genome sequences were aligned with the program Clustal W 1.83 and distances are calculated as p-distances.

FIG. 34 shows phylogenetic trees derived from fingerprint analysis (panel a) versus genome sequence alignment (panel b) for HPV sequences. Fingerprint analysis was performed with virtual hybridization prediction of the UFC 8-mer using extended match scores (extension=10 and threshold=16).

FIG. 35 summarizes the general strategy used for calculating cut-off values.

FIG. 36 shows the free energy distribution for the hybridization of a probe set allowing a defined number of mismatches. The whole Tm variation of the probes in subset E (derived from the complete 13-mer UFC) is only 1° C. The figure also illustrates the placement of convenient cut-off values for allowing only defined number of mismatches.

FIGS. 37A-37D display virtual hybridization fingerprints of Mycoplasma pulmonis UAB CTIP (gi 15828471) which has 963,879 bp and 16.64% [G+C] and Mycobacterium avium subsp. paratuberculosis strain k10 (gi 41406098) having 4,829,781 bp and 69.30% [G+C], obtained using the 13mer UFC. FIG. 37A shows the VH fingerprint for Mycoplasma pulmonis, FIG. 37B shows the VH fingerprint for Mycobacterium avium subsp. paratuberculosis, FIG. 37C displays the superposition of date for the two species, and FIG. 37D summarizes the data.paratuberculosis.

FIGS. 38A-38D display virtual hybridization fingerprints of Bacillus anthracis and Bacillus cereus, obtained using the 13mer UFC. FIG. 38A shows the VH fingerprint for B. anthracis, FIG. 38B shows the VH fingerprint for B. cereus, FIG. 38C displays the superposition of data for the two species, and FIG. 38D summarizes the data.

FIGS. 39A-39D display the virtual hybridization data for both strands of the Escherichia coli genome, considering one strand at a time and considering both strands combined. Shown are three images for the fingerprints obtained with E. coli K12, FIG. 39A representing the direct strand (Genbank sequence submission), FIG. 39B representing the complementary strand, and FIG. 39C showing the superposition of fingerprints of both strands. FIG. 39D shows a brief description of the fingerprint analysis for E. coli indicating the number of matches on each strand and the number of signals shared.

FIGS. 40A-40B illustrate a general tandem hybridization embodiment of the UFC. An unlabeled nucleic acid sample is hybridized with the UFC, together with a collection of labeled oligonucleotide “stacking probes.” If the hybridization is carried out under conditions (typically, elevated temperature) where neither the surface-immobilized UFC probes, nor the labeled stacking probes will form a stable duplex with the target strands (FIG. 40B), but where the longer duplex comprising UFC probe hybridized in tandem with stacking probe is stable due to the stacking interactions between the two contiguously hybridized probes (FIG. 40A), then the pattern of hybridization across the array will reflect the tandem occurrence of UFC probes and labeled stacking probes within the target nucleic acid sequence.

FIGS. 41A-41B are representative genomic fingerprints obtained with bacterial genomic DNA. FIG. 41 shows the Corynebacterium diphtheriae genomic fingerprint obtained using the original “12K” UFC probe set. FIG. 41B shows the Corynebacterium diphtheriae genomic fingerprint obtained using the “complementary” UFC probe set.

FIGS. 42A-42B compare Tm variation with the free energy of original and resized probe set. FIG. 42A shows the variation of the Tm vs the free energy for the original set of 13-mer probes consisting of 85,000 probes with an initial Tm range from 53.9° C. to 65° C., i.e. a™ difference of 11.1° C. FIG. 42A shows the variation of the Tm vs the free energy for the resized set.

### DETAILED DESCRIPTION OF THE INVENTION

As used herein, “universal fingerprinting chip” refers to an oligonucleotide microarray containing a wide diversity of probe sequences, capable of producing unique, diagnostic fingerprints when hybridized with a wide variety of genomic samples. As used herein, “virtual hybridization” refers to the prediction of the pattern of hybridization of a defined microarray of oligonucleotide probes, when interrogating a nucleic acid target of defined sequence, wherein said prediction is based upon the thermodynamics of oligonucleotide duplex formation and said pattern of hybridization is output as a listing of binding sites with associated predicted thermal stabilities for each oligonucleotide probe within the entire nucleic acid target, or alternatively, as a simulated pattern of hybridization signals. As used herein, “mismatch” generally refers to two opposing bases within a nucleic acid duplex structure which do not comprise a normal Watson-Crick base pair, however the term may also refer to probes containing base differences. As used herein, “terminal mismatch” refers to a base mismatch positioned at a strand terminus within a duplex nucleic acid structure formed by hybridization of an oligonucleotide probe to a single-stranded nucleic acid target. As used herein, “internal mismatch” refers to a base mismatch positioned internally within a duplex nucleic acid structure, separated from the closest strand terminus by at least one normal Watson-Crick base pair. As used herein, “tandem mismatches” refers to two or more base mismatches positioned adjacent to each other within a duplex nucleic acid structure. As used herein, “spaced mismatches” refers to two or more base mismatches within a duplex nucleic acid structure, separated from each other by at least one normal Watson-Crick base pair. As used herein, “sequential entropy” refers to an arbitrary scale (from 0 to 1) of degree of order within a nucleic acid sequence, such that the value “0” corresponds to the most highly ordered (repetitive) sequence and the value “1” corresponds to the least ordered (nonrepetitive) sequence. As used herein, “randomization” refers to the procedure of mixing the list of probes at random. As used herein, “substitution cluster” refers to a strategy for grouping probe sequences, which are derived from a probe known as the cluster mark by substituting a defined number of bases in all possible positions. As used herein, “block cluster” refers to a strategy for grouping probe sequences, all of them sharing a block of contiguous bases of a defined length, in all possible positions. As used herein, “refined cluster” refers to a strategy of grouping similar probe sequences after a rigorous comparison is performed.

A novel strategy for designing a universal fingerprinting chip is described below. It was proposed during the 1980s that a microarray containing all 4ⁿ possible oligonucleotides of length n could be used to perform complete sequencing of DNA molecules in an approach called Sequencing by Hybridization (SBH). Although several technical difficulties have prevented using this technology for de novo sequencing of DNA, the technique is still useful for resequencing or for global comparison of DNA sequences. Comparison of microarray fingerprints can be used easily to identify differences between sequences, and similarities of fingerprints can be used to estimate phylogenetic or taxonomical relations of the sequence sources.

Previous theoretical works for estimating the most convenient sizes of probes that can be used to interrogate complete genome sequences indicated that probes ranging from 10- to 16-mer could be useful for investigating most prokaryotic and eukaryotic genomes. However, information obtained from such microarrays can be difficult to interpret, and it must be taken in account that a considerable fraction of the probes do not have convenient properties to provide useful information in most of the cases.

Several factors such as thermal stability and content of sequence information can affect hybridization process. Thermal stability of duplexes depends on nucleotide sequence, chain length and concentration, as well as the identity of counterions. It is possible to find optimal hybridization conditions for specific binding of any given probe with its target molecule, but when the hybridization is carried out with numerous probes and target molecules (as with microarrays) a loss in specificity can occur. This problem could be especially dramatic with a microarray containing all 4ⁿ combinations of probes of length n where the difference of thermal stability of the probes varies widely. Several probes in this array will provide specific signals, but many others will yield ambiguous signals due to formation of imperfect matched hybrids, whereas some others will not hybridize at all even if their target sequences are present because hybridization is carried out at conditions where their duplexes are not stable.

Some sequences are expected to occur more frequently than others; for example, repeated sequences are in general expected to occur randomly at higher frequencies than non-repeated sequences. A 4ⁿ microarray will include a variety of sequences such as AAAAAAAAA (SEQ ID NO: 2) or GCGCGCGCGC (SEQ ID NO: 3) or, even worse, several variants of them with minimal differences that will not provide more useful information. An optimal design of a universal microarray should include only sequences with appropriate characteristics. Therefore, desirable properties for the probes included in a universal fingerprinting chip are: similar thermal stability; lack of repetitions of a defined size; reasonable level of sequence entropy; and convenient degree of dissimilarity between all the probes of the chip.

### Estimation of Proper Probe Size

An important factor for the design of probes to be included in a universal fingerprinting chip is the probe size. Ideally a hybridization fingerprint should produce a moderate number of hybridization signals with respect to the total number of probes in the array (e.g. 37%; Beattie, 1997). If the majority of array elements produce hybridization signals with each DNA target then the differences between nucleic acid samples will be inefficiently detected. In contrast, if hybridization occurs only with a small fraction of the array elements then each hybridization pattern will contain little useful information, and the estimation of similarity between patterns can be biased by stochastic errors.

Based on the size of the genomes to be analyzed, statistical estimations can be conducted to predict the most appropriate probe size for the universal fingerprinting chip. If we consider DL as the average target sequence interval (in number of bases) between expected occurrences of a probe sequence of length n within a nucleic acid target containing bases A, C, G and T equally and randomly distributed, then DL can be evaluated by:

DL=4ⁿ

The above equation can be used to calculate the length of probes that should have a single perfectly paired hybridization site, on average, within a particular genome. For example, the Escherichia coli genome is approximately 4.6 million by long. Therefore, an array in which each probe has a single complement, on average, within each strand of this genome should be constituted by probes that appear once each 4,600,000 bases. The length of such probes can be calculated by rearrangement of the above equation:

n=log DL/log 4=log(4,600,000)/log(4)≈11mer

Thus, 11mer probe sequences would be expected to randomly occur about once, on average, within each strand of the E. coli genome. If both strands are considered, the calculated value of n is 11.57, so the probe length yielding one occurrence, on average, within the E. coli genome would be between 11mer and 2mer.

Another statistical tool for helping select the appropriate UFC probe length for fingerprinting a given nucleic acid sample is the Poisson distribution equation. When the average number of random occurrences per interval=m, the probability P of a occurrences in the interval is:

P(a)=e^{-m}[m^{a}/a!].

Thus, from the Poisson distribution equation, for a probe that occurs once, on average, within the sequence interval DL (m=1),

the probability of 0 occurrence P(0) is e^{-1[}1⁰/0!]=0.368

the probability of 1 occurrence P(1) is e^{-1[}1¹/1!]=0.368

the probability of 2 occurrences P(2) is e^{-1[}1²/2!]=0.184

the probability of 3 occurrences P(3) is e^{-1[}1³/3!]=0.061

. . . etc.

From the above statistical considerations, it is predicted that for a probe length giving, on average, one occurrence within the total length of target sequence, about 37% of the probes will have no complement within the target, about 37% will have one complement, about 18% will have two complements, about 6% will have three complements, etc. It is evident from these calculations that the probe length should preferably be biased somewhat toward fewer hybridization signals (longer probe length) to avoid having too many signals representing multiple hybridization events. For the E. coli genome example, the appropriate probe length therefore appears to be at least 12 bases.

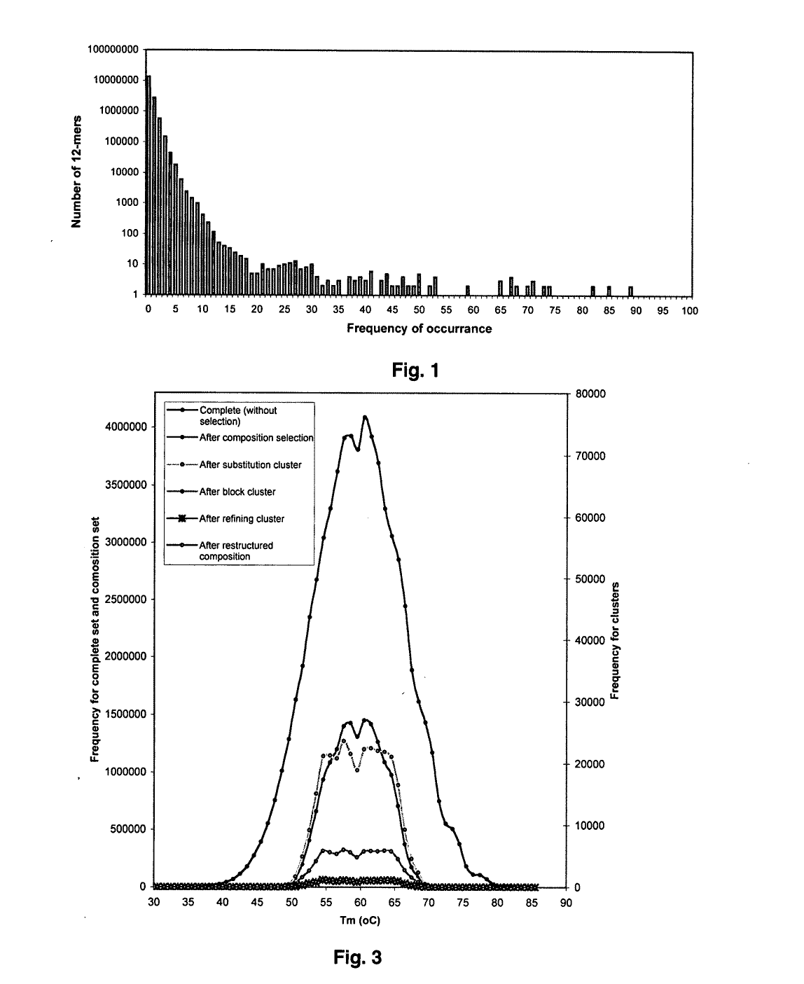

A detailed analysis of the distribution of 12-mer probes in one strand of E. coli genome is shown in FIG. 1, and Table 1 proposes some convenient probe sizes for fingerprinting of particular genomes. However, these calculations are only approximate due to the simplified assumptions about genome composition; it must be considered also that the base composition of genomes varies widely and that there is preferential use of some sequences. Furthermore, since some hybridization signals will inevitably involve base mismatches, the 13mer UFC may well be appropriate for fingerprinting of bacterial genomes. The actual optimum UFC probe length for fingerprinting samples of various genetic complexities will need to be determined experimentally in the laboratory using the actual UFC probe sets. As the number of full genomic sequences becomes greater, the actual oligonucleotide occurrences within different genomes may be taken into consideration in the design of UFCs with maximal fingerprinting efficiency.

### Important Composition Assumptions

Thermal stability is a very important factor to be considered in the selection of probes, and stability of the hybridization must be estimated to evaluate the overall performance of the microarray. Before working on a detailed calculation on the thermal stability of the probes, a filtering step needs to be done in order to eliminate probes that do not posses desirable fingerprint properties. Therefore, the following compositional parameters are applied to the whole set of probes of a given size to select only those sequences having desirable properties: content of 35% to 65% of G+C; lack of internal repetitions longer than 2 nucleotides; a reasonable sequential entropy; avoid the absence of any of the four bases; avoid those sequences forming loops or dimers. These criteria are oriented to obtain a set of sequences with a narrow thermal stability range, which is approximately determined by their G+C plus A+T content. Avoiding internal repetitions, low sequential entropy and the absence of any of the bases are required to ensure that the probe set will have a high sequence variability that permits their use in a wide array of genomes.

The sequential entropy concept described here is somewhat different from the concept of entropy H from the information theory that is frequently used for analysis of sequences in bioinformatics. Such entropy is calculated with the equation:

$$H = - {\sum }_{i}^{n} {p}_{i} {log}_{2} {p}_{i}$$

where n is the number of different symbols present in a sequence and pᵢ is the probability of occurrence of the symbol. A limitation of this concept of entropy is that it is only based on the composition on the sequence, not in the sequence itself. As a result, sequences with identical composition but having different sequence will have the same entropy. For this reason an arbitrary concept of sequential entropy is implemented to describe the degree of disorder in a given sequence. It goes from 0 to 1, where 0 corresponds to the most ordered sequence and 1 to the most disordered. Sequential entropy (H_{seq}) is calculated for a specific sequence by dividing the number of different nearest neighbors (Nₙₙ) by the length of the sequence (n) minus 1 (total number of neighbors):

$$Hseq = \frac{{N}_{nn}}{n - 1}$$

The nearest neighbors (Nₙₙ) counts only how many neighbors composed of different bases are present, e.g. AT, AC, AG, etc., but AA, TT, CC and GG are not counted. This number does not consider the frequency of the dimer. For example, for the sequence GGAGAGAGAGAA (SEQ ID NO: 3), this sequence has only two different neighbors composed of different bases: AG and GA, whereas GG and AA are ignored (see Table 2). Table 2 illustrates the calculation of sequential entropy for several sequences. Empirically, it has been determined that a value of more than 0.5 in sequential entropy is reasonable for probes used in universal fingerprinting chip.

The original number of sequences is drastically reduced by the application of these compositional parameters described above. For example, after applying composition parameters for selecting only those sequences having a 35 to 65% G+C content plus the absence of repeated sequences longer than 3 nt and having a sequential entropy equal or higher than 0.6, the complete set of 67,108,864 possible 13-mer sequences is reduced to 16,283,432 (23%).

Finally, it is suggested that sequences that are capable of forming hairpin loops or dimers be avoided, particularly when long probes are used. For the case of 13-mer probes, however, the maximal length of a complementary section (stem) of a loop is 5 bp. The free energy of such structure is not sufficient to permit the formation of such type of structures at hybridization conditions proposed for the universal fingerprinting chips. For this reason the formation of loops is not a critical issue in this case. Nevertheless, the formation of dimers could still be problematic during the step of depositing the probes onto the chip substrate. In such cases, a verification of formation of dimers can be determined easily to avoid those sequences that can potentially form this type of structure.

### Selection of Highly Discriminatory Sequences

By random sampling of sequences with desirable compositional parameters, a probe set with high sequence variability can be selected. However, it is preferable to select only probes having a defined minimum number of sequence differences. For example, in 13-mer sequences the selection can include only those probes showing more than two base differences among them. This selection can be further improved by subsequently eliminating those probes having contiguous base differences and those probes having their differences at their ends. Under these conditions, the number of signals due to ambiguous hybridization is minimized. Lowered ambiguous hybridization would enhance the specificity of the array.

Probes with a high degree of specificity are selected by a clustering strategy. A cluster is a group containing all the available sequences that share a particular feature with respect to a given sequence (for example a defined degree of similarity). The sequence that defines each cluster is the “mark” of the cluster. After grouping all the combinations of sequences of a given length in clusters, the collection of cluster marks will constitute a new set of sequences that does not share the property used to define the clusters. For example, if the criteria for grouping the sequences is the similarity of probes, the sequences included in each cluster will have a minimum degree of similarity with its mark. However, each mark will have less similarity when compared with each other. Three clustering criteria can be used to construct universal fingerprinting chip with probes having the desired discriminatory properties: substitution clusters, block clusters and refined clusters.

SUBSTITUTION CLUSTERS: For the design of the 13-mer universal fingerprinting chip, the sequences clustered under this criterion will share one or two differences with the mark of the cluster to which they are grouped. Therefore, the resultant collection of cluster marks will include probes that are different in at least three bases between each other.

BLOCK CLUSTERS: Once a set of probes with a defined number of bases is selected, an additional procedure is implemented to eliminate those sequences having the differences located at their ends. This is a very important feature because terminal mismatches usually are less destabilizing than internal mismatches. Therefore this step contributes to decrease the cases of ambiguous hybridizations. In the case of 13-mer probes, this criterion is applied to sequences that have three differences between each other (although this number of differences can be customized). The 13-mer probes are clustered with probes that share the same sequence block of 10 nucleotides with the mark of the cluster. All these probes will have their three differences located at the ends. The resultant collection of cluster marks includes only probes with internal sequence differences.

REFINED CLUSTERS: Some tandem mismatches show a stabilizing effect, and double and triple tandem mismatches are usually more stable than spaced mismatches. Therefore, tandem mismatches are an important contribution to the production of ambiguous hybridization, and it is important to avoid probes whose differences are contiguous. A refining cluster is implemented where the probes are grouped identifying first the most similar probes to the mark of the cluster and then those with differences located contiguously. The resultant collection of cluster marks thus comprises probes with minimized tandem mismatches.

It should be noted that for the case of 13-mer probes, after the substitution cluster, the most similar sequences in the collection of cluster marks will have at most three differences. Then, the criterions to avoid terminal or tandem mismatches are only verified for the most similar cases. This is because when less similar probes are compared it is impossible to avoid sequence differences located contiguously or at the ends. For example, two completely different sequences will inevitably have all their differences contiguously and located at the ends.

### Effect of Accession Order in Building Clusters

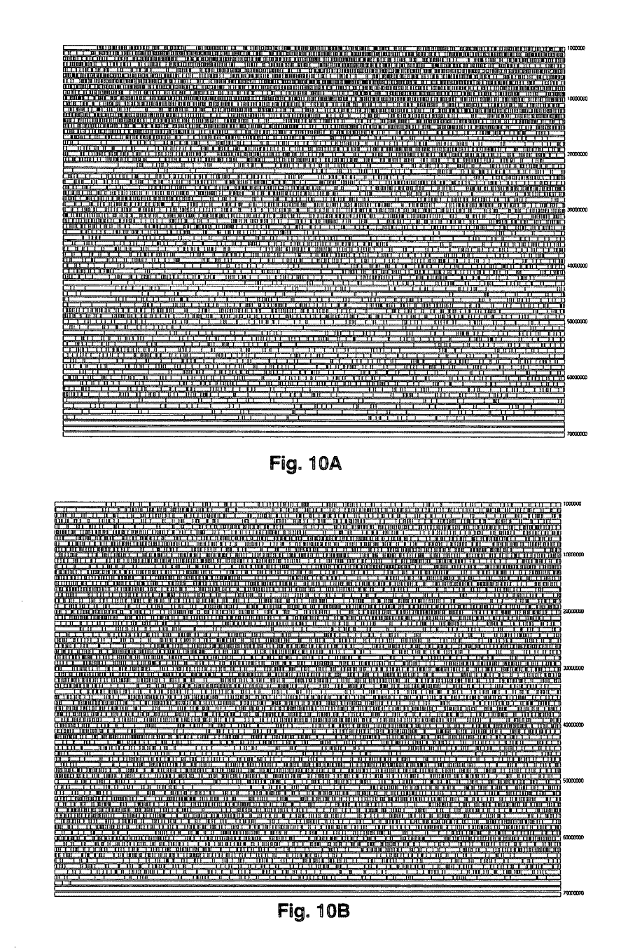

The original list of probes is ordered using a numeric representation where each probe is associated with a unique integer value that is calculated from its sequence (Waterman, 1995). When the procedures are performed by accessing the probe list in order, a biased clustering selection tendency occurs that causes irregular representation of sequences in the group of cluster marks. In other words, there is a tendency to select those sequences located near the beginning of the list (they are overrepresented) and to exclude those at the end of the list (they are underrepresented), and the resultant collection does not represents all the possible sequences. This biased effect is especially important during the block and refined clustering. Therefore, in order to obtain a collection of probes with a uniform base composition, the list of sequences was randomized prior to the construction of these clusters. It must be noted that, when this step was applied a more uniform base composition was obtained as expected; however, a diminution in the number of selected sequences was observed. FIGS. 10 and 11 show a distribution of the selected probes of the 13-mer universal fingerprinting chip following ordered and randomized access to the list of probes with respect to the complete list of combinations of 13-mer sequences.

### Rearrangement of Bases Increases the Discriminatory Power of Probes

A fundamental element in estimating the sequence discriminatory power of probes is the instability caused by base differences recognized by each probe. The stability values for base mismatches in all the possible sequential contexts were used as criteria to improve the discriminatory power of probes used in the universal fingerprinting chip. The discrimination of base mismatches is a main property that permits reliable identification of sequences. Determination of discriminatory potential for each base is done under the nearest-neighbor (NN) model for predicting thermal stability for oligonucleotides. Recently published collection of NN parameters includes stability values for internal mismatches in all the alternative sequential contexts.

Using these data Tm values for all possible combinations of sequences can be calculated. For example, Tm differences between perfectly paired and mismatched sequences can be calculated for the following set of oligonucleotide duplexes:

| | |
|---|---|
| 5′-GATCG-(X M Y )-CGATC-3′ | (SEQ ID NO: 4) |
| 3′-CTAGC-(Xc Mc Yc)-GCTAG-5′ | (SEQ ID NO: 5) |

where X-Xc and Y-Yc are always perfectly paired and M-Mc can take all possible combinations including matched and mismatched cases. These Tm differences can be used as a measure of the mismatch discrimination power of the probes. The higher the Tm difference, the better the mismatch discrimination power. Table 3 lists the Mean General Discriminatory Values (MGDV) for each type of mismatch. The results indicate that the MGDV decreases in the following order:

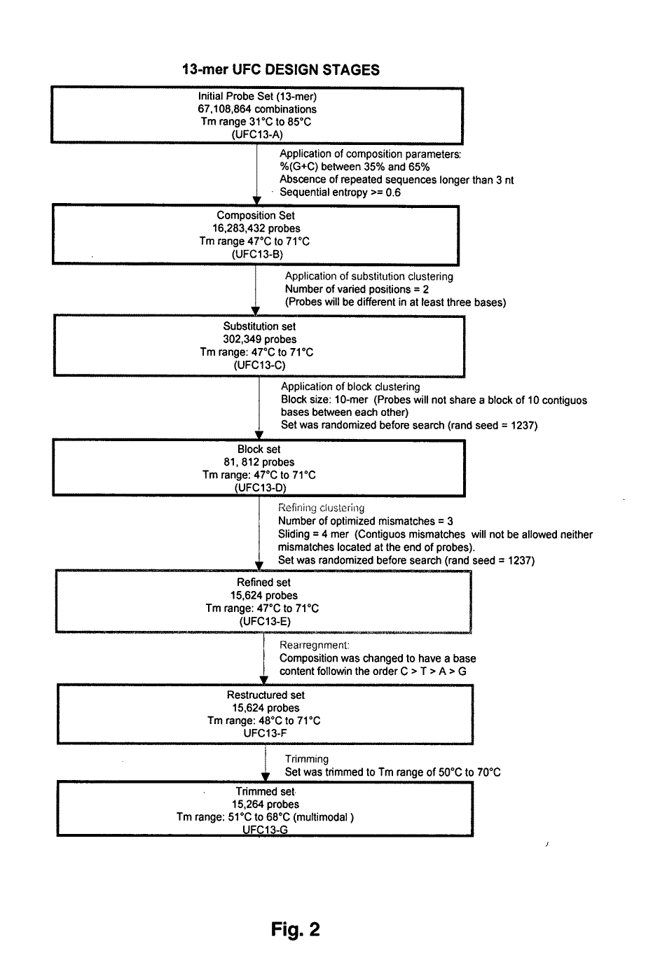

C:H=11.4° C.>T:B=8.2° C.>A:V=7.5° C.>G:D=6.3° C.

where H={A,C,T}, B={C,G,T}, V={A,C,G} and D={A,G,T}. Therefore, in general those probes harboring a higher content of C will have better mismatch discrimination capabilities than probes with higher content of other bases. Hence, the sequences of the probes are rearranged in order to obtain a higher proportion of C and a lower proportion of G to attain a higher general discrimination power while maintaining their original G+C content. A detailed description of all the steps and parameters involved in the selection of 13-mer UFC design is shown in FIG. 2.

### Tm Distribution

Several interesting properties of the 13-mer probe sets were observed. FIG. 3 shows the Tm distributions of 13-mer sequences obtained at the beginning and after each selective step. Tm values depend on the oligonucleotide and salt concentrations, but despite of the conditions used to calculate the Tm by means of the nearest-neighbor model, a similar effect can be observed. Initially, the whole collection of combinations of 13-mer probes had a Tm variation from 31° C. to 85° C., i.e. a range of 54° C. Interestingly, this Tm distribution was not normal, instead it seems to be bimodal, and as described later, this Tm distribution is determined by the base composition of the probes. After the application of the composition parameters described above, the Tm varied from 47° C. to 71° C., lowering the range to 24° C. This Tm variation was not changed during the following selective steps. Finally the probe set was trimmed to have a final Tm variation of 51° C. to 68° C., i.e. a Tm range of 17° C. The Tm distribution exhibited four peaks at the last design stage.

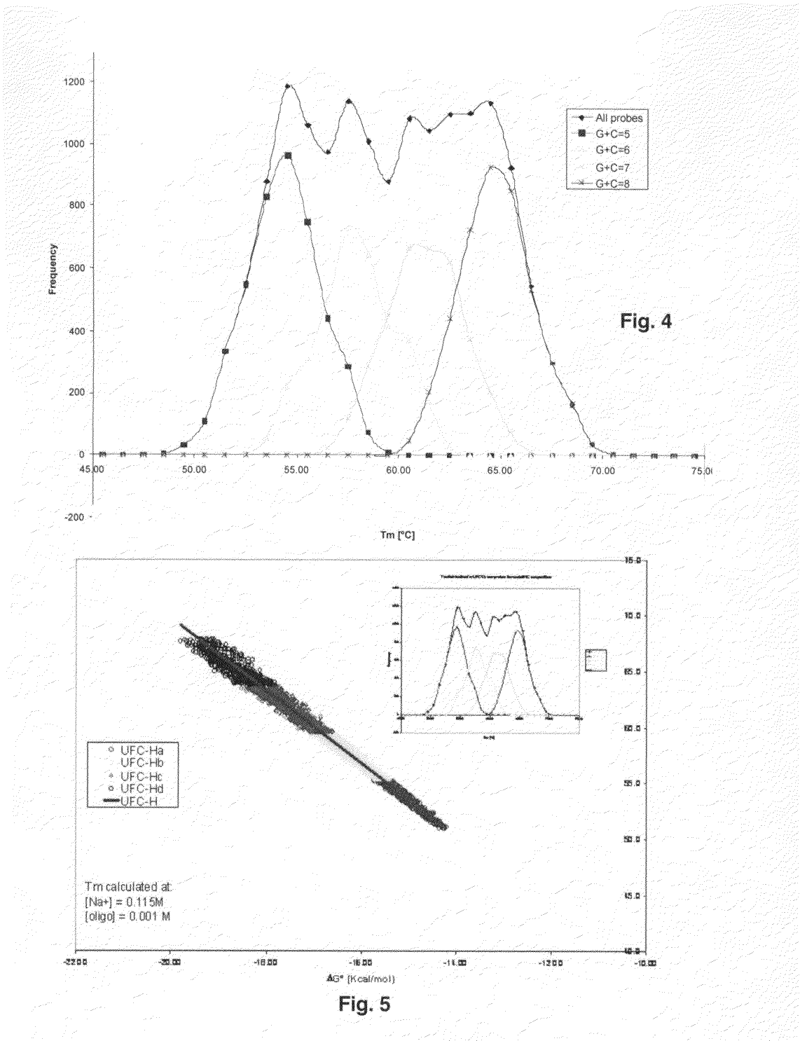

If the collection of 13-mer probes is classified by their G+C and A+T content, four groups with the following base content are obtained: 5(G+C)+8(A+T); 6(G+C)+7(A+T); 7(G+C)+6(A+T) and 8(G+C)+5(A+T). The Tm variation of each group was determined and shown in FIG. 4. These four peaks have a strong correlation with the mean Tm values for each base distribution. This result suggests that the final set of probes can be divided in subsets according to their Tm variation and therefore their G+C content.

### Simulation of Hybridization Process by Virtual Hybridization

Free energy values for perfectly matched sequences are directly associated with Tm value (FIG. 5). The Tm range of 17° C. for the final 13-mer probe set is too wide for practical hybridization purposes. Therefore, this final probe set is divided into four subsets each with an approximate Tm variation of 4.25° C. In each subset the hybridization reaction can be carried at a temperature two degrees below the minimal Tm of the subset. Under these conditions, all the probes should form duplexes that are perfect or contain low numbers of mismatches. In order to predict a reliable hybridization pattern at the conditions employed in the experiments, a recently developed software tool capable of predicting expected hybridization patterns can be used. This computer program known as Virtual Hybridization (VH) calculates thermal stability values at sites where hybridization can potentially occur. The Virtual Hybridization was conceived as a method to locate potential sites on target DNA sequence where hybridization with a probe can occur. These sites are identified using only similarity criteria, defining a minimum number of total complementary bases or a minimum length of contiguous complementary bases between the probes and the target DNA sequences. A rigorous calculation of thermal stability values is performed between the probe and target sites using the Nearest-Neighbor model that includes mismatch data, and the VH parameters are adjusted in order to show only sites with high probability of hybridization such that a predicted virtual hybridization pattern is obtained. The algorithm takes in account that terminal mismatch have different stability values than internal mismatches.

The present invention uses an improved version of virtual hybridization (V.02) which includes an accelerated algorithm as well as drawing options to show predicted fingerprint images of hybridization of any genomic DNA against a universal fingerprinting chip probe set. Green and red colors (fluorophores) are used to compare two hybridization patterns and the intensity of the color is directly related to the stability of the hybridization. When the patterns are compared they can be overlapped, so a yellow color will be obtained when a signal is observed in both patterns, whereas green or red color is observed for hybridization signals produced in only one target DNA sample. A similarity score of the fingerprints can also be calculated using different criterions. Therefore, the virtual hybridization is a very powerful tool to predict hybridization patterns even when ambiguous hybridization occurs.

### Alternate Designs and Applications of Universal Fingerprinting Chip

a) Design of Universal Fingerprinting Chip Derived from Mapping:

A variant of the universal fingerprinting chip can be obtained with the collection of probes arising from a 13-mer mapping of a desired group of genomes. The same criteria of probe selection described above can be applied, but also some additional considerations can apply, for example the search of probes shared between different genome sequences.

### b) Increasing the Number of Probes by Lowering the Number of Base Differences

Another possibility is to design probes with only two or even one base difference that will generate a much larger number of probes while still keeping good specificity and discriminatory power. The complexity (and cost) of these sensors will be proportionally higher. However, these chip variants may be appropriate for fingerprinting of low complexity genomes such as viral genomes.

### c) Increasing the Number of Probes by Augmenting the Size of the Probes:

The size of the probes can be augmented to 14-, 15-, 16-, 17- or even 18-mer. The total number of probes in these sensors will increase in good proportion. These chips would be useful especially for gene expression analysis because the number of probes can be high enough as to statistically yield several probes for each gene, and their specificity will be very good. Therefore, these chips can be used simultaneously for fingerprinting and for gene expression analysis. These sensors will maintain good specificity and discriminatory power under appropriate stringent conditions. These chips may be appropriate for fingerprinting of genomes of high complexity. In these cases, the number of base differences can be augmented to 4, 5 or even 6 to increase the discriminatory power and have a reasonable number of probes.

### d) Adjusting to Similar Tm Values:

In another design, probes with selected Tm values can be decreased or increased in size to 11, 12 14, 15, 16 or even 17 nucleotides to reach Tm values similar to that of the 13-mers selected, thereby, the full probe array may be used in a single hybridization condition, including use of higher stringency to increase the specificity.

### e) Hybridization in a Temperature Gradient:

Similar to those used in determining the best Tm values for PCR reactions, some technological improvements to the hybridization system have been proposed, such as a system capable of producing a temperature gradient that will be useful for controlling the hybridization conditions of universal fingerprinting chip.

### f) Using Each Universal Fingerprinting Chip Probe as a ZipCode (Busti et al., 2002):

For specific recognition of thousands of other molecules, such as proteins attached to ZipCode or for joining to a unique fluorescent sequence for specific detection and purification.

### g) Universal Fingerprinting Chip for Gene Expression Analysis:

By enlarging probe size to 15 or 16-mer and in combination with consensus sequence analysis, universal fingerprinting chip can be used for gene expression analysis. SNPs, short sequence changes, DNA crossing-over, or alternative splicing associated with diseases or important phenotypic characteristics can also be detected simultaneously with genes by tandem hybridization. Universal fingerprinting chips for identifications of regulatory sequence, analysis of mitochondrial DNA for identification of individuals, and species-specific arrays comprising groups of probes specific for certain organisms can also be developed. Also, the long pursued objective for microarray technology: sequencing by hybridization approach may be realized since one of the most difficult technical problems of this approach, ambiguous hybridization, can now be solved with the help of tools such as virtual hybridization.

A “complementary strand” UFC can be specified, comprising probes pairing with the opposite strand. Since the fingerprint will usually be acquired using double stranded genomic DNA, the use of a complementary UFC probe set will serve to verify the fingerprinting results and enhance the specificity of the hybridization signals. For example, relatively stable G•T or G•A. mismatches in one strand will correspond to relatively unstable C•A or C•T mismatches in the opposite strand, respectively. Thus, if both the original and complementary UFC probe sets are used, mismatch discrimination will be improved and the information content of the combined fingerprint will be enhanced.

All programs described herein have been incorporated in a program called UFCdesigner, which was written with the programming software Borland Delphi 7.0 (Borland Software Corporation). They have been successfully tested in the following WINDOWS operating systems: MILLENIUM, 2000 and XP. Linux versions have been developed using Borland KYLIX DESKTOP 1.0 (Borland International), and have been tested in LINUX RED HAT 7.3, FEDORA CORE 2 and MANDRAKE 10. The phylogenetic reconstructions of distance data using the nearest-neighbor algorithm were conducted in PHYLIP 3.6 alpha 3 (Felsenstein, 1989, 2002). Phylogenetic trees were also drawn using MEGA 2 (Kumar et al., 2001) and TREEVIEW (Page, 1996). Some statistical analysis of data was conducted with MICROSOFT EXCEL 2000 (Microsoft Corporation).

In one embodiment of the present invention, there is provided a method of constructing a set of probes capable of analyzing the whole genomes of all or most prokaryotic or eukaryotic cells. The method comprises the steps of: selecting a length for the probes; generating a first list of sequences for the probes; selecting a set of desirable compositional parameters, thereby generating a second list of sequences; applying substitution cluster to the second list of sequences, thereby generating a third list of sequences; randomizing the third list of sequences; removing terminal mismatches by a clustering method, thereby generating a fourth list of sequences; randomizing the fourth list of sequences; removing tandem mismatches by a clustering method, thereby generating a fifth list of sequences; performing base substitution to the fifth list of sequences, thereby generating a sixth list of sequences for the probes; and narrowing the range of Tm by removing sequences with low or high Tm values, thereby generating a seventh and final list of sequences for the probes. The seventh list of sequences may be further edited by removing sequences that are predicted to hybridize with repetitive sequences known to exist within genomes. The final probe sequences can further be validated by virtual hybridization. In general, the probes can be DNA, RNA, or PNA.

In one embodiment of the above method, a set of 13-mer probes suitable for analyzing the whole genomes of most prokaryotic and lower eukaryotic organisms is generated. A set of 15,264 capture probes, highly representative of all possible (67,108,864) 13-mer sequences and having optimal fingerprinting properties was selected by six sequential steps: 1) selection of compositional parameters such as a G+C content between 35 and 65%, absence of internal repeats and a convenient sequential entropy; 2) exclusion of probes having only one or two differences between them; 3) randomization followed by elimination of probes having differences at their ends; 4) randomization followed by discarding probes having consecutive differences; 5) base substitution to improve the mismatching discriminatory power in the probe set; and 6) trimming of probes with extremely low or high Tm values. The resultant set has a Tm distribution with four peaks that are correlated with the number of G+C. This set was rearranged to improve their mismatch discriminatory power and finally it was trimmed to obtain a set with a Tm variation of 17° C. The set was subdivided into four groups each with a Tm range of about 4.2° C. which is very convenient for the experimental strategies. When convenient, the set can be further subdivided into groups with shorter Tm range.

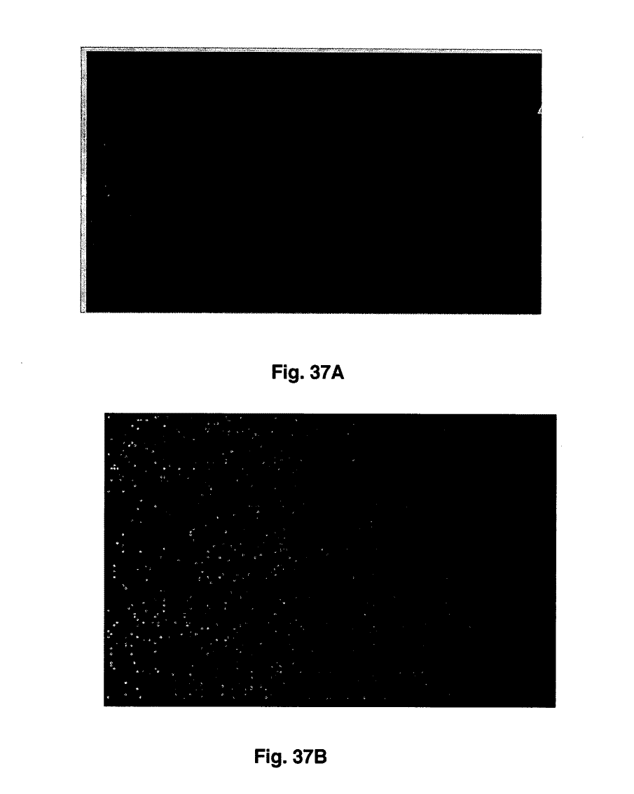

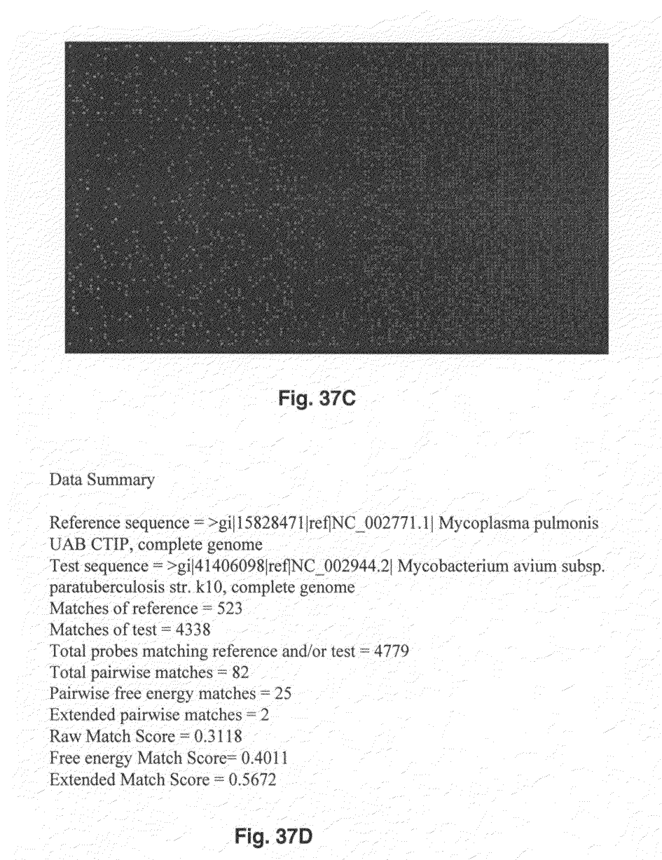

The fingerprinting potential of the 13-mer universal fingerprinting chip (UFC-13), calculated as 10^{4,594}, was tested in complete viral genomes and bacterial genomes obtained from GenBank. Genomic HPV fingerprints were obtained by virtual hybridization and phylogenetic trees were constructed. A strong correlation with phylogenetic trees produced by sequence alignment was observed. Moreover, fingerprinting analysis on a mixture including HPV, HIV and SIV viruses produced a phylogenetic tree with two perfectly separated, species-related regions while keeping the currently proposed topologies for these viruses. Virtual fingerprints were also obtained with bacterial genomes (FIGS. 37-39) and phylogenetic relationships were established from virtual hybridization results. Therefore, it is theoretically validated that the universal fingerprinting chip of the present invention has a high sequence discriminatory power. Examples of programs that can be used to estimate phylogenetic relationships from such fingerprints are Phylip 3.6, MEGA3 and UPMA.

In one embodiment the probes generated by the methods described supra can be immobilized on a microarray substrate for genetic analysis. In a related embodiment the microarray further comprises a set of probes complementary to these probes. As explained above the fingerprint for any organism will usually be acquired using double stranded genomic DNA, and so the use of a complementary probe set will serve to verify the fingerprinting results and enhance the specificity of the hybridization signals.

In another embodiment the present invention provides a method of identifying species within a biological sample, comprising (a) preparing a nucleic acid sample from the biological sample; (b) labeling the nucleic acid sample; (c) hybridizing the labeled nucleic acid sample with probes generated according to the method described above; (d) detecting and quantifying the label bound to each probe to generate a fingerprint image; and (e) comparing the fingerprint image with a reference data set, wherein results from the comparison would identify the species in the biological sample. Preferably in this method the probes are bound to a microarray substrate. The probe set is augmented by addition of a complementary probe set as described above. DNA or RNA samples can be used in this method.

In yet another embodiment is provided a method for identifying species within a biological sample, comprising (a) preparing a nucleic acid sample from the biological sample; (b) hybridizing the nucleic acid sample with probes generated according to the methods described above; (c) using a DNA polymerase and fluorescently tagged 2′,3′-dideoxynucldoside triphosphate substrates to incorporate fluorescent tags onto the 3′-ends of these probes; (d) detecting and quantifying the label incorporated into each probe to generate a fingerprint image; and (e) comparing the fingerprint image with a reference data set, wherein results from the comparison would identify the species in the biological sample. In this method the arrangement of probes and samples that can be analyzed are as described supra. In a related embodiment, different fluorescent tags can be used to simultaneously generate multiple fingerprints that are distinguishable from each other via the fluorescent label.

In a further embodiment the instant invention provides a method of identifying species within a biological sample, comprising (a) preparing a nucleic sample from the biological sample; (b) hybridizing the nucleic acid sample with the probes generated according to the methods described above with a mixture of labeled stacking probes designed to hybridize in tandem with these probes; (c) optionally covalently linking tandemly hybridizing probes using DNA ligase; (d) detecting and quantifying the label incorporated into each probe to generate a fingerprint image; and (e) comparing the fingerprint image with a reference data set, wherein results from the comparison would identify the species in said biological sample. In this method the arrangement of probes and samples that can be analyzed are as described supra. This method can utilize either the entire set of stacking probes or a subset thereof. In a related embodiment different fluorescent labels are incorporated into different subsets of stacking probes to simultaneously generate a multiplicity of distinguishable fingerprint images. For example, four different sets of stacking probes, each bearing a different fluorophore, can be mixed together and used to yield four distinguishable fingerprints in a single hybridization reaction. This “multi-color” strategy greatly increases the information content of a fingerprint. In a further embodiment of this method, the hybridization conditions are selected such that the tandem hybrids in which two probes hybridized to the target strand adjacent to each other in a contiguous stacking configuration are stable but isolated probes do not stably hybridize to the target.

In another embodiment of the present invention, there is provided a method of using the universal fingerprinting probes disclosed herein to define taxonomic and phylogenetic relationships between biological samples. DNA is extracted from a series of biological samples, then labeled and hybridized with the universal fingerprinting chip to yield hybridization fingerprints, which are compared with each other to construct phylogenetic trees for the organisms under study. The arrangement of probes is as described supra.

In yet another embodiment of the present invention, there is provided a method of using the universal fingerprinting probes disclosed herein to identify a biological sample. Nucleic acids (e.g. DNA or RNA) are isolated from the biological sample and hybridized with the fingerprinting probes to generate a fingerprint image. Comparing the fingerprint image with a reference data set would provide identification for the biological sample. The arrangement of probes is as described supra.

In still another embodiment, there is provided a method of using the universal fingerprinting probes disclosed herein to analyze differential gene expression. Nucleic acids (cDNA or RNA) derived from two biological samples are hybridized with the fingerprinting probes to generate two fingerprint images. Comparing the fingerprint images with each other would provide differential gene expression. The arrangement of probes is as described supra.

In yet another embodiment, there is provided a method of detecting a single base change in a target nucleic acid. Fingerprinting probes generated according to the method of the present invention are first attached onto a solid support such as a microarray substrate. Target nucleic acid is hybridized with a first oligonucleotide probe comprising (i) a first end comprising sequences complementary to the probes attached to the solid support, and (ii) a second end comprising a nucleotide complementary to the single base change in the target nucleic acid. A labeled second oligonucleotide probe is also annealed to the target nucleic acid, wherein the second oligonucleotide probe is ligated to the second end of the first oligonucleotide probe. The labeled ligated product is then hybridized with the probes attached to the solid support, wherein detection of the labeled product on the solid support would indicate the presence of the single base change in the target nucleic acid. In general, the second oligonucleotide probe can be labeled with a tag well known in the art, e.g. a fluorescent or chemiluminescent label. In this embodiment the probes to be attached to the solid support are selected by performing virtual hybridization of the probes generated according to the method described supra against the nucleotide sequences comprising the target nucleic acid sample to identify members of the oligonucleotide probe set which may hybridize to the nucleic acid sample; and eliminating from the set of oligonucleotide probes to be attached to the solid support those probes that are predicted to stably hybridize with the nucleic acid sample.

TABLE 1
Estimated Probe Sizes For Fingerprinting of Different Genomes

| | | Number | probe |
|---|---|---|---|
| Organism | genome size (bp) | of genes | size (mer) |
| Human papillomavirus | 9,000 | 6 | 8 |
| Escherichia coli | 4,639,221 | 4289 | 12 |
| Saccharomyces cerevisiae | 12,000,000 | 5400 | 13 |
| Homo sapiens | 3.2 × 10⁹ | 35,000 | 17 |
| | 6.4 × 10⁷(coding) | 35,000 | 14 |

TABLE 2
Comparison of Sequential And Shannon's Entropies

| | | | I | II | III | IV | V |
|---|---|---|---|---|---|---|---|
| | | | AACCGGTT | AAAAAAAA | ACACACAC | ACGTCGTA | ACAGTCGA |
| | | | SEQ ID | SEQ ID | SEQ ID | SEQ ID | SEQ ID |
| Numeric | Dimer | Weight | NO: 6 | NO: 7 | NO: 8 | NO: 9 | NO: 10 |
| 0 | AA | 0 | 1 | 7 | | | |
| 1 | AC | 1 | 1 | | 4 | 1 | 1 |
| 2 | AG | 1 | | | | | 1 |
| 3 | AT | 1 | | | | | |
| 4 | CA | 1 | | | 3 | | 1 |
| 5 | CC | 0 | 1 | | | | |
| 6 | CG | 1 | 1 | | | 2 | 1 |
| 7 | CT | 1 | | | | | |
| 8 | GA | 1 | | | | | 1 |
| 9 | GC | 1 | | | | | |
| 10 | GG | 0 | 1 | | | | |
| 11 | GT | 1 | 1 | | | 2 | 1 |
| 12 | TA | 1 | | | | 1 | |
| 13 | TC | 1 | | | | 1 | 1 |
| 14 | TG | 1 | | | | | |
| 15 | TT | 0 | 1 | | | | |

| | | | | | |
|---|---|---|---|---|---|
| Probe length | 8 | 8 | 8 | 8 | 8 |
| Relative sequential order | +++ | +++++ | ++++ | ++ | + |
| Number of neighbors | 7 | 7 | 7 | 7 | 7 |
| # Neighbors with | 3 | 0 | 2 | 5 | 7 |
| different bases (weight = 1) | | | | | |
| Sequential entropy = | 0.43 | 0.00 | 0.29 | 0.71 | 1.00 |
| Shannon's entropy (bits) | 2.81 | 0.0 | 0.99 | 2.24 | 2.81 |

TABLE 3
Mean General Discriminatory Values (MGDV)
(° C.) For All Possible Mismatches

| Mismatch | On complementary strand | On direct strand |
|---|---|---|
| G: G | 6.8 | 6.8 |
| G: A | 7.7 | 4.0 |
| G: T | 8.2 | 4.4 |

MGDV for G: D mismatch = 6.3

| | | |
|---|---|---|
| C: C | 13.5 | 13.5 |
| C: T | 12.4 | 8.7 |
| C: A | 12.0 | 8.3 |

MGDV for C: H mismatch = 11.4

| | | |
|---|---|---|
| A: C | 8.3 | 12.0 |
| A: A | 6.5 | 6.5 |
| A: G | 4.0 | 7.7 |

MGDV for A: V mismatch = 7.5

| | | |
|---|---|---|
| T: T | 7.8 | 7.8 |
| T: G | 4.4 | 8.2 |
| T: C | 8.7 | 12.4 |

MGDV for T: B mismatch = 8.2

The following examples are given for the purpose of illustrating various embodiments of the invention and are not meant to limit the present invention in any fashion. The present examples, along with the methods, procedures, treatments, molecules, and specific compounds described herein are presently representative of preferred embodiments. One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

### Example 1

### Numeric Representation of Probes

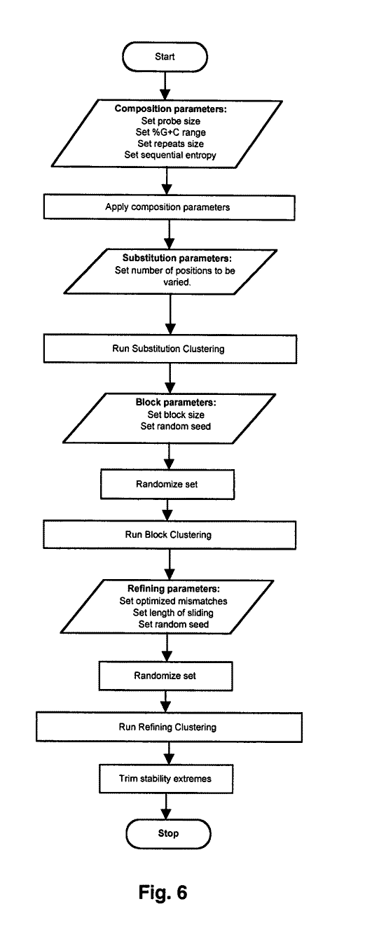

The following examples describe the algorithms and software tools used for designing universal fingerprinting chips. The design of probes is aimed at maximizing the variability and specificity of the probe set while maintaining high discriminatory potential. General steps of designing universal fingerprinting chips are shown in FIG. 6.

An important issue of the algorithms is the numeric representation of sequences. A specific numeric representation is assigned to each probe sequence. This number is a unique integer value which is calculated from the sequence assuming that A=0, C=1, G=2 and T=3. Therefore, each probe sequence is equivalent to a numeric value in base 4, which in turn is converted to a number in base 10 (the numeric representation of the probe). In this way each probe sequence has a unique numeric value between 0 and 4^{L}−1, where L is the length of the probe. This numeric representation of short sequences has been described (Waterman, 1995).

All possible combinations of probe sequences of a defined length are maintained in binary tables with random access, which means that these tables can be accessed from any row (in contrast to sequential access, where the access requires looking first at all previous rows). In this table each probe is identified by its numerical representation, which is identical to the row number in this table. Therefore, the access to these lookup tables can be performed very fast because when the probe sequence is known, its numeric representation can be used to rapidly find it in the table. A collection of object-oriented libraries are provided which contain methods to automatically convert probe sequences to their numeric representation and vice versa and the tables only hold the numeric values of probes. The binary or lookup tables of probes also include fields to indicate the availability of the probe and the number of cluster to which it has been assigned during the clustering procedure. During the clustering procedure, if any probe has already been assigned to a particular cluster, it is marked as non-available.

### Example 2

### Overall Clustering Strategy

A clustering strategy is used to produce a set of probes where all the probes are different in at least a minimum number of bases defined by the user. This strategy consists of searching an available probe in the table. This sequence is marked as the n-mark of the n-cluster and is stored in an independent table of cluster marks. Then the remaining available probes in the table are compared with this n-mark using any of the similarity criteria described above. If a probe exhibits a similarity with the n-mark, then it is assigned to the n-cluster and is marked as non-available. Once all available probes are compared and clustered with the n-mark, a new (n+1)-mark for a new (n+1)-cluster is selected from the remaining available probes, and the procedure is repeated. This strategy is performed until all probes in the table have been clustered and marked as non-available. Probes contained in the resultant table of marks will not share the similarity criteria used to build the clusters when they are compared with each other.

### Example 3

### Substitution Cluster

When probes are clustered under this criterion, a cluster is integrated by all those probes which have a maximal number of base differences (substitutions) with respect to the mark of the cluster when probes are aligned and compared along their entire lengths.

As the classical procedures for character comparison between strings are very time consuming, a different strategy was implemented to locate all those similar probes to the mark of the cluster. In this strategy all general substitution patterns for a probe of a defined length are calculated considering the maximal number of base differences. These patterns show all base substitutions that must be produced in the sequence of a probe (the cluster mark) to generate a new sequence that is now different in a defined number of bases. For example, if 0 represents the constant positions and 1 the positions to be varied, the substitution patterns (masks) of one and two bases that can be made from a 5-mer probe are:

| | | | | |
|---|---|---|---|---|
| 00001 | 00100 | 01000 | 01100 | 10010 |
| 00010 | 00101 | 01001 | 10000 | 10100 |
| 00011 | 00110 | 01010 | 10001 | 11000 |

Then the number of substitution patters (Nₚₐₜₜ) for a probe of length L, where at most x-positions are varied can be calculated by the formula:

$${N}_{patt} = {\sum }_{k = 1}^{x} {C}_{L}^{k} = {\sum }_{k = 1}^{x} \frac{L !}{k ! ( L - k ) !}$$

where C_{L}^{k} is the number of combinations in which at most k substituted positions can be distributed in a probe of length L.

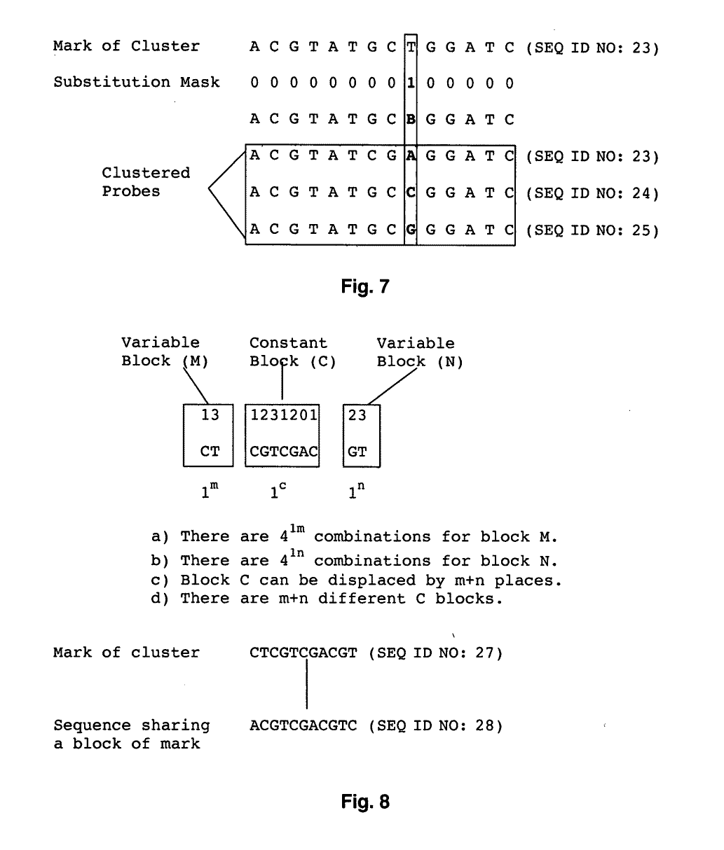

Using these substitution patterns, a combinatorial procedure is used to calculate all sequences that are different in at most m-bases with respect to the mark. In this combinatorial approach, a base to be substituted according to a given pattern is replaced by a letter that represents the “complementary” set to that base (see FIG. 7). For example, if the selected base is A, then the complementary set of bases will be C, G and T. For the sequence ACTAAGTAT (SEQ ID NO: 11), a sequence ADTABGTAT (as represented by SEQ ID NOS: 12-20 below) is obtained after using the substitution pattern 010010000. Then, a recursive combinatorial algorithm is used to calculate all possible combinations of sequences where the one-letter codes are replaced by the bases that they represent. For this example if D={A, C, T} and B={C, G, T}, the next nine combinations of probes are:

(SEQ ID NOS: 12-14)
AATACGTAT AGTACGTAT ATTACGTAT
(SEQ ID NOS: 15-17)
AATAGGTAT AGTAGGTAT ATTAGGTAT
(SEQ ID NOS: 18-20)
AATATGTAT AGTATGTAT ATTATGTAT

All these probe sequences are translated to their numerical representation and then they are located in the lookup table of probes to be clustered and marked as non-available. This procedure is repeated until all the substitution patterns are evaluated and substituted.

### Example 4

### Block Cluster

Under this clustering criterion the probes are grouped by selecting all those probes most similar to the mark of the cluster, and have their differences located at the ends. A hashing strategy can be implemented to identify all probes that share this property with respect to the cluster mark. In this strategy all sub-sequences of a defined length that can be produced from the probe used as mark are obtained and compared with those sub-sequences obtained from the remaining available probes in the lookup table. Those probes that share sub-sequences with the mark are clustered and marked as unavailable. The complexity of the calculations required for this strategy are of order O(M²), where M is the number of available probes in the lookup table. For this reason the running time of this algorithm is excessive.

Thus, another clustering procedure, faster but yielding identical results, is followed, where blocks of a defined length of contiguous bases are extracted from the sequence of the cluster mark. All blocks of length I_{c} that can be obtained from this sequence are extracted and from each block all the possible probes sequences that share it are calculated with a combinatorial approach. For a probe of total length L, the length of the block to be extracted is l_{c}. This block can be extracted from anywhere in the probe sequence, therefore there are L−l_{c}+1 different blocks that can be extracted from the probe sequence. Then all possible combinations of sequences of length L that contain this block are built. The algorithm directly calculates the numeric values of these sequences. If n_{c} is the numerical representation of block c, for a sequence containing lₘ bases at the left of c and lₙ bases to the right of c such that lₘ+l_{c}+lₙ=L, the numerical representation for all combinations of probes sharing block c can be calculated with:

n_{probe}=(iₘ·4^{L-l}^{ₘ})+(n_{c}·4ⁱ^{ₙ})+(iₙ)

where n_{probe} is the numerical representation of the probe, iₘ can take values from 0 to 4^{lm}−1 and iₙ can take values from 0 to 4^{ln}−1 (see FIG. 8). This clustering method eliminates those cases in which a higher similarity can be found between probes when they are slid between each other (FIG. 3). The derived sequences are located in the table, marked as non-available and assigned to the current cluster. After applying the block clustering strategy the resultant set of marks of clusters will not share blocks of length l_{c} between all of them when compared with each other.

### Example 5

### Refined Cluster

After the selection process of substitution and block clustering, the set of probes will be different in at least a defined number of bases (three bases in the instant case of the 13-mer) and these difference will not be located at the ends. But for cases where the probes are different in exactly this minimal number of bases, some of these differences could be located at contiguous positions. For this reason a refined clustering procedure is carried out in order to select only those probes with non-contiguous differences when they are compared against each other. In order to verify this stage, the user must specify the number of base differences to be optimized (for example three). It is not convenient to optimize a large number of differences because as the number of base differences between two probes increases, it will be impossible to avoid some or all contiguous base differences.

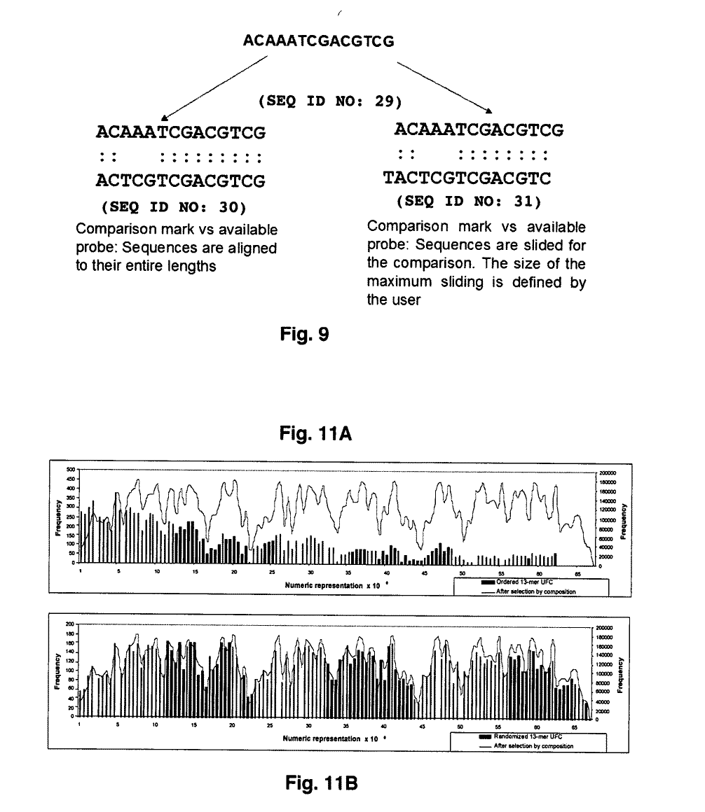

As the number of available probes has been considerably reduced up to this stage, a rigorous comparison between the mark and all the available probes is performed. When the number of base differences between the mark and any probe is equal to the number of differences to be optimized, they are closely inspected in order to check if some of them are contiguous. Probes with contiguous base differences are clustered with the mark and then designated as non-available. After this process of refined clustering, the resultant cluster marks set do not have contiguous base differences for the most similar cases (FIG. 9).

### Example 6

### Base Composition Rearrangements

As described above, base mismatch discrimination power can be estimated using the Mean General Discriminatory Values (MGDV) for each type of mismatch. These values are the average differences in the Tm between matched and mismatched sequences and they decrease in the following order:

C:H=11.4° C.>T:B=8.2° C.>A:V=7.5° C.>G:D=6.3° C.

where H={A,C,T}, B={C,G,T}, V={A,C,G} and D={A,G,T}. Accordingly, those mismatches containing C are more destabilizing than other mismatches and mismatches containing G are, on average, the least destabilizing. Small variations in the base composition of the resultant set of probes cannot be avoided, but this difference in composition can be manipulated conveniently in order to improve the capacity to discriminate against mismatches. If the composition of the resultant set is changed by applying the same base substitution schema, then similarity between the probes is not altered. For example, all Gs can be changed to Cs whereas As can be changed to Ts and vice versa. Bases differences between probes in the set are maintained. However, this change must be such that the G+C and A+T composition are maintained in order to keep their overall thermal stabilities. At this stage the algorithm shows the total number of bases in the resultant set and it warns if the base composition is not in agreement with the MGDV values in order to permit the user to take a decision. The user can manually modify the base composition of the probes, and the user will be warned if the proposed changes alter the A+T and G+C content.

### Example 7

### Randomizing Strategies

Factors such as sequential entropy and the order followed to access the data during the clustering steps determine the number, the base composition and the distribution of probes in the resultant set. Sequential entropy has an important role because it reduces considerably the number of probes with undesirable properties and increases sequence variability. The order of access has an important role in the sequence variability but more importantly, in the distribution of probes. The clustering procedure is said to be ordered if during the clustering procedure the available probe designated as mark of cluster is selected following the original ordering of the probes in the table (with their numerical representations in increasing order), whereas the clustering procedure is said to be randomized if the list of probes is previously disordered.

When the clustering is ordered, there is a strong tendency to select those probe sequences located at the beginning of the list (they are overrepresented) and to exclude those at the end of the list (they are underrepresented). The resultant collection of probes does not homogeneously represent all the possible sequences (see FIGS. 10-11). This effect is avoided when the list of probes is previously randomized. In such case a more uniform base composition was obtained (FIGS. 10-11). The table of probes cannot be directly disordered because this order is important to keep a fast access to the list of probe sequences in the table. Instead, the list of available probes is placed in a separate array and then randomized. In this form, the clustering procedure follows the order dictated in this new list, and the cluster marks are selected by verifying, once a cluster has been concluded, whether the next probe is still available. Most programming languages provide functions to generate random numbers. However, it should be noted that such functions are in reality pseudorandom generators because they use a standard mathematical function to generate the numbers. These mathematical functions in general require a seed, which is a number used to initialize the pseudorandom generator. If the same seed is used then the same series of pseudorandom numbers is produced. An algorithm used to randomize the elements contained in a list of probes can be implemented using techniques described by Cho and Tiedje (2001).

### Example 8

### Tm and Free Energy Calculation

The final stage in designing the universal fingerprinting chip is the calculation of thermodynamic properties of the resultant set, particularly the free energy)(DG°) and the melting temperature (Tm). At the beginning of the selection procedure, the composition was adjusted to select only those probes with a convenient G+C content. This criterion considerably reduces the thermal stability range of the set. A more precise calculation can be performed with the nearest-neighbor (NN) model for thermal stability of short nucleotide sequences. The NN model for nucleic acids assumes that the stability of a given base pair depends on the identity and orientation of the neighboring base pairs. Thus the thermal stability of probes depends not only on base composition but also on sequence of the probe. Parameters for calculating Tm and DG° using the nearest-neighbor model have been published recently. Free energy of probes can be calculated by the equation:

ΔG°=ΔH°−TΔS°

where DH° and DS° are the stacking enthalpy and entropy of the duplex. Tm can be calculated by the equation:

$$Tm = \frac{Δ H °}{Δ S ° + R ln c}$$

where c is the oligonucleotide concentration and R the gas constant (1.987 cal/K mol). Tm must be corrected for salt concentration. DH° is assumed to be salt-concentration-independent whereas DS° can be corrected by:

ΔS°=ΔS°_{1M}+0.368·L·ln [Na⁺]

where ΔS°_{1M} is the stacking entropy calculated at 1M [Na⁺] concentration.

It can be appreciated from these formulae that Tm is also a function of the duplex sequence and salt concentration. In practice, the NN model provides a more precise prediction of the stability of short duplexes than empirical formulas based on the G+C content. Parameters for the nearest-neighbor model have been estimated for duplex formation in solution. It is still not clear how these parameters are affected in hybridization on microarrays where one strand of the duplex is fixed to a surface (especially those terms that refer to volumetric concentrations as the duplex and the salt concentrations). Some authors have shown that the relative stabilities of the duplexes are maintained in such cases. Routines for calculating Tm and DG° of the probes when they hybridize perfectly (without mismatches) against their duplexes are implemented in the object-oriented libraries of the designer program. Ideally, thermal stability of probes should be similar in order to minimize the effect of ambiguous hybridization. As is noted above, the Tm range of the resultant probe set can still be too wide so that ambiguous hybridization is not entirely avoided. However, the nearest-neighbor model permits a reasonable estimation of thermal stability when mismatches are present.

### Example 9

### Construction of Probe Sets for Universal Fingerprinting Chip

Several sets of universal fingerprinting chip probes have been derived with the algorithms described above. Table 4 lists the number of probes obtained at different stages of the design for several n-mer probes. Table 5 shows the selection criteria and features for probes of different sizes. Table 6 shows the number of probes that were selected through all the steps in the design of 13-mer probes, as well as number of probes after ordered and randomized clustering procedures. There was a small increase in the number of probes after randomized clustering. A detailed analysis of the selected probes showed that 7,835 probes begin with A; 3,743 begin with C; 2,137 begin with G and only 1,418 probes begin with T for the probe set obtained with ordered clustering (Table 6). In contrast, for the probe set obtained where the list was randomized before the block and refining cluster procedures, 4124 probes begin with A, 3989 probes begin with C, 3892 probes begin with G and 3619 begin with T (Table 6).

FIG. 10 shows a graphical representation of the distribution of probes after ordered and randomized selection. It is clear from this figure that most of the probes selected using ordered clustering tend to accumulate at the beginning of the list (they are overrepresented) whereas probes selected at the end of the list tend to be underrepresented. In contrast, the distribution of probes in the randomized set is considerably more homogeneous. It should be noted that the final distribution of the selected probes is not totally random because of the restriction imposed on the composition of the probes. However, as it can be seen in FIG. 11, the distribution of the randomized set is very close to the distribution of probes obtained after applying the compositional parameters (G+C content, absence of repeats and sequential entropy), whereas the distribution of the ordered set has a strong tendency to agglomerate at the beginning of the list.

A key parameter in the selection of probes is the sequential entropy H_{seq}. One of the most important aspects of Universal Fingerprinting Chip is its capacity to work with a wide variety of organisms. The proposed design strategy for such fingerprinting chip is intended to obtain a representative probe set derived from all the possible combinations of probes of a given length with maximized sequence variability and hybridization specificity. Sequential entropy is a direct measure of sequence variability for each probe. The sequential entropy concept used in the present invention is different from the Shannon's Entropy (H), a frequent parameter used in evaluating the information content of DNA sequences, which is calculated by the following formula:

$$H = - {\sum }_{i}^{n} {p}_{i} {log}_{2} {p}_{i}$$

where the entropy is the negative sum of the probabilities of all n symbols (pᵢ) multiplied by the logarithm base 2 of the probability of each symbol. Symbols in DNA can be four nucleotidic bases; however, all 16 possible combinations of nearest-neighbors (dimers) can also be used as symbols. In the latter case, the Shannon's entropy seems to be related to the Sequential Entropy used herein, which is calculated from the nearest-neighbor composition of the probes. However, Shannon's entropy for dimers does not distinguish between dimers composed of different or identical bases, whereas sequential entropy considers only nearest-neighbors composed of different bases, which is equivalent to assigning a weight of 1 to nearest-neighbors with different bases (AC, AG, AT, CA, CG, CT, GA, GC, GT, TA, TC, TG) and a weight of 0 to those composed of identical bases (AA, CC, GG, TT). Therefore, sequences AATT (SEQ ID NO: 21) and ACGT (SEQ ID NO: 22) would have the same value of Shannon's entropy based on dimer content; however, the latter sequence would have a higher sequential entropy. Table 2 shows more examples of sequential entropy calculation. Sequential entropy is a more desirable measure of sequence diversity.

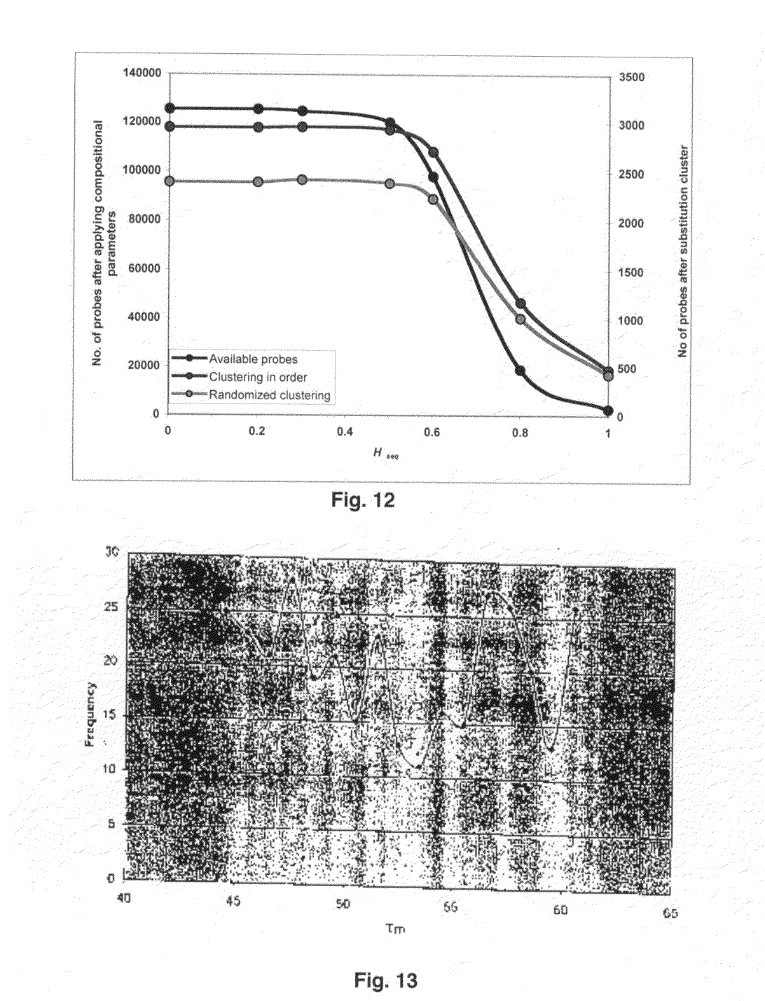

FIG. 12 shows the effects of sequential entropy on the number of probes selected in the first design step of 9-mer probes. The number of probes keeps constant for H_{seq} values from 0 to 0.6 (considering only those sequences with 35 to 65% of G+C and lacking internal repeats longer than 3 nucleotides). This number reduces drastically with higher values of H_{seq}. Similar results were observed in the selection of longer probes. Therefore H_{seq} values equal or higher than 0.6 seem to be desirable as a reference value for design purposes. However, this sequential entropy can be manipulated to obtain sets with specific diversity levels.

Application of sequential entropy equal to or higher than 0.6 in the design of 13-mer probes showed additional benefits in that it yielded sets of probes where all bases were present in all probes (lower values of H_{seq}, produced some probes where a base was absent) and also all selected probes were non self-complementary. Therefore, the use of sequential entropy was not only useful for increasing the variability of the sequences, but also useful in discarding several probes with other undesirable characteristics. The final steps in the design of the probe set include rearrangement of base composition and reduction of the range of duplex stability of the probe set. These final steps are optional and were used to improve the characteristics of the probes.

There was a small variation in base composition in the randomized probe set with a significantly higher content of A than for other bases. As mismatches containing C generally have better mismatch discriminatory properties, it is desirable to modify the base composition to obtain a probe set with a higher content of C and lower content of G (which is the base with the least mismatch discrimination properties). This rearrangement was performed for all the probes in the set while the G+C and A+T content were maintained and the base differences between the probes in the set remained unaltered.

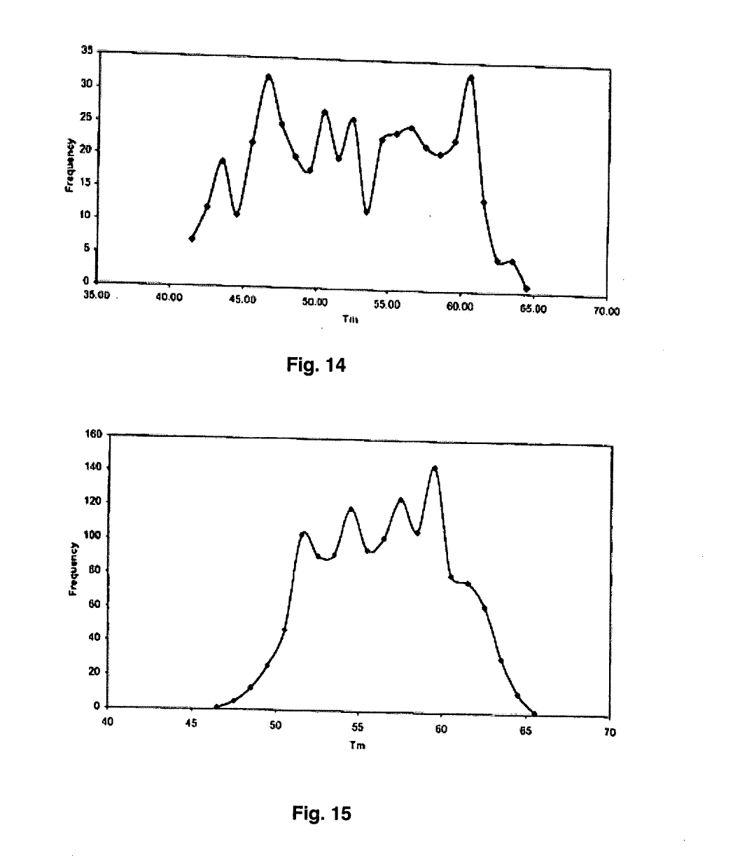

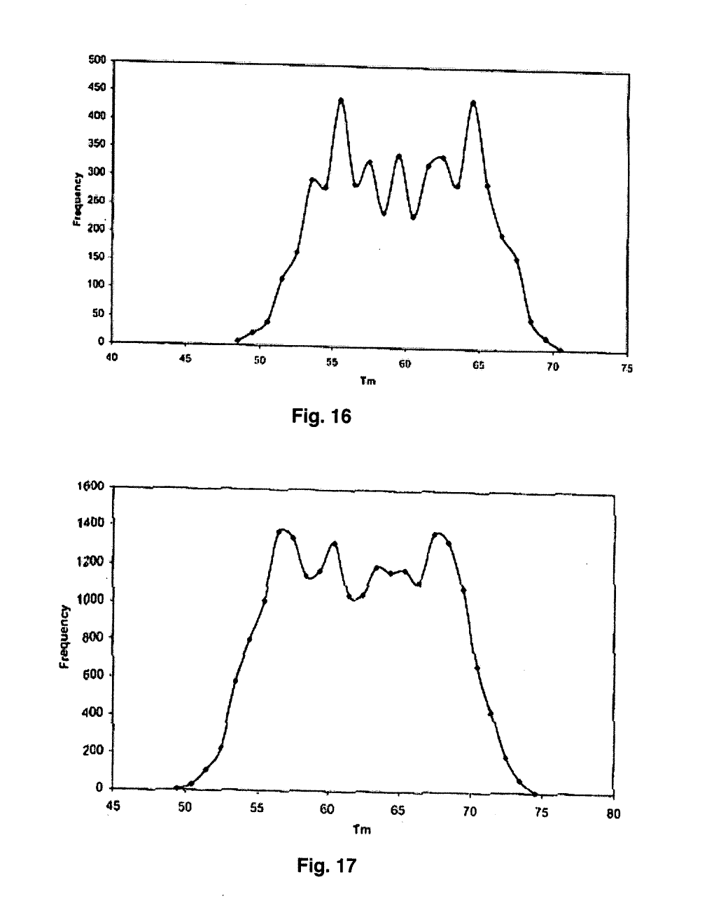

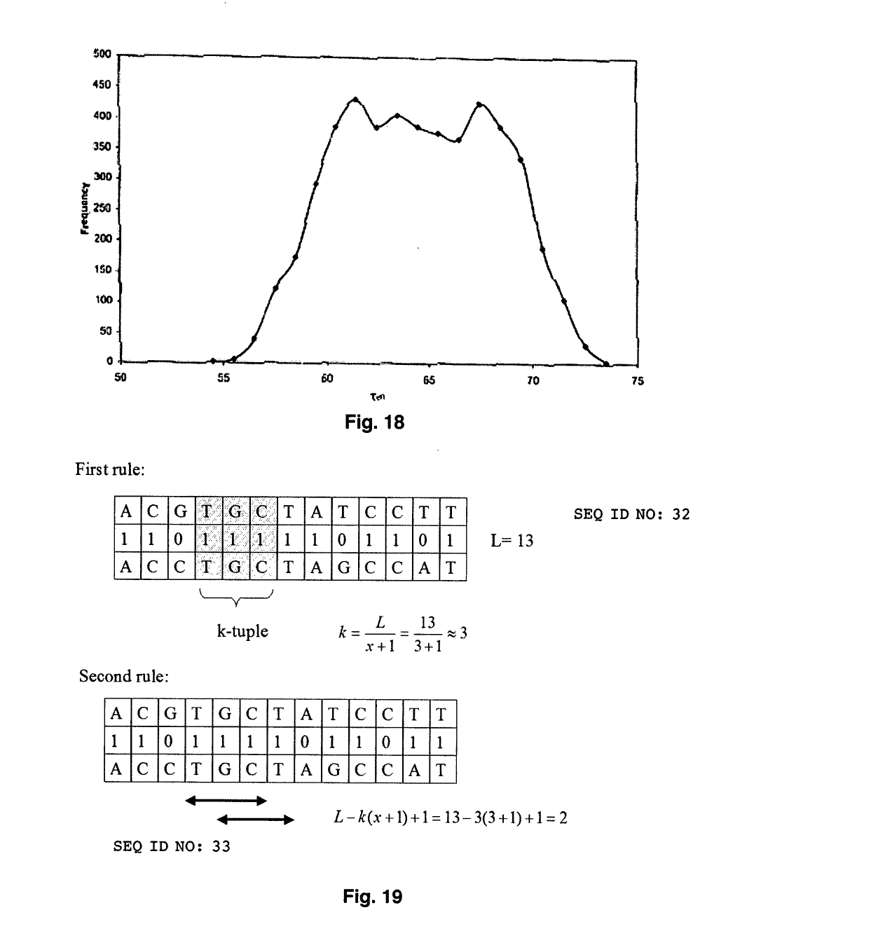

After rearrangement of base composition of the probes, free energy and melting temperatures of the probes were calculated, and the set was trimmed to obtain a narrow Tm range. The 13-mer probe set was divided into four groups with an even shorter Tm range. This reduction in Tm range is desirable for increasing the specificity of the probes and reducing the number of ambiguous hybridizations. Ambiguous hybridization occurs most frequently at hybridization temperatures lower than the Tm of the probes. Virtual simulation of hybridization reaction showed that hybridization at temperatures 1 or 2 degrees below the Tm of the less stable probes resulted in some ambiguous signals with at most three mismatches frequently located at the ends of the probes. This is in agreement with the expected specificity of the probes. FIGS. 13-19 show the Tm distribution for probe sets of different length which are generated according to the method described herein.

Finally, sequences that are capable of forming stem-loop structures (hairpins) or dimers must be avoided. This is particularly problematic when long probes are used. However, in the case of 13-mer probes, the maximal length of a complementary (stem) section of a hairpin loop is 5 bp. The free energy of such structure is not sufficient to permit the formation of such structures at hybridization conditions proposed for the universal fingerprinting chips. For this reason the formation of hairpin loops is not a critical issue that could negatively affect hybridization in this case. Formation of dimers, however, could still be problematic for the process of depositing the probes in the microarray substrate because these dimers could negatively affect the efficiency of attachment and interfere with hybridization. In such cases, a verification of the formation of dimers is preferable in order to avoid those sequences that can potentially form this type of structure. All algorithmic ideas presented herein have been implemented and tested in a program called UFCdesigner. This program permits modification of all parameters that have been described for probes of different lengths, and this program is adaptable for designing probe sets with specialized features.

TABLE 4
Comparison of The Number of Probes Obtained At
Different Design Stages For Several N-Mer Probe

| | | Probes after | Number of | Probes after | Probes after | Probes after |
|---|---|---|---|---|---|---|
| | Total | compositional | substitution | substitution | block | refining |
| Length | combinations | parameters | patterns | cluster | clustering | clustering |
| 7 | 16,384 | 7,120 | 7 ^{a)} | 1,258 ^{b)} | 204 ^{a)} | 106 ^{b)} |
| 8 | 65,536 | 28,384 | 8 ^{a)} | 4,881 ^{a)} | 774 ^{a)} | 376 ^{a)} |
| 9 | 262,144 | 98,328 | 9 ^{a)} | 20,764 ^{a)} | 2,759 ^{a)} | 1,207 ^{a)} |
| | | | 45 ^{b)} | 2,710 ^{b)} | 497 ^{b)} | 128 ^{b)} |
| 10 | 1,048,576 | 408,080 | 558 ^{b)} | 9,046 ^{b)} | 1,866 ^{b)} | 452 ^{b)} |
| 11 | 4,194,304 | 2,269,248 | 668 ^{b)} | 37,992 ^{b)} | 8,197 ^{b)} | 1,722 ^{b)} |
| 12 | 16,777,216 | 5,434,528 | 788 ^{b)} | 98,787 ^{b)} | 24,848 ^{b)} | 4,982 ^{b)} |
| 13 | 67,108,864 | 16,283,432 | 918 ^{b)} | 302,349 ^{b)} | 81,812 ^{b)} | 15,624 ^{b)} |

^{a)} Parameters were adjusted for at least 2 differences between all probes.
^{b)} Parameters were adjusted for at least 3 differences between all probes.

TABLE 5
Selection Criteria And Features For UFCs of Different Sizes

| Size | 13 | 12 | 11 | 10 | 9 | 8 | 8a |
|---|---|---|---|---|---|---|---|
| Initial number | 67,108,864 | 16,777,216 | 4,194,304 | 1,048,576 | 262,144 | 65,536 | 65,536 |
| of probes | | | | | | | |
| Compositional | Default | Default | Default | Default | Default | Default | H_{seq} = 0.5 |
| parameters | | | | | | | |
| No. of probes | 16,283,432 | 5,434,528 | 2,269,248 | 408,080 | 98,328 | 28,384 | 41,248 |
| available after | | | | | | | |
| compositional | | | | | | | |
| parameters | | | | | | | |
| First random | No | 12,973 | 1373 | 27 | 819 | 1713 | 1713 |
| seed | randomized | | | | | | |
| Number of | 2 | 2 | 1 | 1 | 1 | 1 | 1 |
| positions to | | | | | | | |
| be varied | | | | | | | |
| Available after | 302,349 | 78,572 | 283,507 | 62,149 | 15,479 | 4957 | 6307 |
| substitution | | | | | | | |
| cluster | | | | | | | |
| Second | 1237 | 7,137 | 17 | 923 | 217 | 1313 | 1313 |
| random seed | | | | | | | |
| Number of | 3 | 3 | 2 | 2 | 2 | 2 | 2 |
| mismatches | | | | | | | |
| Available after | 81,812 | 22,216 | 50,285 | 11,044 | 2,785 | 767 | 917 |
| block cluster | | | | | | | |
| Third random | 1,237 | 1,711 | 137 | 147 | 963 | 3197 | 3197 |
| seed | | | | | | | |
| Refine cluster | 3 mism. | 3 mism | 2 mism. | 2 mism. | 2 mism. | 2 mism. | 2 mism. |
| parameters | 4 slide | 3 slide | 2 slide | 2 slide | 2 slide | 2 slide | 2 slide |
| Available after | 15,624 | 4,863 | 20,951 | 4,936 | 1335 | 395 | 447 |
| refine cluster | | | | | | | |
| DG° min | −19.80 | −18.32 | −17.73 | −15.43 | −13.45 | −12.21 | −12.16 |
| [kcal/mol] | | | | | | | |
| DG° max | −14.20 | −12.48 | −10.64 | −9.92 | −9.18 | −7.18 | −7.72 |
| [Kcal/mol] | | | | | | | |
| Tm min [° C.] | 57.8 | 54.3 | 49.1 | 48.2 | 46.8 | 37.9 | 41.1 |
| Tm max [° C.] | 74.2 | 73.4 | 74.5 | 70.4 | 65.6 | 64.3 | 64.1 |

TABLE 6
Comparison of The Number of Probes And Total Base Composition
of The Sets Selected In Each Design Step For 13-Mer Probes
Using Ordered And Randomized Clustering

| Design step | Ordered | Randomized¹⁾ |
|---|---|---|
| Initial set | 67,108,864 | 67,108,864 |
| After applying | 16,283,432 | 16,283,432. |
| compositional parameters^{a)} | | |
| After substitution | 302,349 | 302,349 |
| clustering^{b)} | | |
| After block clustering^{c)} | 81,221 | 81,812 |
| After refining clustering^{d)} | 15,133 | 15,624 |
| Probes beginning with A^{e)} | 7,835 | 4.124 |
| Probes beginning with C^{e)} | 3,743 | 3,989 |
| Probes beginning with G^{e)} | 2,137 | 3,892 |
| Probes beginning with T^{e)} | 1,418 | 3,619 |
| A content^{e)} | 54,748 (27.8%) | 51,540 (25.4%) |
| C content^{e)} | 49,732 (25.3%) | 51,116 (25.2%) |
| G content^{e)} | 47,081 (23.9%) | 50,575 (24.9%) |
| T content^{e)} | 45,168 (23.0%) | 49,831 (24.5%) |

¹⁾The list of probes was randomized before the block and refining clustering steps.
^{a)}Compositional parameters: 35-65% of G + C, Absence of repeats longer than 3 nt, Sequential entropy ≧ 0.6.
^{b)}Substitution clustering parameters: Number of substituted positions = 2.
^{c)}Block clustering parameters: block size = 10.
^{d)}Refining clustering parameters: Number of optimized base differences = 3, sliding = 4.
^{e)}Data corresponding to final set (After refining clustering).

### Example 10

### Algorithms of Virtual Hybridization

This example describes algorithms and software for virtual hybridization and visualizing and comparing predicted hybridization patterns with oligonucleotide microarrays. Virtual hybridization can predict the most probable hybridization sites where an oligonucleotide probe would bind to a target nucleic acid sequence. These sites are found by means of a two-stage search procedure. In its first stage, potential hybridization sites are identified by finding sites with selectable number of bases that can be paired with the oligonucleotide probe. Then free energy values are evaluated for those potential hybridization sites. If the calculated free energy values are equal or lower than convenient free energy cut-off values, those sites are considered as sites of high probability of hybridization. Improved and accelerated algorithms for virtual hybridization are described below. Software for visualizing predicted hybridization patterns is also described. This tool shows a graphical representation of the hybridization patterns that could be obtained at specific experimental conditions. This presentation simulates the real images that could be expected from practical experiments. This type of graphical representations is convenient for comparing predicted and experimental fingerprints, and also for obtaining differential fingerprints from two different target sequences. Tools for predicting hybridization patterns of simple and complex oligonucleotide microarrays on full or partial genome sequences, as well as tools for graphic and quantitative display of predicted hybridization patterns are closely linked to the program for designing UFCs described above. Consequently, programs for designing UFCs constitute a software package that includes powerful tools for designing, simulating hybridization experiments and validating sets of probes for universal fingerprinting.

### Identifying Potential Hybridization Sites

A simple algorithm is used to identify potential hybridization sites by rigorously comparing the sequence of the probe along the length of the target sequence. This search includes two parameters: the minimal accepted length of contiguously paired bases (minbasescom) and the minimal accepted number of complementary bases between a probe and a potential hybridization site (minblocksize). A virtual hybridization search begins by looking for sites in the target molecule where the number of contiguously paired bases or the number of complementary bases with the probe, are equal to, or greater than minblocksize or minbasescom, respectively. Sites found by means of this search are stored and considered as potential hybridization sites.

This procedure considerably reduced the problem of evaluating the bimolecular secondary structure of pairing of probes with the entire target molecule by using only those sites where there are enough paired bases to produce a stable duplex. However, this approach has a considerably long running time because it requires a number of comparisons proportional to the length of the duplex product. Thus, this search can take a considerable amount of time especially when the number of probe sequences is large and/or the target sequences are long.

A new and accelerated version of virtual hybridization with considerable improved running time is described below. This algorithm is based on the idea of filtration for sequence comparison (Gusfiled, 1997; Pevezner, 2000; Waterman, 1995). If two sequences of the same length (L) having at most x mismatches are compared, then:

i) these sequences must share at least a word of length k (k-tuple) such as:

$$k = \frac{L}{x + 1}$$

ii) if gaps are not allowed in the comparison, then the two sequences must share at least L−(x+1)k+1 of such k-tuples (Pevezner, 2000; Waterman, 1995).

These rules are illustrated in FIG. 19. Shared k-tuples can be easily found by hashing (Cormen et al., 2001; Gusfiled, 1997; Pevezner, 2000). The target DNA sequence is hashed to words of length of at most k and the positions of each k-tuple are mapped onto a lookup table. Then each probe sequence is scanned to extract all k-tuples of the probe sequence. If this k-tuple matches with a k-tuple of the lookup table, the beginning of the possible potential hybridization site is calculated by:

start=j−i+1

where i is the position of the k-tuple in the probe, and j the position of the k-tuple in the target DNA sequence (which is consulted from the lookup table). All start positions are recorded in a table of hits, where the number of start sites that is found for each position of the DNA sequence (hit) is tracked. If the number of hits for a given site equals (or exceeds) the value t−(x+1)k+1, then such site is stored as a potential hybridization site.

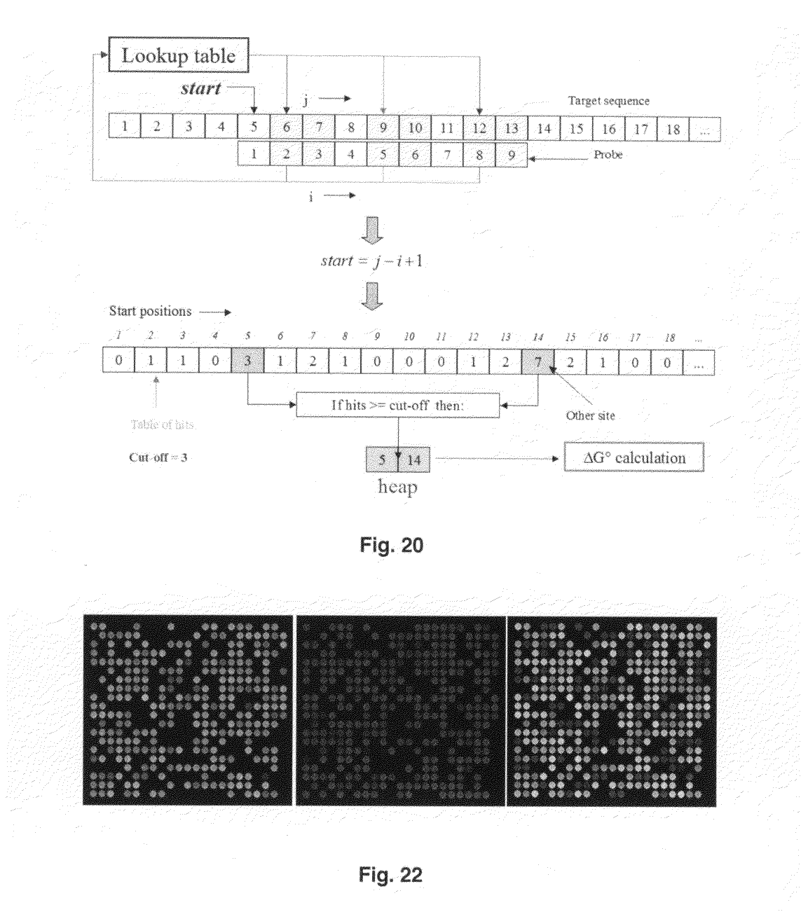

It must be noted that by choosing a size of the k-tuple shorter that the maximal calculated by k=L/(x+1), then the minimal number of hits for potential hybridization sites is increased. Therefore, this can increase the algorithm speed while maintaining the specificity. FIG. 20 illustrates several important details of the described algorithm.

### Calculating Free Energy of Hybridization at Potential Hybridization Sites

Free energy of hybridization between a probe and its potential hybridization sites is calculated by the nearest-neighbor model, which considers thermal stability as sequence-dependent and in terms of base pair doublets (nearest-neighbors).

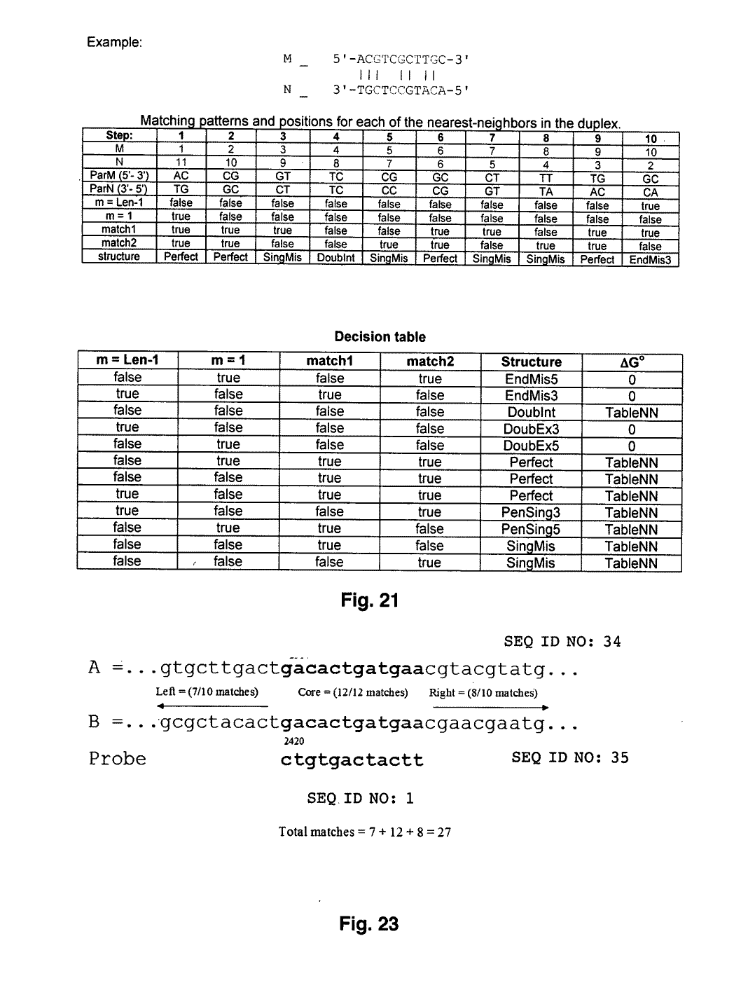

Bases between a particular site and the probe are compared in order to decide if such bases can be paired (match) or not (mismatch). Then all matches and mismatches are grouped in pairs. This approach does not presently consider gaps in that comparison. Various duplex secondary structures can be found in this way. Table 7 summarizes several secondary structure components (substructures) and abbreviations used to represent them. Matching patterns for each of the nearest-neighbors of the duplex can be combined with the positions of such patterns in the duplex to identify a secondary structure component as illustrated in FIG. 21. Free energy value associated with each substructure can be calculated by means of a decision table. The free energy value for the duplex will be the sum of all individual free energy values associated with each substructure.

TABLE 7
Secondary Structure Components For DNA Duplexes

| Structure | Abbreviation |
|---|---|
| 5′ Terminal mismatch | EndMis5 |
| 3′ Terminal mismatch | EndMis3 |
| Double internal mismatch | DoubInt |
| 3′ Double external mismatch | DoubEx3 |
| 5′ Double external mismatch | DoubEx5 |
| Perfect paired dinucleotide | Perfect |
| Penultimate single mimatch close to 3′ end | PenSing3 |
| Penultimate single mismatch close to 5′ end | PenSing5 |
| Single internal mismatch | SingMis |

The published nearest-neighbor data set has not been completed to represent the contributions of all secondary structure components of DNA. Published data for the nearest neighbor parameters includes values for all the 10 nearest-neighbor parameters for Watson-Crick pairings, internal single mismatches and dangling ends (SantaLucia, 1998; Allawi & SantaLucia, 1997, 1998a-c; Bommarito et al., 2000). For these reasons some values need to be estimated from separate considerations. Thermodynamic values for terminal mismatches are not published yet. However, several studies indicate that terminal mismatches are less destabilizing than internal mismatches. Some terminal mismatches may indeed have stabilizing values. Free energy values for terminal mismatches in the present invention have been assumed to be zero. In another approximation, free energy values for terminal mismatches can be estimated from the dangling end thermal stabilities, by considering a terminal mismatch as a combination of two dangling ends. Bommarito et al. have indicated that stabilities calculated in this way have a reasonable correlation with terminal mismatch data in most of the cases. A more confident prediction of thermal stability will be possible when precise values for these contributions are published or calculated from experiments.

Free energy values for tandem mismatches are also not available. In general, tandem mismatches have destabilizing values, but there are some important exceptions that are exceptionally stable (even more than two contiguous A-T pairs). Currently estimated values for these interactions assume that internal mismatches have destabilizing values (positive free energies). In general, multiple contiguous mismatches are considered as internal loops and their associated free energy contribution is calculated using a function that gives a linear dependency of positive free energy value with the loop size.

Penultimate mismatches deserve special attention. If the free energy of penultimate mismatches is considered as similar to that corresponding to internal mismatches, then calculated free energy values for structures with penultimate mismatches are larger (more unstable) than those calculated by considering that the bases located in the end close to the penultimate mismatch are unpaired. These calculations are in agreement with experimental observations. When free energy values for such duplexes are calculated with the algorithm described before, the terminal bases can be paired even if penultimate mismatches are present. Therefore an additional analysis is performed when penultimate mismatches are found in order to untie the paired bases in the ends adjacent to the mismatches and the free energy of such duplex is recalculated.

With regard to bulges, i.e. cases where there are deletions of bases in one of the strands, some data from the literature indicate that bulges have in general destabilizing free energies, but this effect depends also on the sequential context. Apparently, bulges are too unstable for short sequences (up to 13-mer). Bulges could be considered in the program of the present invention by modifying some aspects of the filtering procedure, and estimation of free energy can be performed with a dynamic program algorithm similar to the Zuker's algorithm to predict secondary structure of RNA sequences. Once the free energy value for the duplex is calculated, it is compared with selectable cut-off values. Such cut-off values can be estimated from particular experimental conditions. If the free energy of the duplex is less than or equal to the cut-off value, the site is marked as a high probability hybridization site or probable signal. For a particular microarray, a free energy cut-off for all the probes can be conveniently estimated from the conditions of the hybridization experiment. Then all the sites, which exhibit higher free energy values than this cut-off value will represent probable signals constituting the virtual hybridization pattern. Cut-off values can be assigned for different stringency conditions that produce different hybridization patterns.

### Estimating Free Energy Cut-Off Values for Virtual Hybridization

The Tm values are calculated with the parameters of the nearest-neighbor model using the formula:

$$Tm = \frac{Δ H °}{Δ S ° + R ln c}$$

where DH° and DS° are the stacking enthalpy and entropy of the duplex, c is the oligonucleotide concentration and R the gas constant (1.987 cal/K mol). The Tm must be corrected for salt concentration. DH° is assumed to be salt concentration independent whereas ΔS° can be corrected by:

ΔS°=ΔS°_{1M}+0.368·L·ln [Na⁺]

where L is length of the probe, ΔS°_{1M} is the stacking entropy calculated at 1M [Na⁺] concentration. It can be appreciated from these formulas that the Tm is also a function of the duplex and salt concentrations as well.

It is not clear how these parameters are affected in microarray hybridization where one strand of the duplex is fixed to a surface. Moreover, since some stability contributions to the secondary structure have been reported only in terms of free energy, it is preferable to use free energy values to derive the cut-off parameters for predicting hybridization patterns. FIG. 5 shows the variation of Tm against free energy for perfect pairing of a set of 13-mer probes described above. This set has a Tm variation of 17° C. and a free energy variation of about 6 Kcal/mol. This Tm range is too wide for practical hybridization purposes. If the probe set is divided into subsets, each with a defined Tm variation, different hybridization temperatures can be used for each subset. The hybridization temperature is critical in each experiment as some of the probes may produce ambiguous hybridization signals. Possible ambiguous hybridization signals can be predicted with the help of virtual hybridization. In the hybridization data of the HPV sequences against the 13-mer UFC the probe set was divided into four subsets each with an approximate Tm variation of 4.25° C. or 1.8 Kcal/mol free energy (note that free energy values are partially superimposed at the ends of each subset in FIG. 5). Different hybridization temperatures were used for each subset. Cut-off values for free energy were set about 1 kcal/mol less than the free energy value of the more unstable probe of the set (about 2 degrees below the Tm of the most unstable probe of the set). Under these conditions all probes in the set can potentially hybridize perfectly (without mismatch) if their complementary sequences are present in the target DNA and some probes may produce ambiguous hybridization signals. A detailed analysis of the results showed that with these free energy cut-off values only the most stable hybrids containing single mismatches are allowed and predicted hybridizations were produced for the formation of perfect duplexes as well as several hybrid duplexes with at most two mismatches preferably located at the ends.

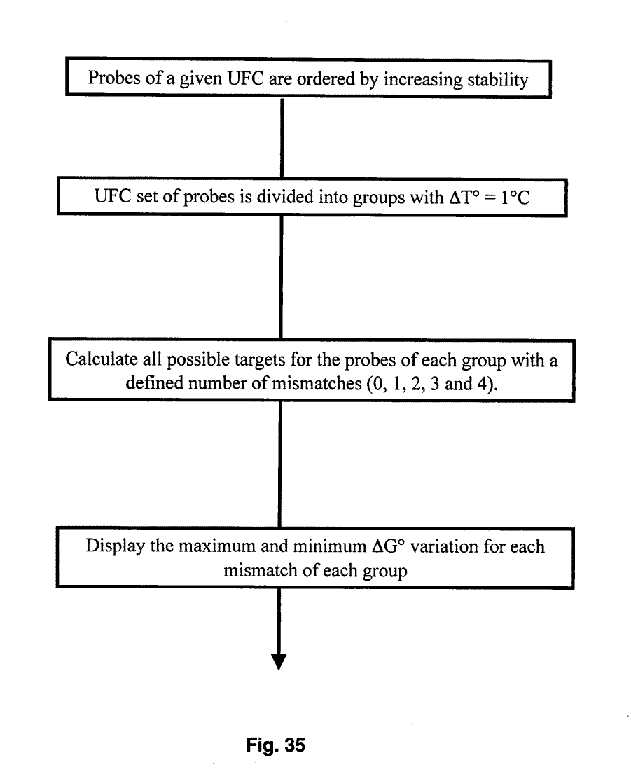

Then a critical aspect of the Virtual Hybridization approach is the Free Energy value used as a cut-off in order to display only those signals representing a defined level of stability, expected to be seen under a particular hybridization condition. The cut-off value is related to the temperature used for the hybridization experiment. This topic has not been commonly considered in previous probe design techniques. In order to estimate cut-off values for a particular set of probes, the complementary sequences of each probe are calculated. Then all possible combinations of complementary target sequences where a particular base is substituted for each the three remaining bases are calculated. This procedure is used in order to calculate all possible targets, with, one, two, three, etc mismatches. Then the free energy ranges for the hybridization of probes for each target sequences, allowing a defined number of mismatches are calculated. FIG. 35 summarizes the general strategy used for calculating cut-off values.

Table 8 shows the division of UFC-13 probes into subsets with 1° C. Tm increments.

TABLE 8
Division of the 13-mer UFC Into Subsets with
a ΔTm Variation of 1° C.

| Subset | Begin | End | Tmₘᵢₙ | Tmₘₐₓ | ΔG°ₘᵢₙ | ΔG°ₘₐₓ | Freq |
|---|---|---|---|---|---|---|---|
| A | 1 | 338 | 51 | 51.9 | −14.7 | −14.2 | 338 |
| B | 339 | 858 | 52 | 52.9 | −15.0 | −14.5 | 520 |
| C | 859 | 1769 | 53 | 53.9 | −15.2 | −14.8 | 911 |
| D | 1770 | 2927 | 54 | 54.9 | −15.6 | −15.0 | 1158 |
| E | 2928 | 3977 | 55 | 55.9 | −16.0 | −15.3 | 1050 |
| F | 3978 | 4969 | 56 | 56.9 | −16.2 | −15.6 | 992 |
| G | 4970 | 6086 | 57 | 57.9 | −16.5 | −15.8 | 1117 |
| H | 6087 | 7117 | 58 | 58.9 | −16.9 | −16.1 | 1031 |
| I | 7118 | 8041 | 59 | 59.9 | −17.3 | −16.5 | 924 |
| J | 8042 | 9036 | 60 | 60.9 | −17.6 | −16.8 | 995 |
| K | 9037 | 10083 | 61 | 61.9 | −17.8 | −16.9 | 1047 |
| L | 10084 | 11195 | 62 | 62.9 | −18.2 | −17.2 | 1112 |
| M | 11196 | 12304 | 63 | 63.9 | −18.7 | −17.6 | 1109 |
| N | 12305 | 13389 | 64 | 64.9 | −18.9 | −17.8 | 1085 |
| O | 13390 | 14386 | 65 | 65.9 | −19.2 | −18.1 | 997 |
| P | 14387 | 14976 | 66 | 66.9 | −19.5 | −18.3 | 590 |
| Q | 14977 | 15264 | 67 | 67.9 | −19.8 | −18.7 | 288 |

The numbers in the columns entitled “Begin” and “End” correspond to the range of probes in the original UFC 13-mer set where all probes have been ordered by increasing stability. The column entltled “Freq” lists the number of probes in each subset.

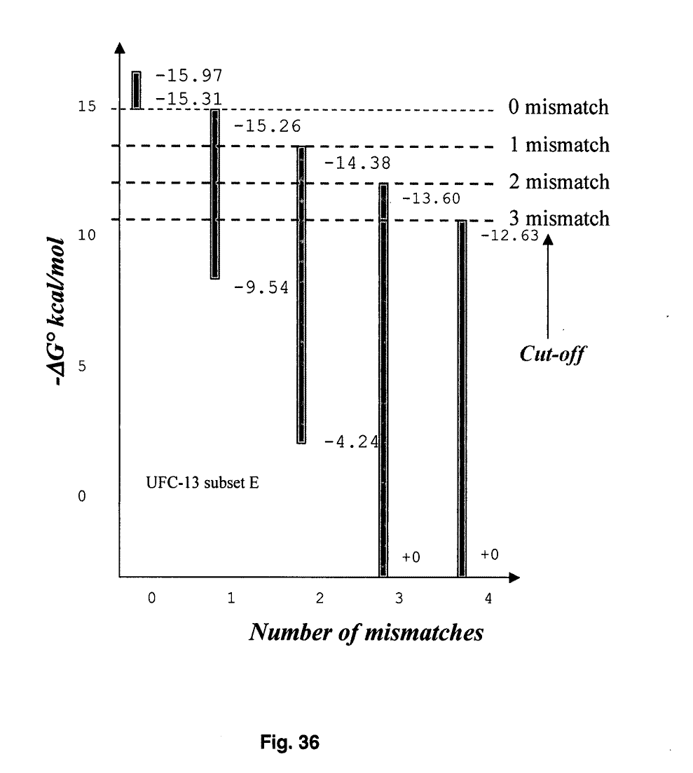

FIG. 36 shows the free energy distribution for the hybridization of a probe set allowing a defined number of mismatches. The whole Tm variation of the probes in subset E (derived from the 13-mer UFC) is only 1° C. The figure also illustrates the placement of convenient cut-off values for allowing only defined number of mismatches.

Table 9 shows that when the number of allowed mismatches increases, also the number of possible target sequences increases exponentially.

TABLE 9
Number of Predicted Target Sequences for the 13-mer
UFC subset E Allowing Defined Numbers of Mismatches

| | Number of mismatches | | | | |
|---|---|---|---|---|---|
| | 0 | 1 | 2 | 3 | 4 |
| Number of | 1050 | 40950 | 737100 | 8108100 | 60810750 |
| targets | | | | | |
| ΔG° min | −15.97 | −15.26 | −14.38 | −13.60 | −12.63 |
| ΔG° max | −15.31 | −9.54 | −4.24 | 1.04 | 5.74 |

Table 10 shows free energy data for all UFC 13-mer subsets that can be derived from the original set by allowing a Tm variation of 1° C. The table shows the minimal and maximal free energy value for 0, 1, 2, 3 and 4 mismatches. Cut-off values for allowing only a defined number of mismatches are also summarized. Values in the column in red could be used as cut-off to allow only perfect hybridization, values in blue as cut-off for allowing 1 mismatch (MM), values in green for allowing two mismatches, and values in orange for allowing three mismatches.

TABLE 10
Free Energy Ranges for Defined Number of Mismatches
for UFC 13-mer Subsets with 1° C. of ΔTm

| | Number of mismatches | | | | | | | | | |
|---|---|---|---|---|---|---|---|---|---|---|
| UFC | 0 | | 1 | | 2 | | 3 | | 4 | |
| Subset | ΔG°ₘᵢₙ | ΔG°ₘₐₓ | ΔG°ₘᵢₙ | ΔG°ₘₐₓ | ΔG°ₘᵢₙ | ΔG°ₘₐₓ | ΔG°ₘᵢₙ | ΔG°ₘₐₓ | ΔG°ₘᵢₙ | ΔG°ₘₐₓ |
| A | −14.65 | −14.20 | −13.97 | −8.63 | −13.01 | −3.13 | −12.40 | 1.79 | −11.52 | 5.81 |
| B | −14.96 | −14.48 | −14.28 | −8.88 | −13.57 | −3.56 | −12.82 | 1.51 | −11.83 | 5.51 |
| C | −15.24 | −14.77 | −14.62 | −9.02 | −13.88 | −3.75 | −13.16 | 1.44 | −12.16 | 5.24 |
| D | −15.56 | −15.03 | −14.95 | −9.26 | −14.16 | −3.94 | −13.35 | 1.10 | −12.32 | 6.01 |
| E | −15.97 | −15.31 | −15.26 | −9.54 | −14.38 | −4.24 | −13.60 | 1.04 | −12.63 | 5.74 |
| F | −16.23 | −15.61 | −15.55 | −9.82 | −14.63 | −4.40 | −14.00 | 0.86 | −13.09 | 5.54 |
| G | −16.54 | −15.85 | −15.95 | −10.15 | −15.06 | −4.64 | −14.40 | 0.68 | −13.40 | 5.24 |
| H | −16.89 | −16.08 | −16.19 | −10.38 | −15.31 | −4.97 | −14.71 | 0.36 | −13.71 | 4.99 |
| I | −17.34 | −16.46 | −16.49 | −10.68 | −15.89 | −5.23 | −15.01 | 0.06 | −14.43 | 4.99 |
| J | −17.60 | −16.77 | −16.79 | −10.97 | −16.04 | −5.34 | −15.18 | −0.18 | −14.29 | 4.88 |
| K | −17.80 | −16.87 | −17.14 | −11.25 | −16.19 | −5.73 | −15.19 | −0.36 | −14.28 | 4.66 |
| L | −18.18 | −17.18 | −17.56 | −11.53 | −16.49 | −5.93 | −15.72 | −0.68 | −14.43 | 4.44 |
| M | −18.66 | −17.58 | −17.79 | −11.78 | −16.80 | −6.33 | −15.92 | −0.97 | −14.62 | 4.01 |
| N | −18.90 | −17.84 | −18.09 | −12.11 | −17.12 | −6.51 | −16.27 | −1.17 | −14.85 | 3.90 |
| O | −19.18 | −18.15 | −18.53 | −12.48 | −17.51 | −6.82 | −16.51 | −1.44 | −15.23 | 3.54 |
| P | −19.53 | −18.30 | −18.90 | −12.65 | −17.90 | −7.15 | −16.62 | −1.53 | −15.23 | 3.40 |
| Q | −19.80 | −18.68 | −18.92 | −12.95 | −18.12 | −7.35 | −16.68 | −1.97 | −15.23 | 3.09 |
| Cut-off | | | 0 MM | | 1 MM | | 2 MM | | 3 MM | |

Consider that the signal intensity of a hybridization signal is given by:

$$I ∞ {\sum }_{i = 1}^{n} {c}_{i} = {\sum }_{i = 1}^{n} {e}^{Δ {G}_{i}^{o} / RT}$$

where i is one of the n potential binding sites (with or without mismatches) of the probe at temperature T and ΔG°ᵢ is the free energy (stability) for the probe binding in such site. In this formula T is the hybridization temperature which can be estimated from the free energy cut-off value. Using this formula it can be seen that the contribution to the signal intensity of the mismatched probes could be significant. Therefore by calculating the signal intensity considering not only the free energy contribution of the more stable binding site but considering all the contributions of the mismatched sites (at a given cut-off value) it is expected that a better correlation to the real signal intensity will exist. A similar concept has been addressed by Zhang et al. This formula indicates that if the hybridization temperature is not carefully considered, then the number of low-stable potential hybridizations can be high enough to produce intense “cross-hybridization” signals even if there is not a perfect match with the probe and this can explain many of the unspecific signals observed in hybridization experiments with short oligonucleotide probes.

### Tools for Showing Predicted Hybridization Patterns

In graphical representation, the arrayed probes are shown in the same disposition as they are placed in the microarray in real experiments. Sites with high probability of hybridization are represented with a colored spot. The intensity of the spot is proportional to the free energy value of hybridization. It has been proposed that the number of sites where the probe can potentially hybridize must be considered in order to calculate the color intensity. This can be calculated from the free energy values estimating the concentration of target that hybridizes to each site by means of some thermodynamic rules. The sum of the concentrations for all those sites must be proportional to the intensity of the color, and then it can be used to calculate a more convenient value of intensity.

Graphical representations of predicted hybridization patterns can be easily compared with those obtained in real experiments. In this comparison different colors can be assigned to predicted and experimental patterns, and graphical representation of hybridization patterns are then superimposed. If the same signal is present in both predicted and experimental fingerprints, then the superimposed image will show a signal resulting from the mixing of the two colors, and the color intensity ratio between the predicted and experimental patterns can be used to estimate the accuracy of the predictions. The predicted fingerprints can also be compared for different nucleic acid samples using a similar approach, and the information can be used to compare the similarity between target molecules. Thus, it is a useful tool for fingerprinting and differential fingerprinting. FIG. 22 shows some graphical representations for predicted hybridization patterns obtained with this tool.

### Tools for Comparing Predicted Fingerprints

The degree of similarity between fingerprints are related to the similarity of the target DNA sequences, such that highly similar sequences must yield very similar fingerprints (in fact, two identical DNA sequences must provide the same fingerprints). Currently there are no universally accepted criteria for comparing fingerprints, but several methods derived from pattern recognition methodologies can be used. A widely used similarity measure (S) is the Tanimoto measure (Theodoridis and Koutroumbas, 1999). If X and Y are two sets and nₓ, n_{y}. n_{y∩x} and n_{y∪x} are the cardinalities or number of elements of X, Y, the union and the intersection of the sets respectively, the Tanimoto measure between two sets is defined as:

$$S = \frac{{n}_{X ⋂ Y}}{{n}_{X} + {n}_{Y} - {n}_{X ⋂ Y}} = \frac{{n}_{X ⋂ Y}}{{n}_{X ⋂ Y}}$$

In other words, the Tanimoto measure between two sets is the ratio of elements they have in common to the number of different elements in both sets. Another similarity measure between sets that can be used is given by Nei and Kumar (2000):

$$S = \frac{2 {n}_{X ⋂ Y}}{{n}_{X} + {n}_{Y}}$$

Both similarity measures yield values of 1 when sets X and Y are identical and 0 when they are completely different. In terms of microarray fingerprinting, sets X and Y contain those probes that hybridize with sequences x and y respectively, and the intersection is the set of probes that hybridize with both sequences. Then similarity measures between sets are proportional to the similarity between sequences.

A raw similarity measure (S_{raw}) can be calculated assuming that n_{y∩x} is equal to the number of probes that hybridize with both sequences. But strictly speaking, this is only true if these probes hybridize against the same site in both sequences, i.e. if they hybridize with homologous sites. This could be true when using long probes, but shorter probes can hybridize with certain non-homologous sites through ambiguous base pairing. Therefore, raw similarity measures can overestimate the similarity.

Alternatively n_{y∩x} can be expressed in terms of those probes that hybridize with the same energy against both sequences given other similarity measure (S_{G}). This increases the probability that hybridizations can occur in homologous sites between sequences, but they still can be biased for random hybridization of short probes with non-homologous sites and it can exclude some correct sites where single mismatches between homologous sites, can even produce ambiguous hybridization. In practice S_{G} measures tend to underestimate the similarity.

A better similarity measure can be calculated only when the sequences of the targets are known. If the sequence is known it can be verified if the hybridization signals shared between two fingerprints are occurring at homologous sites between the sequences. An extended similarity measure (S_{extended}) can be calculated. In this case both sequences are aligned at the predicted hybridization sites and then their sequences are extended on both sides of this site by a defined number of bases. If the similarity in that extended section is equal or higher than a selectable threshold, then the probe is considered to hybridize at homologous sites in both sequences and they are identified as extended matches (E) which can be used as a measure for n_{y∩x}. This strategy is illustrated in FIG. 23.

The present programs permit users to test different options to calculate similarity measures and distances. The analysis can be automatically performed for defined sets of probes and target sequences. In such cases the program calculates all the similarity measures and distances between all pairs of target sequences. The table of pairwise distances can be stored in Phylip format for subsequent analysis of data.

Similarity measures can be converted into dissimilarity measures or distances. One of them is drawn from phylogenetic studies by assuming that the number of substitutions per site is given by d=2rt, where r is the rate of substitution and t the time of divergence, then this number can be estimated from experimental data by:

$$d = - \frac{ln S}{L}$$

where L is the length of the probes (Nei and Kumar, 2000). Other definitions of distance can be employed. Distances between fingerprints can be used to build trees of similarity using algorithms for tree reconstruction such as UPGMA or Neighbor-Joining.

### Example 11

### Validation of Probes by Virtual Hybridization

In order to evaluate if the probe set could provide reliable fingerprinting analysis, a virtual hybridization process was performed on a collection of complete genome sequences of Human Papillomaviruses (HPV), Human Immunodeficiency Viruses (HIV) and Simian Immunodeficiency Viruses (SIV). Results of virtual hybridization of HPV sequences with the 13-mer probes showed few perfect and ambiguous hybridization signals expected due to the small size of the genomes (about 8000 bp). However, even with this small number of signals, the results seemed to correlate with the previously known identities of these viruses. Several formulas were used to calculate the pairwise distance or the relationship between two hybridization patterns in order to obtain a distance measure between patterns that can be used to build a dendogram for the data using an algorithm such as the neighbor-joining or some other method based on distances. Important parameters for estimation of distances between fingerprints are the total number of probes that produce signals with both targets to be compared (B) and the total number of signals shared by both targets (S). Using these data a raw score (S_{raw}) between fingerprints can be calculated:

$${S}_{raw} = \frac{B - S}{B}$$

Using this raw score, comparison of two identical fingerprints will yield 0 and 1 for two completely different fingerprints. Results obtained with these scores can be biased due to the presence of a signal with the same probe in both fingerprints produced by hybridization in non-homologous sequence sites. Several approaches can be used to ensure that a signal is produced in homologous sites. One possibility is to include in the analysis only fingerprinting signals sharing the same free energy (G). In such case a score (S_{G}) can be calculated as:

$${S}_{G} = \frac{B - F}{B}$$

A better score can be calculated only when the sequences of the targets are known. If the sequence is known it can be verified if the hybridization signal shared in two fingerprints is occurring at homologous sites between the sequences. Then an extended score can be calculated. In this case both sequences are aligned at the sites where hybridization was predicted. Their sequences are extended on both sides of this site to a defined number of bases. If the similarity in that extended section is equal or higher than a convenient threshold, it can be considered that the probe hybridizes on homologous sites in both sequences and they are identified as extended matches (E). The extended score (S_{extended}) is then calculated as:

$${S}_{extended} = \frac{B - E}{B}$$

In practice extended scores produce better correlation with other similarity studies than G and Raw scores, while G scores correlates better than Raw scores. However, the distance (score) values obtained by the formulas listed above were considerably different than those derived from previous phylogenetic studies based in alignments of sequences. Another distance measure (d_{improved}), based in phylogenetic reconstructions from data of Restriction Fragment Length Polymorphysms (RFLPs), can be calculated as:

$${d}_{improved} = - ( ln \frac{2 E}{T} ) / n$$

where T is the sum of signals obtained with both targets and n is the length of the probe. B-S, B-F and B-E described above are experimental measures of n_{y∩x} and B is a measure of n_{y∪x,} 2E is equivalent to 2n_{y∩x} and T is equivalent to nₓ+n_{y}. In the present invention, distances estimated by this formula were in good agreement with the distances calculated from alignment of sequences.

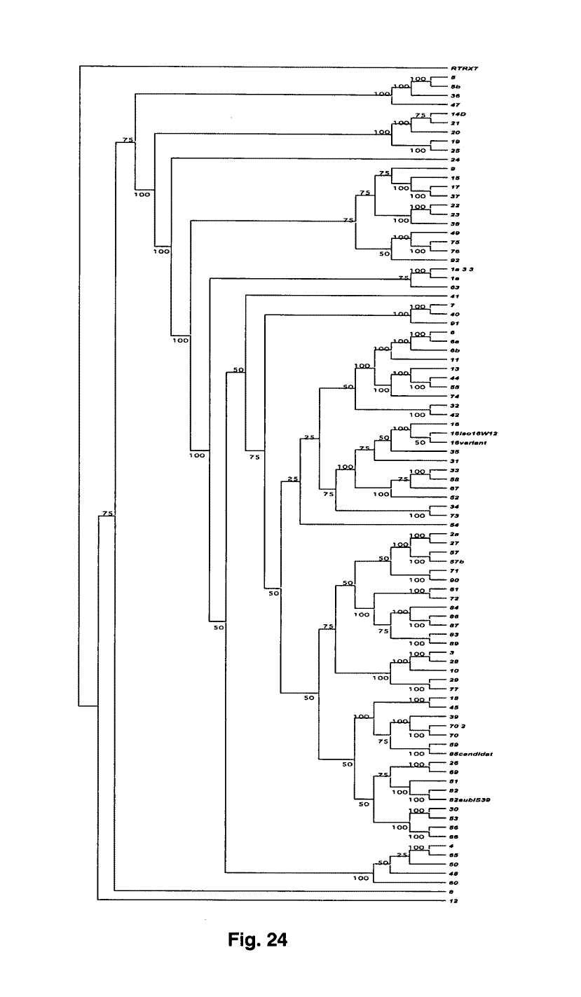

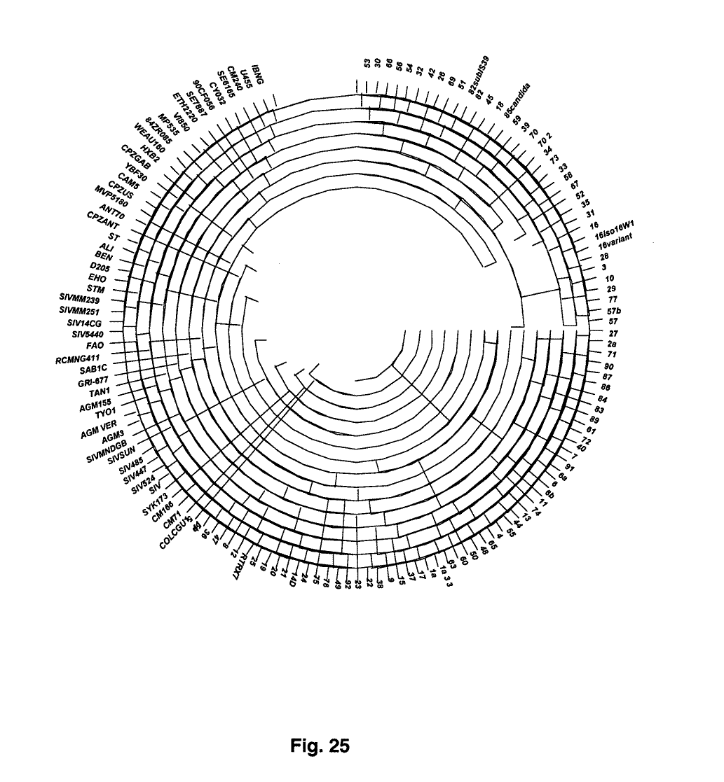

A neighbor-joining phylogenetic tree was constructed for HPV with data from virtual hybridization analysis using 13-mer probe set and the improved distance measures (FIG. 24). The resulting phylogenetic tree was in good agreement with phylogenetic studies conducted previously on these viruses. The analysis was repeated with an 11-mer probe set that gave considerable higher number of signals.

The fingerprint analysis was repeated with a mixed collection of HPV, HIV and SIV sequences and then a single tree was constructed from these data (FIG. 25). The tree shows two perfectly separated groups of sequences: one for HPV sequences and the other for SIV and HIV sequences. More interesting is the fact that the actual topologies of the trees are in good agreement with those previously reported in phylogenetic studies performed on these viruses.

Theoretical validation of the universal fingerprinting chip against HPV, SIV and HIV strongly suggest that the probe sets designed by the strategy of the present invention have a strong fingerprinting power. The fingerprinting potential of a universal fingerprinting chip can be estimated as follows. If/represents the signal produced by a probe, and 0 represents the absence of it, then hybridization with two probes would produce the following hybridization patterns (fingerprints): (0,0), (0,1), (1,0), (1,1)=4 different patterns=2²

Similarly, hybridization with three probes would yield the following fingerprints: (0,0,0), (0,0,1), (0,1,0), (0,1,1), (1,0,0), (1,0,0), (1,1,0), (1,1,1)=8 different patterns=2³

Therefore, the number of potential fingerprints (NF) that can be obtained with a microarray with N probes can be calculated with the formula:

NF=2^{N}

Accordingly, the 13-mer probes of the present invention, which contains 15,264 probes, has a fingerprinting potential of 2^{15,264}=10^{4,594}. In order to understand the magnitude of this value, Einstein's theory of the structure of the universe deduces that the number of atoms in the universe is 10⁸⁰. The numbers of life forms that exist on the surface of this Earth and its entire biosphere are about 10²⁹ and 10⁴¹ respectively. Therefore, the number of potential fingerprints for the 13-mer probes is significantly high enough to analyze any kind of organism.

Steps used to optimize the number of base differences and their relative positions in the probes would guaranty a high sequence discrimination power. This can be observed from the results of HPV sequences analysis where two highly similar HPV sequences were compared. In those cases, the number of signals shared in both fingerprints was considerably low, indicating that the probe set is very sensitive to differences of target sequences. Even with this number of signals, information about the distance between the sequences permits correct taxonomic or phylogenetic reconstruction of trees as compared to those derived from alignments of sequences. Moreover, tree reconstruction obtained with virtual hybridization approach using extended matches constitutes a novel method for phylogenetic tree estimation based in local similarities. This method does not require sequence alignment and the running times for the examples described herein are acceptable, i.e. about 30 minutes including virtual hybridization process and pairwise analysis of 80 genomes with 8000 bp each by a 2.3 Ghz Pentium IV processor.

### Example 12

### General Protocols of Molecular Fingerprinting Using Universal Fingerprinting Chips

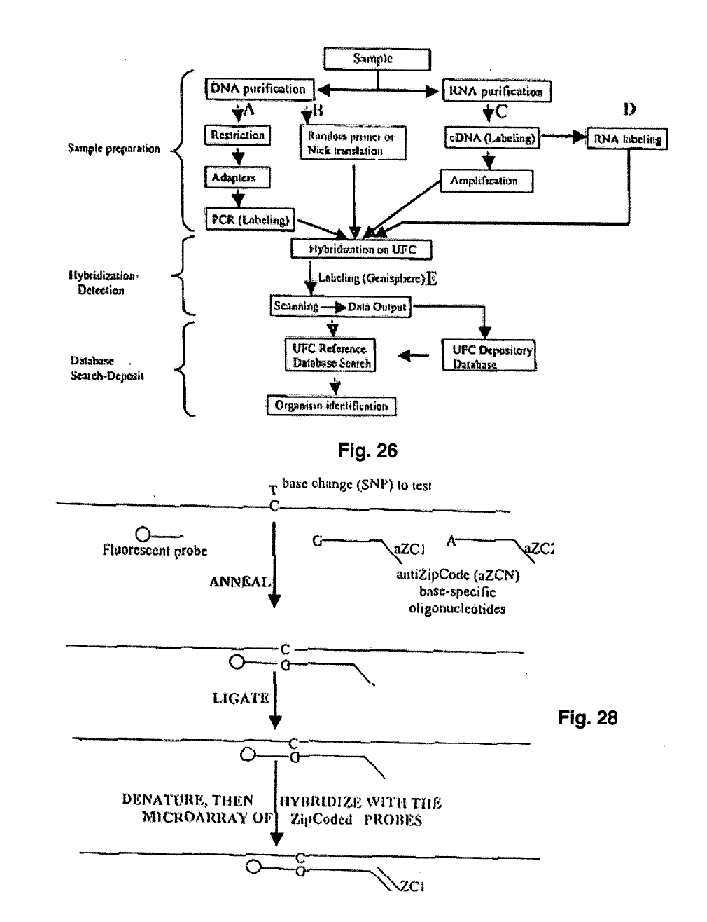

This example describes general protocols of using the probes of the present invention in fingerprinting or diagnostic studies. In general, experimental approach of using the universal fingerprinting chip of the present invention to identify species, strains or subtypes of organisms has three components: (i) sample preparation; (ii) hybridization-detection, and (iii) database search-deposit. A flowchart protocol, with alternative sample preparation steps, is illustrated in FIG. 26.

There are numerous published protocols for extracting, purifying and labeling nucleic acids from biological samples. In general, they include the steps of cell or tissue disruption, nucleic acid purification, target amplification (when needed), labeling, fragmentation, and denaturation. Commercial kits are available to perform these steps and they include appropriate experimental protocols. The main purposes of sample preparation are: i) to increase the amount of target (when needed), ii) to label the sample, iii) to fragment the sample and iv) to denature the duplex target to enable hybridization to the probes on the universal fingerprinting chip (UFC).

Labeling is typically done by incorporating radioactive isotopes or fluorescent molecules (such as Cy3 or Cy5 label) during polymer synthesis (e.g. PCR, random primer DNA synthesis, nick translation, cDNA labeling, or T4 RNA polymerase synthesis). Alternatively, labeling can be done after hybridization with oligonucleotide adapters for fluorescent dendrimers such as those described by Genisphere. A denaturing step is done, generally by heating, before hybridization. Hybridization is usually done by incubation at appropriated temperature and solution conditions for each subset of UFC probes. Hybridization signals can be captured by scanning. The resulting signals are submitted to normalization and quantification. The set of quantitatively detected hybridization signals comprises the fingerprint. This fingerprint can be used to perform a similarity search on appropriate UFC Reference Database. The similarity search includes several criteria: magnitude of hybridization signals, G+C content, A, G, C and T content, gene content, codon usage, repeated sequences content, distribution of signals having low and high intensity, pairs of signals and distribution of pairs of signals. A deposit of the fingerprint into UFC Reference Database can be done to increase its reliability in future analysis.

### Universal Fingerprinting Chip (UFC) Microarray Preparation

The universal fingerprinting chip can be implemented using a variety of oligonucleotide microarray systems that utilize a variety of methods and devices for microarray fabrication, hybridization fluidics, and image acquisition. For example, microarray fabrication can involve in situ oligonucleotide synthesis on the chip (e.g. the Affymetrix GENECHIP platform) or robotic placement of presynthesized oligonucleotides across the chip. The latter approach can be accomplished using touch-off dispensing (e.g. using slotted pin, capillary, or fiber tip devices) or remote droplet dispensing (e.g. using piezoelectric or solenoid “ink jet” devices). The hybridization surface may be a flat glass chip, semiconductor materials, metallic or metal oxide surfaces, a thin film of polymeric material, an array of polyacrylamide gel pads, a flow-through material consisting of channel glass micromachined silicon, or other porous material. The latter, three-dimensional chip configurations offer improved hybridization kinetics and increased binding capacity per array element.

When robotic arraying devices are used the probes are typically chemically modified to provide bonding to chemical groups on the support surface. For example, oligonucleotides derivatized at one end with a primary amine group will readily link to surfaces coated with epoxysilane; biotin-labeled probes will bind to streptavidin-coated surfaces; thiol-labeled probes will bind to gold surfaces; and carboxyl-derivatized probes will bind to aminosilane-coated surfaces. A particularly convenient attachment method involves bonding of 3′-aminopropanol-derivatized oligonucleotides to underivatized glass.

The UFC probes may be arranged across the chip in rows or zones corresponding to similar Tm values for use in a variable temperature hybridization chamber described below. For hybridization at fixed temperatures, the UFC probes can be distributed into four chips, each subset having about 4.25° C. Tm range, or into seventeen subsets, each having about 1° C. Tm range. The array preferably contains duplicates for each probe. Appropriate negative and positive control probes should also be included.

As discussed above, different UFC microarrays can be designed which are appropriate for use with nucleic acid samples of different genetic complexity. For example, 11-mer or 12-mer probe sequences would be expected to randomly occur about once, on average, within the E. coli genome. Another statistical tool for selecting appropriate UFC probe length for fingerprinting a given nucleic acid sample is the Poisson distribution equation. When the average number of random occurrences per interval=m, the probability P of a occurrences in the interval is: P(a)=e^{-m}[m^{a}/a!].

Thus, from the Poisson distribution equation, for a probe that occurs once, on average, per sequence interval (m=1),

the probability of 0 occurrence P(0) is e^{-1[}1⁰/0!]=0.368

the probability of 1 occurrence P(1) is e^{-1[}1¹/1!]=0.368

the probability of 2 occurrences P(2) is e^{-1[}1²/2!]=0.184

the probability of 3 occurrences P(3) is e^{-1[}1³/3!]=0.016

From the above statistical considerations, it is predicted that for a probe length giving, on average, one occurrence within the total length of the target sequence, about 37% of the probes will have no complement within the target, about 37% will have one complement, about 18% will have two complements, about 6% will have three complements, etc. It is evident from these calculations that the probe length should be biased somewhat toward fewer hybridization signals (longer probe length) to avoid having too many signals representing multiple hybridization events. From the calculation of fingerprinting E. coli discussed above, it is reasonable to predict that a 13mer UFC will be appropriate for fingerprinting bacterial genomes in general.

### Hybridization

Numerous variations of hybridization and washing conditions which may be used with oligonucleotide microarrays have been described in the literature. Prior to hybridization with labeled, fragmented, amplified and denatured target, the UFC is typically prehybridized with a “blocking reagent” such as 10 mM tripolyphosphate or Denhardt's reagent to minimize nonspecific binding.

Depending on the UFC probe Tm values and type of microarray platform, hybridizations should be carried out in conditions with appropriate temperatures, target concentration, pH and ionic concentration. For example, a hybridization buffer suitable for radiolabeled target on microscope slide arrays contains 3.3M tetramethylammonium chloride, 2 mM EDTA, 0.1% SDS, 10% (w/v) polyethylene glycol-8000 and 50 mM Tris-HCl, pH 8. Suitable hybridization times will depend on the microarray platform and target concentration but are typically from 30 minutes to overnight. Following the hybridization reaction the microarray chip is washed with hybridization buffer, or briefly with water to remove unhybridized target prior to imaging. The so-called “stringency” of hybridization, which affects the degree of mismatch discrimination, can be controlled at either the hybridization step, the washing step or both, usually by choice of counterion concentration and temperature. A relatively high stringency hybridization/washing condition, which facilitates discrimination against mismatches, involves hybridization at 2-5 deg C. below the predicted Tm of the probes.

To provide variable “stringency” across the microarray chip, a Peltier-based incubation chamber may be provided, such as that used in thermocyclers to control temperature in thermocycling instruments. A Peltier device hybridization chamber could be used to create controlled temperature gradients or discrete temperature zones across a microarray chip. Thus, if the probes were distributed according to their Tm values and hybridized in such a Peltier chamber to provide uniform hybridization stringency for probes of variable Tm across the array, the extent of imperfect hybridizations may be greatly diminished.

### Fingerprint Imaging

Depending on the type of label and microarray chip employed, fingerprint images are typically captured using a CCD camera, confocal scanning microscope or other scanning system. Radiolabels are usually recorded using a phosphorimager or photographic film that can be developed and densitometrically scanned. Fluorescent or chemiluminescent images are usually recorded using a CCD camera or confocal scanning microscope. The latter is often used with planar microarray supports such as glass slides, whereas CCD cameras are preferable for 3-dimensional microarray chips such as gel pad arrays or flow-through chips. A variety of computer programs are available to perform normalization of data and to associate each positive hybridization signal with the corresponding probe sequences, genomic locations, genes, proteins or regulatory sites, etc. Signal intensities can also be determined to estimate the relative quantity of material detected at each array element. When convenient, clusters of data can be obtained. A fingerprint image can be displayed, and the results reported in tabular or graphic form.

### Comparative Fingerprints

A frequent application of universal fingerprinting chip is to compare fingerprints from different samples. This can be done by overlapping two fingerprint images that have previously been transformed to display different colors. Fingerprint signals seen in only one sample will appear with its corresponding color, while signals seen in both samples will appear as mixture of the two colors. The degree of similarities and differences in hybridization signals can be computed and displayed in a table or graphic format with a score of relatedness. To improve the score of relatedness, fingerprints can be related to known genomic sequences (such as those of the organism predicted) to compare their location, nearest neighbor sequences, distances and directions of pairs of positive signals. Numeric comparison of experimental fingerprints can be performed by means of the formulas described in examples 10 and 11.

### Phylogenetic Trees

When the goal of a UFC fingerprinting study is to reveal phylogenetic relationships between the samples under study, all the fingerprints obtained in the study can be submitted to simultaneous comparative analysis of the parameters described in the above Comparative Fingerprints section. Phylogenetic analysis can be performed using the Phylip software package and distance measures between hybridization patterns can be used to build a dendogram for the data using an algorithm such as the neighbor-joining, or some other method based on distances, as described in Example 11. Additionally the G+C content, A, G, C and T content, gene content, codon usage, repeated sequences content, distribution of signals having low and high intensity, pairs of signals and distribution of pairs of signals can be included to improve the phylogenetic or evolutionary relatedness.

### Example 13

### Construction and Uses of Fingerprint Reference Data Set

Experimental fingerprints obtained from any new sample are compared with a fingerprint reference data set (FRDS) to identify the organism. Two types of reference data set fingerprints are envisioned. Firstly, experimental fingerprint reference data sets (E-FRDS) can be continually acquired by fingerprinting known species, strains or subtypes using a given universal fingerprinting chip. The UFC fingerprint of any “unknown” sample is used to query the E-FRDS database to search for a match and thus indicate the species, strain or subtype of the biological sample. Secondly, using GenBank and other available genomic sequence databases together with the predicting power of the virtual hybridization module, virtual fingerprint reference data sets (V-FRDS) can be predicted for any known genomic sequence. The V-FRDS is useful for provisional species, strain or subtype identification when experimental fingerprints are not yet available for a given species, i.e. when the UFC fingerprint of the “unknown” has no match within the experimental fingerprint reference data sets. As more and more experimental fingerprint reference data sets are generated and compared with the virtual data sets, differences between experimental and virtual reference data sets can be used to improve the virtual hybridization module, and to continually improve the predictive power of the V-FRDS.

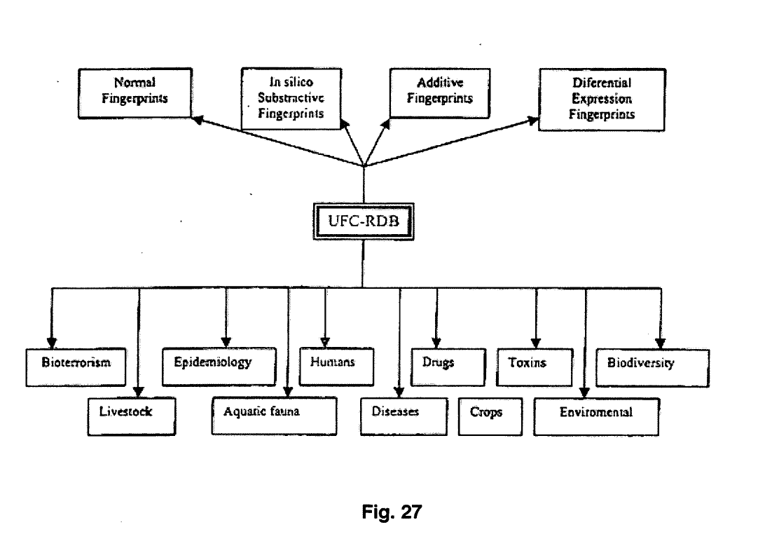

The reference data sets database can be annotated with genetic, biochemical, physiological and phenotypic organism-related information. The reference database can also include gene expression profiles experimentally acquired using the UFC with different organisms or strains or under different culture or treatment conditions. UFC-derived differential gene expression data can also be related to gene expression databases derived by other means, such as differential display, cDNA library sequencing, SAGE or Affymetrix GENECHIP. The reference expression database can be advantageously used in pharmaceutical screening programs, wherein UFC transcriptional fingerprinting is used to identify new drug candidates that elicit specific transcriptional responses. Various embodiments of molecular fingerprinting and uses of reference databases are described below and illustrated in FIG. 27.

### Reference Databases

Databases containing predicted fingerprints of all organisms sequenced (DNA and/or mRNA) plus experimental fingerprints from identified organisms or tissues, or differentially expressed fingerprints arising from particular treatments can be constructed and continually maintained. Phylogenetic trees can also be constructed from fingerprints and related to the reference databases. In addition, from time and space relationships, many evolutionary, phenotypic and physiological relationships can be deduced. With this information, several specific types of reference databases useful for different types of organisms or specific kinds of applications can be derived as described below. For example, specific practical information such as that relevant to epidemiological control of an outbreak or emergency measures for detection of microbial agents related to a bio-terrorist attack can be associated to these particular databases.

### Deposit of Experimental Fingerprints

Continuous update of the reference databases is preferably conducted to improve their reliability and diagnostic potential. For this purpose the creation of a depository database is envisioned. This depository database should be annotated with information related to the way in which the fingerprint is produced during experimental analysis. This information should be carefully reviewed before being deposited into the reference database.

### Differential Expression Fingerprints

Differential fingerprints are obtained by comparing hybridization patterns arising from two mRNA or cDNA samples. The differences are genetically related to changes in phenotype or in the environment. Important phenotypic properties as well as genetic changes associated with improvements in crops, livestock, human health, etc. can be associated with these fingerprints. Thus, numerous medical or environmental problems can be studied using differential expression fingerprints.

### Diagnosis of Co-Infections

It is important to recognize that in many cases, it will be possible to identify mixtures of two or more organisms using a single universal fingerprinting diagnostic test. For example, two different bacteria will produce an additive fingerprint pattern which can be easily analyzed with appropriate software to identify the two organisms in the sample. Also a substractive fingerprint strategy can be useful in identification of viruses infecting a human tissue as follows. For example, fingerprint associated with human tissue can be substracted from that obtained from human cervical samples containing HPV to facilitate detection of and revealing the genotype of HPV virus infecting the sample. Due to sequence variations, special attention is given to relevant signature hybridization signals.

### Epidemiological Reference Database

Infectious organisms such as bacteria, viruses, fungi etc. can be easily identified by fingerprinting. The fingerprinting power of universal fingerprinting chip is sufficient high to identify these organisms even at the level of strains. Thus, special epidemiological reference database can be constructed which is preferably annotated with important information such as drug resistance related to specific fingerprint signals and recommendations to avoid or control an outbreak.

### Vaccinal Reference Database

The evolution of bacteria and viruses submitted to selective pressure of vaccine usage can also be easily identified by fingerprinting. The predominant new, resistant strains, can then easily be selected as the strains of choice for preparation of new, effective vaccines.

### Bioterrorism Reference Database

Special bioterrorism reference database can be constructed and maintained to analyze any biological sample potentially containing microorganisms. This database includes sequence-predicted and experimentally obtained fingerprints for known microbial agents, as well as transcriptional fingerprints associated with exposure of cells or tissues to bioterrorism agents or toxins. The database is preferably annotated with information related to the source of the microbial or toxic agents and important steps recommended to control specific type of problem.

### Human Populations Database

The applications of universal fingerprinting chip in human population are potentially enormous. A reproducible DNA fingerprint database of individuals within the human population can be constructed. The molecular fingerprints of individuals cannot be altered. Samples can be obtained from any tissue from living or deceased persons. The analysis can be performed in relation to paternity tests and legal or forensic identifications. Also an accurate phylogenetic tree of human populations across the globe can be constructed. It is envisioned that human population databases not only can be based on sequence variations in genomic DNA, but also on individual variations in gene expression patterns revealed by analysis of RNA or cDNA derived from different individuals.

An important application of fingerprinting is in the field of pharmacogenomics. It is well known that different individuals display different responses to pharmaceutical treatments in terms of adverse side effects and effectiveness of drugs. Clinical studies can be carried out in which molecular fingerprinting is conducted using genomic DNA or RNA samples from individuals having known responses to drugs, and the results are deposited into a reference database annotated with information about drug effectiveness and adverse side effects. Subsequently, such fingerprinting can be used by physicians to select the best drug treatments for their patients.

### Disease-Related Reference Database

Molecular fingerprints of normal and altered (diseased) tissues can be compared to establish fingerprint signals specifically associated with the disease state. Since each fingerprint signal corresponds to a specific sequence, genes or regulatory regions having the same or very similar sequences can be identified. It is also expected that specific types or variants of a given disease will display their particular fingerprint variations, which will be very important to guide the best treatment for the patient.

### Toxic Environmental Contamination Reference Database

Animals, plants, humans and microorganisms undergo specific changes in gene expression patterns in different tissues that are due to environmental exposures. The effects of different pollutants or toxic agents can therefore be associated with groups of specific fingerprinting signals. Eventually, when such molecular fingerprinting-based environmental diagnostics are available on a global scale, they can be used in a simple, rapid and cost effective manner. Since a potential source of toxins is from terrorism or chemical warfare, the reference databases can be annotated with recommended measures to control the problem.

### Animal and Plant Reference Database

The fingerprint of strains of varieties of animals or plants of economical interest can easily be obtained and used for breeding and selection.

### Example 14

### Molecular Fingerprinting and Similarity Search

A fingerprint is a portrait of the sequences contained in the genomic baggage of an organism. There are four main sources of genomic content: (i) genetic material contributed by their parent(s) (heredity), (ii) genomic sequences acquired by horizontal transfer (e.g. plasmids), (iii) genomic loss of unused genes, and (iv) new variations arising from mutations. A good fingerprint should be able to detect the results of all these sources of genomic fluctuations in individual or grouped organisms. In addition to sequences essential for life, such as those corresponding to amino acids functioning in enzyme activities, some sequences are commonly conserved in groups of related organisms. Each pattern of hybridization revealed by universal fingerprinting chip contains some signals corresponding only to individual (strain) variations, some signals corresponding to the variant, and some others related to the species, and so on (strain, variant, species, genera, family, etc.). Thus, each fingerprint is a signature of the organism that reveals its group and individual characteristics.

The similarity search uses several important criteria to perform quantitative analysis aimed at identification of organisms. These criteria include: (i) number of hybridization signals, (ii) G+C content, (iii) pattern and intensity of hybridization signals, and (iv) patterns of pairs of sequence-related signals. Diagnostic identification is made by comparing experimental fingerprinting data to information contained in one of the respective reference databases described above.

### Number of Hybridization Signals

A bacterial genome having 3×10⁶ bp has approximately 350 times greater genetic complexity than a 8,000 bp long virus (such as HPV). The human genome is still more complex (3×10⁹ bp). It is expected that, except for repeated sequences, the number of different sequences in each genome will increase proportionally to genome complexity. Thus, the number of hybridization signals given by a set of probes representing all possible sequences (as in universal fingerprinting chip) should increase with genome complexity. Hence, the number of fingerprint signals is a clue for identifying the source of the tested sample.

### G+C Content

G+C content is another important element used in similarity search. It is expected that short-sized probes, as typically contained in universal fingerprinting chip, will produce a hybridization fingerprint with DNA targets having a similar base composition. A Gaussian distribution of probes giving hybridization signal is expected in relation to their G+C base content, with a peak on the same value of G+C base content present in the target. Thus, graphic distribution is also a clue for identifying the organism present in the sample tested.

### A, G, C and T Content

The proportion of each base, even for similar G+C content, can be variable with the type of organisms. These values can be easily obtained by the analysis of probes giving hybridization signals. These base composition values represent a useful classification parameter for organism identification.

### Gene Content

Through a Blast similarity search in GeneBank the UFC probe set can be related to the consensus gene sequences searched. Since the clusters of genes are related to metabolic and phenotypic characteristics, their presence is useful for identification and also for evolutionary and phylogenetic purposes.

### Codon Usage

The preferential use of degenerate codons is a key criterion to determine evolutionary relationships between organisms. The alignment of amino acid and codon sequences in the genes detected by the probes can be compared with those probes giving fingerprint signals to recognize which are the preferential codons used. Therefore this information can be useful for more precise identification and phylogenetic relationships.

### Pattern and Intensity of Hybridization Signals

Variations in the intensity and in the location of hybridizations signals are expected. Hybridization locations should correspond to nucleotide sequences present in the target, and hybridization intensity is related to the number of times that a given sequence is present in the sample tested. Sequences present more than once will produce more intense hybridization signals. Thus hybridization signals can be divided into groups according to their intensities. Information provided by this analysis probably is the most important for the identification of each organism.

### Pattern of Pairs of Sequence-Related Signals

A great advantage of universal fingerprinting chip (UFC) is the known identities of sequences used as probes. In the full set of UFC sequences there are numerous groups of probes sharing part of their sequences. It is expected that from a given group of probes sharing partial sequence similarity only those two forming an overlapping sequence in the target will give hybridization signals. Therefore, the amount and location (in the UFC) of probe pairs sharing a similar partial sequence and giving hybridization signals would serve to identify organism in the sample tested.

### Considerations for the Development of Universal Fingerprinting Chip

Two aspects are considered during the design steps of universal fingerprinting chip: (1) every organism must produce a specific hybridization pattern; and (2) pattern similarity between two organisms must be related with genome (or sequence) similarity so that the pattern can be used for proper organism identification. The first of these two considerations is relatively easy to resolve by selecting randomly a set with a convenient number of probes having the appropriate size. Additional considerations such as base composition, thermal stability and absence of hairpins also influence the reliability of the fingerprint. The second consideration is more complicated. Hybridization reaction is complex to analyze because several parameters are involved. Some of these parameters include: secondary structure of the targets, stability of probe binding, and presence of multiple binding sites. Although current methods of predicting secondary structure of the targets are still inaccurate for long sequence, some solutions have been proposed for this problem such as fragmentation of samples in order to minimize the influence of the secondary structure. Also tandem hybridization or arbitrary sequence oligonucleotide fingerprinting can be used. Current methods for predicting thermal stability of oligonucleotides work better than those for predicting secondary structure and stability of long sequences.

Many microarray design methods consider only the Tm for the perfect match between probe and target. However, ambiguous hybridization can occur and there are several sequential contexts that can produce stable ambiguous hybridization signals, which in turn can reduce considerably the specificity of the hybridizations. This problem is especially dramatic when the thermal stability of the probes varies widely. In such cases, using conditions that permit hybridization of the less stable probes would result in a considerably high number of ambiguous and unspecific signals.

Comparison of hybridization patterns is critical for organism identification. Current methods for comparing fingerprints consider that two fingerprints share a probe signal if the intensity of the signal in both fingerprints is statistically higher than the background noise. Several investigators have tried to correlate signal intensity with probe binding stability, but the results do not show a good correlation between these two parameters. This could be due to the fact that a probe can bind to multiple sites in the same target. In some of these sites the hybridization can be ambiguous. Signal intensity instead is related to the amount of probe that is incorporated by hybridization to the target. This quantity is related to the presence of multiple binding sites and the thermal stability of hybridization.

If signal intensity is directly proportional to the concentration (amount) of probe incorporated:

I∝c

and free energy ΔG° and concentration are related by:

ΔG°=RTlnc

then the amount of probe that binds to target DNA could be estimated by:

c=e^{ΔG°/RT}

It would be interesting to test if the signal intensity correlates better with the next formula:

$$I ∝ {\sum }_{i = 1}^{n} {c}_{i} = {\sum }_{i = 1}^{n} {e}^{Δ {G}_{i}^{o} / RT}$$

where i is one of the n potential binding sites of the probe at temperature T and ΔG °ᵢ is the free energy (stability) for the probe binding in such site. This background is important to understand several critical parameters used for the UFC design and theoretical validation.

Karlin and Altschul have developed statistic methods in order to verify if alignment and degree of similarity can be used to estimate biological relation between sequences. The Karlin and Altschul's statistics is currently used to evaluate if the similarity is significant in Blast searches. The next equation shows the probability of obtaining by chance a score S equal or higher than a defined number for the alignment between two sequences M and N if it is assumed that there is no biological relationship (homology) between them:

P(S≧x)=1−e^{-Kmne}^{^{−λS}}

where K and λ are the Karlin and Altschul's constants, m and n are the length of the sequences and S is the score for the alignment between the sequences M and N. K and λ depend on the scoring system used to evaluate the alignment. If a single scoring system is used to evaluate DNA alignment where a match has a value of +1 and a mismatch a value of −2, then K=0.621 and λ=1.33. In order to estimate the length of a probe (m) that perfectly aligns with a DNA sequence of length n to obtain a score with low probability for finding by chance (P<0.05), the probability is calculated by this equation using several probe lengths.

The Karlin and Altschul's statistics can be also used to confirm if the probe sequence that is shared by two fingerprints corresponds to a homologous sequence shared by the two target sequences. In the approach named hit extension the probe sequence shared by two target sequences is extended by both sides until a specific length is reached (extension). If the number of matches exceeds a specified threshold, then the subsequence is accepted as homologous and is taken in the calculation of the similarity. A problem with this approach is that the user needs to specify values for the extension and threshold, and these values have an important influence on the distance values. However we can use the Karlin and Altschul's statistics to estimate convenient values. In this approach if we use a match score of +1 and a mismatch score of −2 and K=0.621 and l=1.33, then the probability to obtain a give score S is calculated by:

P(S≧x)=1−e^{-Kmne}^{^{−λS}}

where m and n represent the length of the target and probe sequences, respectively. The score S is calculated by:

S=(probe length+total extension−mismatches)−(2× mismatches)

where total extension is the sum of the left and right extensions. For example, if we use a probe length of 8 and an extension of 10 nucleotides allowing 7 mismatches (which corresponds to extension length of 5 and a threshold of 11 in the dialog box) then the score is (8+10−7)−(2*7)=−3 and the probability of obtaining such score by random in the HPV sequences with m=9000 and n=18 will be 1.00 (100%). Therefore such matches are easy to find by chance. If now we are using a probe length of 8, a total extension of 10 nucleotides (as in the previous example) but allowing only 2 mismatches (extension length=5 and threshold=16 in the dialog box), then the score is (8+10−2)−(2*2)=12 and the probability for finding such score by chance with m=900 and n=18 is 0.0117 (1.17%). Therefore such score is not easily found by chance, and it is expected that the distances based in such score have a better correlation with the real distances between the sequences.

In order to verify if the phylogenetic distances between sequences were correctly assigned with the fingerprint analysis, the fingerprint distances were compared with those obtained from the alignment of the genome sequences. The 94 sequences of the HPV viruses were aligned with the help the Clustal X 1.83 program and the program Mega 3 was used to estimate the table of distances from the alignment. The distance between two aligned sequences was calculated as a p-distance which is defined as: p=number of differences/length of the alignment.

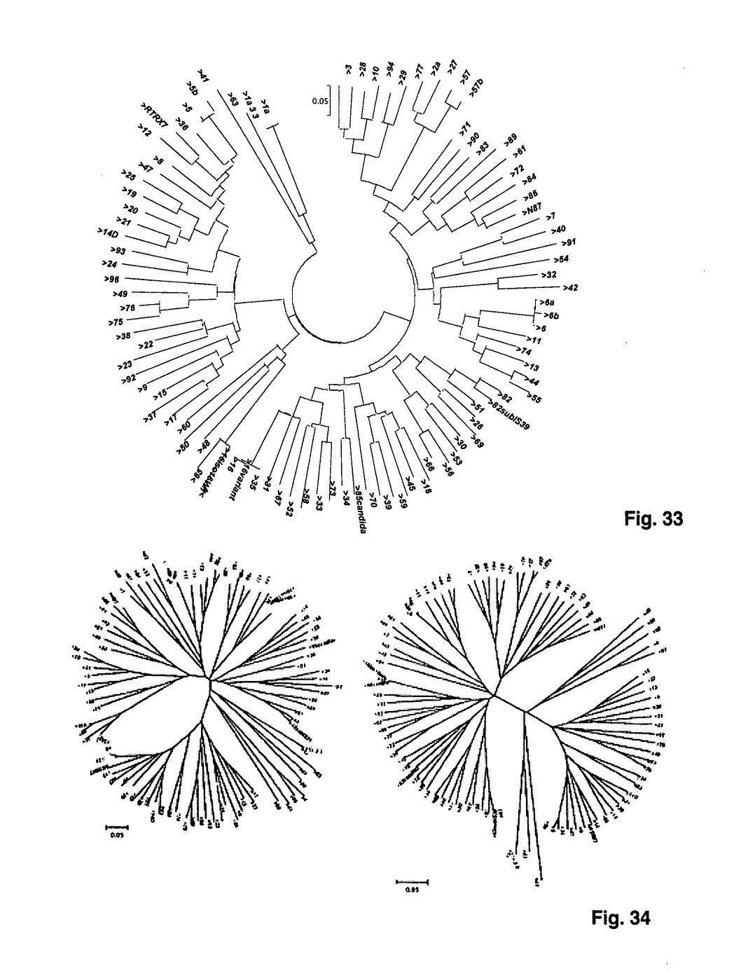

The distances calculated from the two extended scores previously described are shown in FIG. 33. For this calculation virtual hybridization was performed with UFC-8 mer and the distances were calculated from the extended scores using an alignment extension of 10 and thresholds values of 11 or 16. Genome sequences were aligned with the program Clustal W 1.83 and distances are calculated as p-distances. It can be seen that the distances calculated with the extended scores allowing two mismatches (threshold value of 16) has the better correlation with the distances derived from the alignment. The tree calculated with this score system is shown in FIG. 34 (panel a) as well as the tree derived from the alignment (panel b). All trees were calculated from the distance data with the neighbor joining NJ algorithm using Phylip 3.6. Although there are considerable differences between the trees, they show several similarities. However although the distances derived from the Clustal alignment have been taken as reference, it must be considered that global multiple alignments obtained by this program are not optimal. Clustal uses a heuristic method for multiple alignment which is prone to errors especially for divergent sequences. Errors are propagated during the alignment and the most distant sequences can have considerable errors in the alignment. The extended match score approach can be considered as a method that used local alignments to derive the phylogenic distances. It is known that local alignments provide more reliable information about similarity between sequences than global alignments. Therefore this example illustrates how the Karlin and Altschul statistics can be conveniently used to estimate extension and threshold values for this phylogenetic approach.

### Example 15

### Gene Expression Profiling with Universal Fingerprinting Chip

It is expected that the pattern of hybridization signals in a fingerprint arising from cDNA or RNA samples will reflect the pattern of gene expression. The universal fingerprinting chip system disclosed herein can be adapted for gene expression profiling as follows. If gene sequences of interest are known, one or more coding sequence databases (e.g. cDNA sequences in eukaryotes or gene sequences in prokaryotes) can be first interrogated by a universal fingerprinting probe set using virtual hybridization to select probes that correspond to the known transcripts or cDNAs. The probe length or other selection parameters in the probe set design process described previously can be adjusted to accommodate the genetic complexity of the cDNA or RNA molecules of interest. Preferably, there should be at least three unique probes per transcript. For mammalian transcriptomes (total length on the order of 6×10⁷ bases) a 14mer probe set appears appropriate, while for bacterial transcriptomes a 12mer probe set may be sufficient. Additional probes (derived from appropriate coding sequence databases) can be added to the probe set if necessary to represent each known or predicted transcript by at least one probe.

Although it is preferable to retain maximum discriminatory power of the probe set by having three or more spaced and internal differences in the probe design, this restriction may be relaxed in the case of expression profiling within gene families comprised of closely related sequences, or when comparing transcriptional profiles of closely related organisms. Similarly, a specialized probe set targeted to conserved gene sequences among divergent species could also be designed. Specialized fingerprinting chips containing fewer probes can also be designed for groups of genes associated with specific biological functions or pathways, such as those associated with mitochondrial function, oxidative response, signalling pathways, etc. An alternative “sequence-directed” approach for developing a probe set for expression profiling would be to assemble all known expressed or coding sequences within a broad class of organisms (e.g. higher eukaryotes, mammals, vertebrates, plants, or microorganisms) into a coding sequence database which is then used as a starting point to define all n-mer sequences contained in the coding sequence database. The probe set for expression profiling of the desired class of organisms would then be designed by performing the same sequence selections steps that were described in the present disclosure. This alternative design approach is applicable to both universal and specialized types of transcriptional fingerprinting chips.

An important feature of universal fingerprinting chip is that it can be used for fingerprinting whether or not the target sequences are known. Therefore, transcriptional profiling can be carried out even though the organisms under study have little or no sequence information available. In this case, the probe sets selected from comprehensive sequence databases as discussed in the previous paragraph are preferably used for transcriptional fingerprinting in organisms having limited or no known gene sequences. Appropriate choices of probe length are guided by the Poisson distribution equation described above and depend on the genetic complexity of target nucleic acids.

Hybridization of cDNA or RNA from two sources of interest, such as normal vs. tumor tissue samples, or virulent vs. nonvirulent microbial strains, to universal fingerprinting chips will generate two transcriptional fingerprints that reflect differential gene expression patterns and thus reveal sequences of biotechnological interest. A differential fingerprint image can be created by comparing two independent images. Such images can arise from different samples, for example from two related organisms or a single organism exposed to two environmental conditions. The relationship between the two samples can be easily seen and calculated from the proportion of common hybridizations.

Differences between two samples can be qualitatively visualized by using appropriate combination of colors. For example, one sample can be labeled with one fluorescent color and the other sample with a different fluorescent color. Various software programs can transform each fluorescent signal to a “pseudocolor” (eg. red or green). Superimposing these two colors gives a third color (yellow in this case), which indicates that a hybridization signal of similar intensity is obtained from both samples.

The above red/green/yellow pseudocolor representation would give a qualitative view of differential gene expression profiles, which is useful to visualize gross differences in gene expression. In reality, the range of hybridization signal intensities across the array will vary over a wide range rather than being a +/−result. Thus, quantitative differences across the entire array of hybridization spots for two or more samples are preferably computed in a spreadsheet format that considers differences between individual array elements as well as differences between hybridization images from different fingerprinted samples. A variety software packages are available for handling hybridization data in microarray-based gene expression analyses. The results are typically output in spreadsheet format with “n-fold” differences (increases or decreases) reported for each array element or gene (if known). To provide increased statistical certainty, experiments are preferably repeated several times. If commercially available RNA or cDNA standards (representing known gene sequences over a range of relative abundances) are included in the experiments, a reasonable estimate of absolute transcript abundances can be made. Of course, accuracy of the results will be affected by the quality of the RNA or cDNA sample (influenced by RNA degradation during sample preparation), sensitivity and linearity of detection, and microarray surface configuration (flat surface versus 3-dimensional array supports).

### Example 16

### Phylogenetic Analysis with Universal Fingerprinting Chip

An important piece of evidence in the “in silico” universal fingerprinting chip (UFC) validation was the generation of phylogenetic trees from virtual hybridization analysis of many HPV, HIV and SIV viral genomic sequences as described above. The phylogenetic trees generated by this virtual hybridization approach were in strong agreement with those obtained from traditional approach of analyzing aligned genomic sequences. It is envisioned that phylogenetic trees can also be derived experimentally from hybridization fingerprints on DNA samples derived from a collection of biological samples. These experimentally derived fingerprints can be used, in exactly the same way as was done with the virtual fingerprints (e.g. using the Phylip software) to generate phylogenetic trees.

The field of phylogenetics can benefit greatly from the universal fingerprinting chip (UFC) approach. The UFC approach to phylogenetic tree construction is applicable to a variety of species and target genes. It can be carried out using cellular DNA samples in the case of prokaryotes and simple eukaryotes, and using chloroplast, mitochondrial or cellular DNA in higher eukaryotes. DNA samples are typically subjected to PCR (preferably multiplex) to reduce genetic complexity, select desired (polymorphic) regions and introduce fluorescent, chemiluminescent or chromogenic tags for hybridization signal detection. Alternatively, DNA sample can be subjected to the following non-PCR method to generate the desired target fragments prior to hybridization to the UFC: (i) fragmentation by physical shearing or endonuclease digestion; (ii) passage through an affinity column of gene-specific oligonucleotide probes tethered to beads to fish out the desired genetic regions; (iii) denaturation and elution of bound target strands; (iv) end-labeled using polynucleotide kinase. As discussed previously, appropriate choice of UFC probe length will depend on the genetic complexity of the samples. It is envisioned that each sample could be subjected to UFC fingerprinting in a single hybridization experiment, generating fingerprints that could be analyzed to generate a phylogenetic tree rapidly and cost effectively. In general, after labeled fragments of DNA are prepared by a method such as PCR or oligonucleotide affinity described above, they are hybridized to a universal fingerprinting chip to generate differential fingerprints. Taxonomic trees can then be generated by analytic program such as the PHYLIP software along with algorithms for distance measures between hybridization patterns and dendogram building, as described in Example 11.

### Example 17

### Detection And Purification Applications Using ZipCode Strategy

Norman et al. (1999) described a microarray “ZipCode” method to search for point mutations. A collection of 24-mer ZipCode probes, comprised of combinations of six groups of four bases, were arrayed onto microarray surface to create a “universal” chip. Target DNA was used as template to ligate two oligonucleotides. The first oligonucleotide was a chimeric sequence containing a stretch of bases complementary to target sequence plus a sequence complementary to the ZipCode sequence (anti-ZipCode). A second fluorescent-labeled oligonucleotide hybridized in tandem to the first oligonucleotide on target DNA. Base variations associated with the point mutations were placed at the end of the first chimeric oligonucleotide next to the junction with the labeled probe. Thus, ligation occurred only when the sequences at the junction are perfectly complementary. The ligation product was then hybridized to the array of ZipCoded probes, and the location of fluorescence on the ZipCode array would reveal which single nucleotide polymorphism (SNP) allele was present in the target DNA (FIG. 28). The advantage of the ZipCode strategy is that a single, universal microarray can be used for analyzing any target sequence with appropriate fluorescent and chimeric probes for each application. Because a key feature of the probe design of the present invention is diversity of probe sequences, it is envisioned that the universal fingerprinting chip of the present invention can serve as a universal array to search for single nucleotide polymorphism, and other sequence variations, using the ZipCode strategy. A critical consideration in the selection of UFC probes for the ZipCode strategy is to use sequences having the same Tm values in order to have discrimination depending only on the sequences involved. Otherwise, groups of UFC sequences for ZipCode purposes, having very different Tm values for each group, can be used to reach separations, purifications and identifications by combining both stringency and sequences involved. Very specific ZipCode sequences can be obtained by the combination of two or more 13-mer UFC probe sequences. The combination of 13-mer UFC probe sequences can simultaneously take into account their Tm values to reach the desired final Tm value.

A key characteristic of each ZipCode sequence is that it must be unique and hybridize only to its anti-ZipCode complementary region of the chimeric target-binding probe. Not only is it essential that each ZipCode sequence will not hybridize to any of the other anti-ZipCode sequences used in a “universal array,” but it is equally essential that each ZipCode sequence will not hybridize to the target sequence that is being analyzed. Since the UFC contains a wide diversity of oligonucleotide probes, some of which will be complementary to any given target analyte and others of which will not hybridize to a given target analyte, the Virtual Hybridization module of the UFC system may be used to select probes in any given UFC set that will not hybridize with any target sequence of interest, and therefore identify a subset of UFC probes that can serve as specific ZipCode sequences for any given target sequence, such as a genome, transcriptome, cDNA, amplicon or mixture of amplicons. Alternatively, the UFC can be hybridized with any desired nucleic acid analyte to identify the subset of UFC probes that fail to hybridize with the target analyte and are thus suitable for use as ZipCode sequences for analysis of said analyte.

In addition to being applied in the original ZipCode strategy as discussed above, the universal fingerprinting chip (UFC) of the present invention can also be applied in an expanded array of ZipCode strategies not described previously. For example, the UFC probes can be used as ZipCode probes in a “liquid array” platform such as the Luminex system. The UFC probes can also serve as ZipCode capture reagents to purify target sequences and anything else bound to them including proteins, cells, etc. Furthermore, combinations of UFC probes will be sufficiently long to provide strong duplex stability even at high temperatures. These additional ZipCode applications are illustrated below.

### Non-Chip Analysis of DNA Using ZipCode UFC Probes as Adapters Attached to Color-Coded Beads

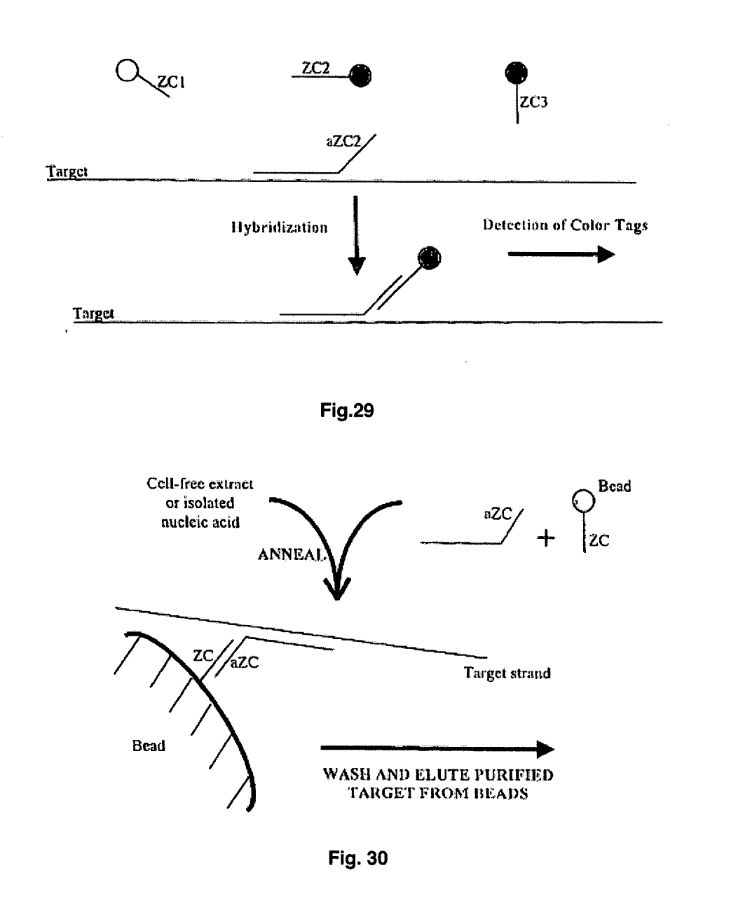

Specific universal fingerprinting ZipCode probes can be covalently attached to different “color-coded” beads, enabling target DNA sequences to be detected with appropriate chimeric oligonucleotides comprised of anti-ZipCode sequence linked to anti-target sequence (FIG. 29). In the bead strategy depicted above, the beads are preferably nanometer- to micrometer-sized particles composed of glass, ceramic materials, metals, metal oxides, rigid polymeric materials such as latex, soft polymeric beads such as polyacrylamide, dendronic structures, micromachined particles of variable shape, or any other particles known to practitioners of the art. The “colors” can include a variety of fluorophores, chromophores, electrophores, mass tags, or luminescent tags including “photonic dots” and chemiluminescent species. The ternary bead complexes are physically separated, preferably by flow cytometry, then “decoded” by any available instrumentation capable of distinguishing between the tagants, such as optical or mass spectrometry. An attractive feature of the bead approach described above is the high multiplexing potential enabling simultaneous analysis of numerous samples or analysis of numerous sequence features within a single sample. Such multiplexing capability is due to the combination of diverse universal fingerprinting probe sequences with numerous tags. The tags can be comprised of individual distinguishable tagants, or mixtures of tagants yielding complex “spectral signatures” unique to each bead, and the tags can be bonded to the surface of a solid bead, bonded to the interior of porous or polymeric beads, physically encapsulated within the beads, or soaked into the beads.

### Purification of DNA or RNA Using ZipCoded Beads

Purification of specific nucleic acid sequences from a crude cell-free extract or nucleic acid preparation can be easily performed by attaching ZipCode sequences to beads, annealing the sample with anti-ZipCode oligonucleotide, and washing the beads and eluting the purified target (FIG. 30).

### Simultaneous Purification of Numerous Targets Using ZipCode and Manifold

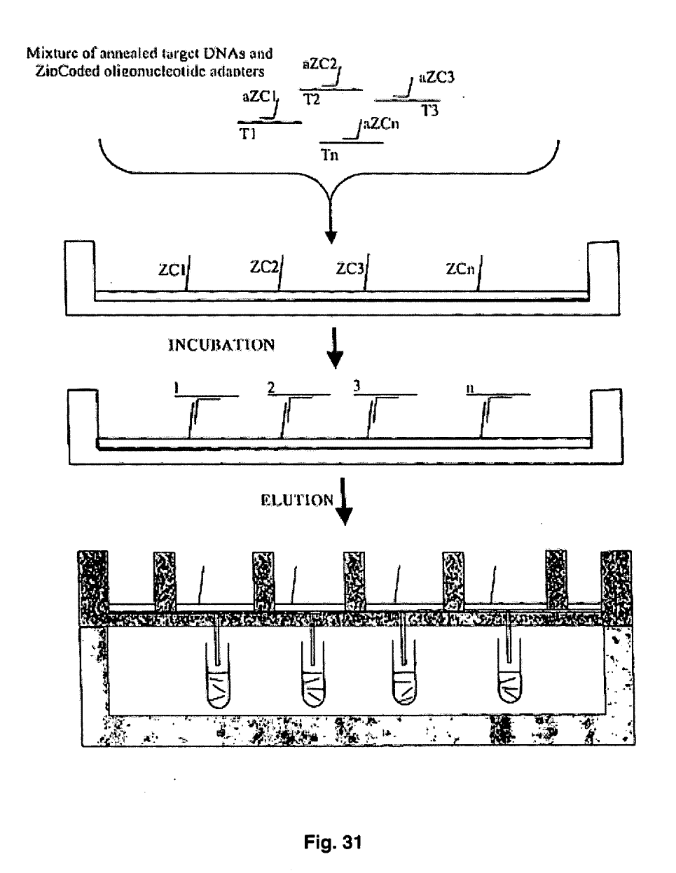

As depicted in FIG. 31, arrays of many different ZipCode oligonucleotides can be covalently attached to membranes or fitted materials, e.g. within individual regions in the 96-, 384- or 1536-well format. A sample containing many DNA sequences to be purified is incubated with the corresponding oligonucleotide adapters (chimeric oligonucleotides comprised of a sequence recognizing a specific target plus a particular anti-ZipCode sequence). The product is incubated with the membrane under annealing conditions. After washing the DNAs can be eluted from isolated manifold cells under denaturing conditions.

### Example 18

### Cluster Associated Fingerprinting Chips

The universal fingerprinting chip of the present invention has the potential to be applied to identify organisms at all levels of divergence, from highly related to almost unrelated organisms. Nevertheless, in many cases, where DNA sequences are available and a specific diagnostic task is required, a much less complex diagnostic fingerprinting chip will be sufficient to identify species or genotypes of interest.

One example of great significance is the identification of high risk papillomavirus types in cervical samples, and it is envisioned that this can be achieved using simpler fingerprinting chips named “cluster associated fingerprinting chips” derived from full universal fingerprinting chip (UFC). As shown above, theoretical validation of fingerprinting capacity of 13mer and 11mer UFCs by virtual hybridization (VH) on genomic sequences of HPV (human papilloma virus), HIV (human immunodeficiency virus) and SIV (simian immunodeficiency virus) revealed a strong correlation between their phylogenetic relationships and their fingerprints. This virtual hybridization analysis also revealed when a single probe is or is not recognized by one, two or several groups of viruses, and indicated the location of hybridization sites in the viral genomes. This analysis also revealed when the hybridization sites corresponded to similar sequence context in two or more viruses.

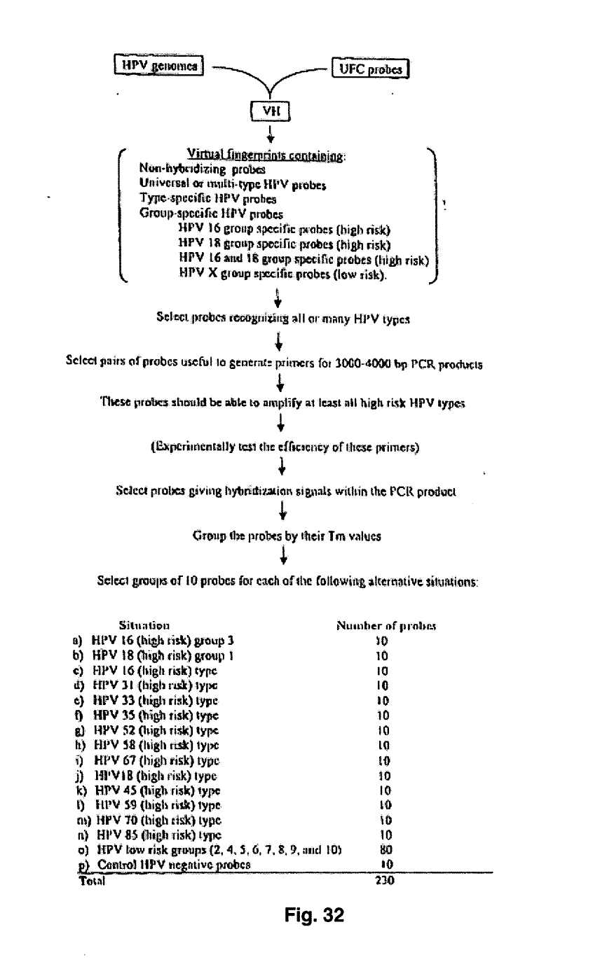

Therefore this information can be used to design simpler, specialized fingerprinting chips containing a subset of UFC probes, such as a chip able to identify high risk HPV types, HPV variants and low risk groups of HPV types (FIG. 32). A given probe may yield a hybridization signal with only one HPV type, in which case it is selected for the cluster associated fingerprinting chip. At other times the probe may give signals with two or more HPV types. In this case the reference sequences of the HPV types detected can be extracted and aligned to search for their differences. If they are similar, the probes are selected to search for those HPV types. In other cases, one probe may give signal with one mismatch in two different HPV types, but with each mismatch occurring at a different target site or involving a different base change. Then, each of the two different HPV sequences can be used as a probe in the cluster associated fingerprinting chip. This cluster associated fingerprinting chip (CAFC) design is envisioned to permit detection and identification of high risk HPV types, HPV 16 variants and low risk HPV groups with high confidence, leading to prediction of the risk of developing cervical cancer and providing therapeutic guidance in a much simpler and economical device. The use of 10 probes for each type or group will guarantee detection even in the presence of single base variations in the sequences of HPV types under scrutiny. The original UFC design, with probes having three internal and spaced base variations, will guarantee CAFC's high specificity.

As discussed above, in cases where extensive databases exist for genetic regions of known sequence diversity, the same general approach can be followed to generate a variety of CAFCs targeted to rRNA genes, mitochondrial and chloroplast genomes, etc. Although the HPV genotyping example given above specified ten probes for each type or group, this number can be greater or smaller than ten depending on specific application. Similarly, the CAFC approach can utilize probes of varying length to minimize Tm differences across a given chip or to accommodate different degrees of genetic complexity in target DNA. The CAFC approach can also be applied to analysis of multiplex PCR products and for direct genomic DNA analysis without PCR.

### Example 19

### Virtual Hybridization Analysis of Bacterial Genomes Using the 13-mer UFC

The 13-mer UFC performance with bacterial genomes was tested by virtual hybridization. For this purpose a total of 191 fully sequenced bacterial genomes were obtained from GenBank. In this analysis we included only bacterial genomes fully sequenced without ambiguous base calls. These genomes were submitted to virtual hybridization against the UFC probe set to obtain their genomic fingerprints as follows: The UFC set, which has a Tm range from 52 to 68 centigrade degrees, was divided into 17 subsets, each having one degree centigrade of Tm range. Virtual hybridizations were done with each subset for all the genomes. The virtual hybridizations were done under conditions allowing only the formation of perfect matched and single mismatched duplexes.

Several examples of UFC fingerprints generated by Virtual Hybridization of the UFC-13 with bacterial genomes of known sequence are shown below. Although these VH-predicted fingerprints were obtained by analysis of only one strand, the analysis can easily be extended to both strands, comparable to an experimental UFC fingerprint experiment.

As an example of the bacterial fingerprints with the UFC, the images corresponding to Mycoplasma pulmonis UAB CTIP (gi 15828471) which has 963,879 bp and 16.64% [G+C] and Mycobacterium avium subsp. paratuberculosis strain k10 (gi 41406098) having 4,829,781 bp and 69.30% [G+C] are shown (FIG. 37). As can be seen, the number of hybridization signals was much greater in Mycobacterium avium, whose genome size is about five times larger than that of Mycoplasma pulmonis. The distribution of hybridization signals was also different. In Mycoplasma pulmonis most signals were located on the left side of the image, while in Mycobacterium avium they were on the right side. This is due to the distribution of probes in the array, since they were placed according to increasing Tm values, with those at the left having lower Tm and lower [G+C] content.

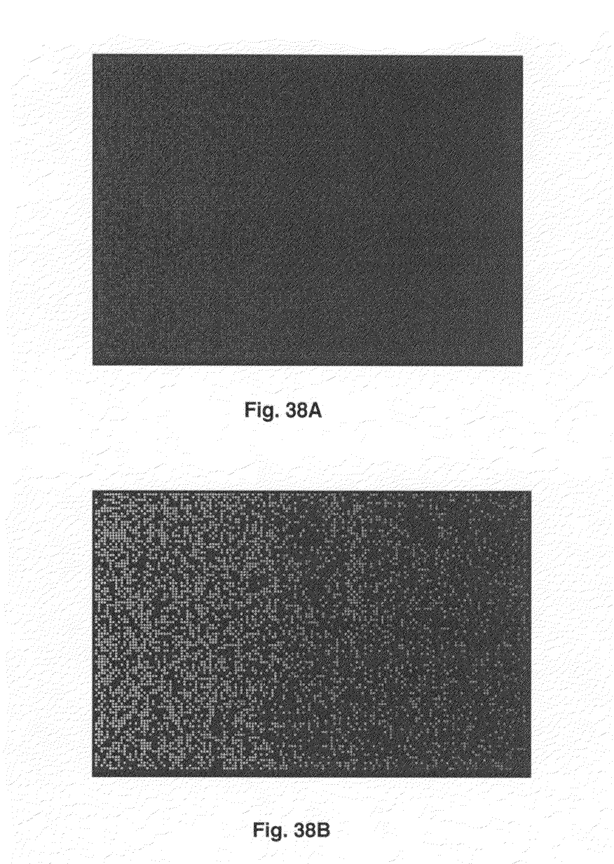

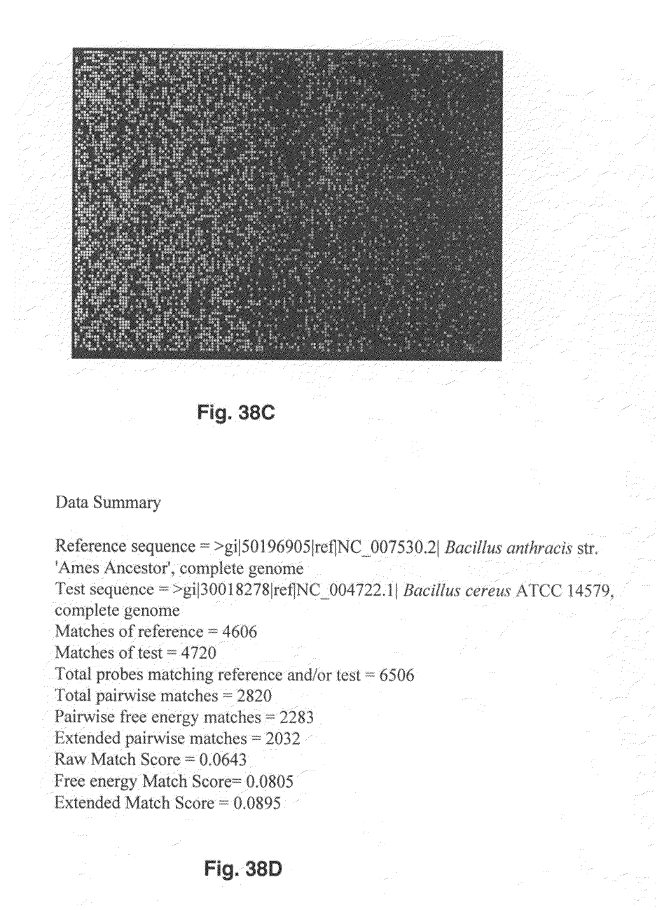

The fingerprinting example described above represents two unrelated bacterial species. The fingerprinting power of the UFC can be further demonstrated by comparing closely related species, for example Bacillus cereus and Bacillus anthracis, which are difficult to distinguish on the basis of widely used 16S rRNA gene sequence. As seen in FIG. 38, numerous differences between these closely related species can be revealed using the UFC-13. The fingerprint for Bacillus cereus (green dots) and Bacillus anthracis (red dots) was done in conditions similar to those previously described. The overlapping of both fingerprints, shows a great number of differences (red and green dots) in addition to the shared (yellow) signals. Thus, these closely related bacterial species can be easily discriminated with the UFC.

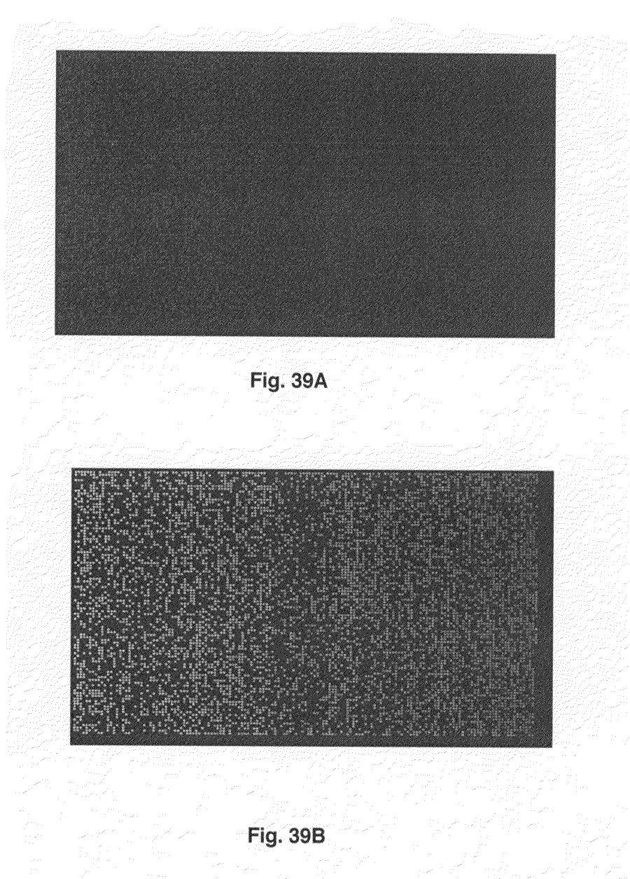

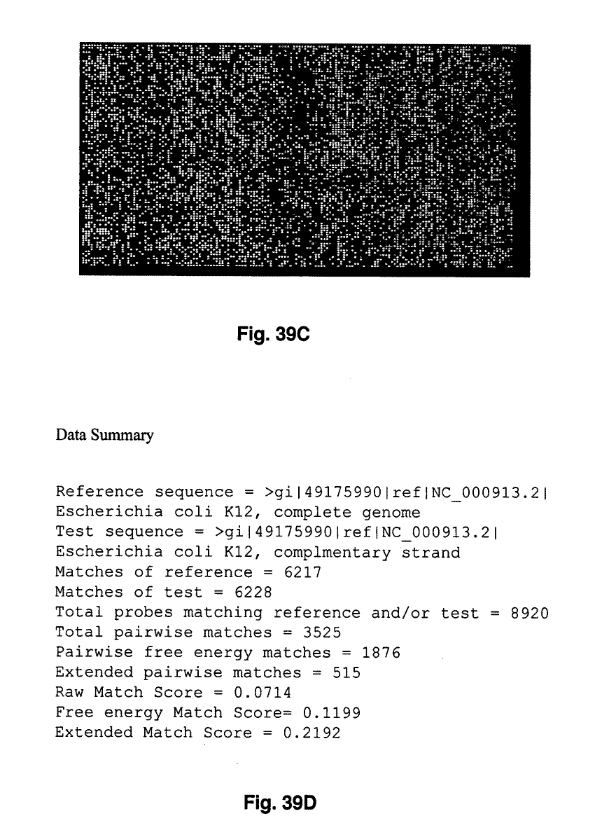

For greater relevance to experimentally obtained UFC hybridization data it is useful to extend the UFC/VH analysis to both strands of genomic DNA. The virtual hybridization data for both strands of the Escherichia coli genome, considering one strand at a time and considering both strands combined, are shown in FIG. 39. Shown are three images for the fingerprints obtained with E. coli K12, one for the direct strand (Genbank sequence submission), another for the complementary strand, and the last showing the superposition of both. Panel D shows a brief description of the fingerprint analysis for E. coli indicating the number of matches on each strand and the number of signals shared.

### Example 20

### Estimation of Phylogenetic Relationships from VH Results

A database containing all the bacterial fingerprints obtained by VH analysis with the UFC-13 was built. Each bacterial fingerprint was compared against each of the others in order to calculate a distance measure between fingerprints (the distances are based in the number of signals which are shared between two fingerprints). All distances were collected in a pairwise distance table which was used to calculate a tree using the Neighbor-Joining algorithm which is implemented in the programs Phylip 3.6 and MEGA3. The nearest-neighbor algorithm is a traditional algorithm described in the phylogenetic literature, which is used to calculate trees from distance data. There are other programs available to calculate trees from distance data, such as the UPGMA, or the Fitch-Margoliash which could be alternatively used. Phylip and MEGA are public-domain programs which have their own implementations of the Neighbor-joining algorithm. Thus, although we have used Phylip and MEGA programs to build the tree, a variety of other programs could be used to calculate the trees, using the same algorithm.

Under the stringency conditions tested, the most similar bacterial strains separated were Bacillus anthracis var Ames and Bacillus anthracis var Ames Ancestor. They were separated with a score of 0.000017. Their genomes have a difference in size of 126 bp, and careful analysis of their alignment revealed 27 different sites along their genomes, consisting of 15 single base substitutions, 4 single base eliminations, and 8 additions (with a total of 130 bp inserted). Therefore the total difference is 15+4+130=149. This quantity was divided by the average of the two genome sizes to obtain a quotient of 0.0000285. These considerations suggest that a single base difference within a region of approx. 35,000 bp can be detected using the UFC under the conditions tested. It is anticipated that by slightly relaxing the hybridization stringency an even wider strain resolution can be achieved.

The confidence of the bacterial organization produced by fingerprinting with the UFC was assessed by comparing the bacterial list in this tree (UFC-Tree), with the bacterial list produced by the tree obtained from the alignment of sequences contained in the ribosomal (conserved) genes, which is published in the TIGR-Tree. Due to the great differences in the bacterial order between both trees, a third tree was constructed with the fingerprint of conserved signals contained in the fingerprints producing the UFC-Tree. The conserved signals contained in the fingerprints producing the UFC-Tree were detected by comparing all the shared conserved signals for the 191 bacteria as follows:
i) The hybridization signals shared by each pair of genomes were detected.
ii) The sites recognized for a given 13-mer probe in a shared signal between two genomes were obtained.
iii) The two genome sequences that share such signal are aligned in the site recognized by the 13-mer probe. Then the site is extended by adding the 4 bases flanking both sides of the site in order to obtain a site which is 21 bases long. The number of bases used for the extension was calculated from a formula described by Karlin and Altschul. This number corresponds to the number of bases required in order to obtain an extended aligned section of a length such that the probability of finding by random occurrence a shared section of such length between two genomes of a given length is very low. The length of the genomes used to calculate the number of bases for the extension was the average genome length. A further improvement could be the automatic calculation of the most convenient extension length by using the actual length of the genomes that are being compared. This extension approach is similar to the hit extension algorithm implemented in BLAST which is used to calculate similarity between two sequences and it can be described as a local alignment tool.
iv) If the number of identical bases in this 21-base region shared between the two genomes is higher than a defined threshold (for bacteria this threshold is equivalent to allowing a single base difference) as calculated with the Karlin-Altschul's formula, then this site is stored as an extended or conserved match.
v) A new table of distances between fingerprints is calculated considering only the conserved matches in order to produce a table of distances between conserved fingerprints.
vi) The table of distances between conserved fingerprints is then used to construct an Extended UFC-Tree using the neighbor-joining algorithm.

The three trees discussed above were next compared using as reference the bacterial classification published in The Institute for Genomic Research web page. The analysis shows that all the bacterial species were generally well grouped into their genera in their respective trees (data not shown). However, a different degree of separation of bacterial species belonging to same genera, for each tree, was observed (Table 11). In the TIGR-Tree only slight separation (total distance of 7) of species belonging to 3 genera was obtained. In the UFC-conserved-Tree a wider separation (total distance of 64) affecting 7 genera was observed. The widest separation was produced with the UFC-Tree (total distance of 252) affecting 8 genera.

To explain this difference three analyses (genome size, [G+C] content and pair-wise genome alignments) were performed. This analysis showed (Table 12) that there was a notable difference in the G+C content in those bacterial species, belonging to the same genera, which were separated in the UFC-Tree. There was not a direct correlation with the separation of bacterial species belonging to the same genera with the genome size, except in some notable cases such as in Mycoplasma, Bacillus and Lactobacillus. Additionally in the case of Lactobacillus the genome alignments showed a strong similarity (diagonal) between the genome sequences of Lactobacillus acidophilus and Lactobacillus johnsoinii, which were listed next to each other in the UFC-Tree, while no similarity was shown between the genome of these two species and the genome of Lactobacillus plantarum, which was located 91 positions away. Therefore, it seems that there is a good correlation between the differences in the genomes and the separation of species in the UFC-Tree.

TABLE 11
Separation of bacterial species belonging to the same genera

| | TIGR-Tree | | | UFC-conserved -Tree | | | UFC-Tree | | |
|---|---|---|---|---|---|---|---|---|---|
| Genera | Position | Partial Δ | Distance | Position | Partial Δ | Distance | Position | Partial Δ | Distance |
| Pirococcus | — | — | — | 9, 10, 12 | 2 | 2 | — | — | — |
| Thermoplasma | — | — | — | — | — | — | 67, 79 | 12 | 12 |
| Corynebacterium | — | — | — | — | — | — | 146, 160, 184 | 14 + 24 | 38 |
| Mycobacterium | — | — | — | 118-120, 122 | 2 | 2 | 150, 152-153, 189 | 1 + 36 | 37 |
| Chlamydia | — | — | — | 38-40, 43-44 | 3 | 3 | — | — | — |
| Synechococcus | 25-26, 29 | 3 | 3 | 143, 146 | 3 | 3 | — | — | — |
| Prochlorococcus | 27-28, 30 | 2 | 2 | — | — | — | 22, 31, | 9 | 9 |
| Bacillus | — | — | — | — | — | — | 94-98, 115-119 | 17 | 17 |
| Lactobacillus | — | — | — | 89, 101-102 | 12 | 12 | 32-33, 124 | 91 | 91 |
| Mycoplasma | — | — | — | 18, 20-22, 60-63 | 2 + 38 | 40 | 2-3, 5-7, 16, 35 | 2 + 2 + 7 + 19 | 30 |
| Agrobacterium | — | — | — | 129-130, 132-133 | 2 | 2 | — | — | — |
| Helicobacter | 92-93, 95 | 2 | 2 | — | — | — | — | — | — |
| Pseudomonas | — | — | — | — | — | — | 156-157, 175 | 18 | 18 |
| Separation | 3 cases | | 7 | 7 | | 64 | 8 | | 252 |

TABLE 12
GENOME SIZE (bp) AND G + C (%)
CONTENT IN THE SPECIES OF THE SAME
GENERA BEING SEPARATED IN THE UFC-Tree

| Mycoplasma (2-3, 5-7, 16, 35) | | |
|---|---|---|
| micoides | 1 211 703 | 23.97 |
| mobile | 777 079 | 24.95 |
| penetrans | 1 358 633 | 25.72 |
| pulmonis | 963 879 | 26.64 |
| hyopneumoniae | 892 758 | 28.56 |
| gallisepticum | 996 422 | 31.45 |
| genitalium | 580 074 | 31.69 |
| pneumoniae | 816 394 | 40.01 |
| Prochlorococcus (22, 31) | | |
| marinus | 1 657 990 | 30.80 |
| marinus | 1 751 080 | 36.44 |
| Lactobacillus (32-33, 124) | | |
| johnsonii | 1 992 676 | 34.61 |
| acidophilus | 1 993 564 | 34.71 |
| plantarum | 3 308 274 | 44.47 |
| Thermoplasma (67, 79) | | |
| volcanium | 1 584 804 | 39.92 |
| acidophilum | 1 564 906 | 45.99 |
| Bacillus (94-98, 115-119) | | |
| cereus | 5 411 809 | 35.28 |
| cereus | 5 300 915 | 35.35 |
| anthracis A | 5 227 293 | 35.38 |
| anthracis A A | 5 227 419 | 35.38 |
| anthracis S | 5 228 663 | 35.38 |
| subtilis s | 4 214 630 | 43.52 |
| halodurans | 4 202 352 | 43.69 |
| clausii | 4 303 871 | 44.75 |
| licheniformis | 4 222 645 | 46.19 |
| licheniformis | 4 222 334 | 46.20 |
| Corynebacterium (146, 160, 184) | | |
| diphtheriae | 2 488 635 | 53.48 |
| glutamicum | 3 309 401 | 53.81 |
| efficiens | 3 147 090 | 63.14 |
| Mycobacterium (150, 152-153, 189) | | |
| leprae | 3 268 203 | 57.80 |
| tuberculosis | 4 411 532 | 65.61 |
| bovis | 4 345 492 | 65.63 |
| avium | 4 829 781 | 69.30 |
| Pseudomonas (156-157, 175) | | |
| syringae | 6 397 126 | 58.40 |
| putida | 6 181 863 | 61.52 |
| aeruginosa | 6 264 403 | 66.56 |

There is some correlation between G + C content and the separation of bacterial species and their location in the tree

The grouping of bacterial genera in the TIGR and UFC trees is shown below. The first column shows the classical bacterial taxonomy obtained from PubMed. The second (TIGR-Tree) column shows the 12 groups of (88) bacterial genera obtained from the alignment of amino acid sequences contained in 32 conserved ribosomal proteins. The third (UFC-Conserved-Tree) column shows the 11 groups of (51) bacterial genera obtained from the conserved sequences contained in the UFC fingerprint. The fourth (UFC-Tree) column shows the 3 groups of (22) bacterial genera obtained from the raw UFC fingerprints. Groups are those containing 3 or more genera. It is notable that better separation was obtained using the raw UFC fingerprints.

The results shown above suggest that the UFC fingerprints can be confidently used to classify and identify bacterial species. However, the comparison should be reinforced by estimating the confidence of the clusters calculated in each of UFC trees. This confidence value corresponds to the probability that a particular sequence belongs to a given cluster (the cluster to which it has been assigned by the algorithm) with respect to the probability that the same sequence can belong to different clusters. This kind of test is of particular interest because a situation which is commonly present in classification or taxonomic techniques is that frequently contradictory data (i.e., situations where a taxa is placed in different clusters under different classification studies) are usually associated with low confidence values of cluster assignment. Therefore, statistical tests are required to estimate appropriate confidence values. Statistical tests frequently used to evaluate confidence values are the bootstrap techniques which consist of randomly sampling with repetition the whole database of fingerprints to produce other random fingerprints. A number of 100 to 1000 new random fingerprints are required and for each random fingerprint a tree is derived as with the original fingerprint. The 100 or 1000 trees obtained are compared in order to obtain a consensus tree. This consensus tree includes the number of times (or the percentage) that each branch appeared in the whole collection of random trees. High values (>75% or higher) are indicative of high confidence in a particular cluster. Low values indicate that some of the sequences included in the cluster have been included several times in other clusters (frequently these are the sequences that are contradictory compared with other classifications and indicate that the fingerprint is not definitively associating a sequence with a particular cluster). Bootstrap techniques should be investigated in depth as the procedure is a time-consuming process. This is the type of process that could be performed in a multi-threading application, as each random tree can be calculated and manipulated in a separate process. If several processes are run simultaneously, then the calculation of the bootstrap tree can be done faster.

### Example 21

### UFC Hybridization Detection by Post-Hybridization Template-Directed Single Base Addition

As discussed earlier, a commonly employed means for visualizing UFC hybridization fingerprints comprises labeling of the nucleic acid sample prior to its hybridization to the UFC. Another way to achieve quantitative visualization of the hybridization fingerprint is to introduce the label following the hybridization step. This can be achieved as follows. If the UFC probes are attached to the chip surface at the 5′-end and have a free 3′-OH end, the hybridized target strands can serve as template for DNA polymerization catalyzed by E. coli DNA polymerase 1 Klenow enzyme or any other DNA polymerase commonly used in DNA sequencing, in a reaction containing labeled 2′,3′-dideoxynucleoside triphosphate substrates (ddNTPs) rather than the unmodified dNTPs. Under these conditions a single ddNTP residue will be incorporated onto the 3′-end of UFC probes that have captured (hybridized to) a target strand. If each of the four ddNTPs is labeled with a different, distinguishable fluorophore, as in DNA sequencing applications, then the “color” introduced at each UFC probe site in the array where hybridization has occurred depends on the first template residue adjacent to the 3′-OH terminus of the probe.

This embodiment of UFC hybridization fingerprinting has several advantages over the use of prelabeled targets: (i) there is no need to label the target nucleic acid; (ii) the identity (“color”) of fluorophore incorporated at each site of hybridization will identify the next base adjacent to the 3′-end of each n-mer probe, which reveals “n+1” sequences in the target, thus increasing the information content of the fingerprint, and if a “complementary UFC” is also used the combined results will reveal “n+2” sequences in the target; (iii) if any given UFC probe hybridizes with more than one target sequence, this may be revealed by incorporation of more than one fluorophore (“color”) at the corresponding site in the array; and (iv) in cases where the genetic complexity of the target is too high for a UFC of given probe length (yielding hybridization at the majority of probe sites), the “multicolor” ddNTP labeling approach breaks the fingerprint into four distinct images, which facilitates interpretation of the fingerprint, compared with the corresponding result obtained using prelabeled targets. The latter feature extends the “operating range” of UFCs of any given probe length, with respect to the genetic complexity of nucleic acid samples that can be fingerprinted.

### Example 22

### Tandem Hybridization UFCs

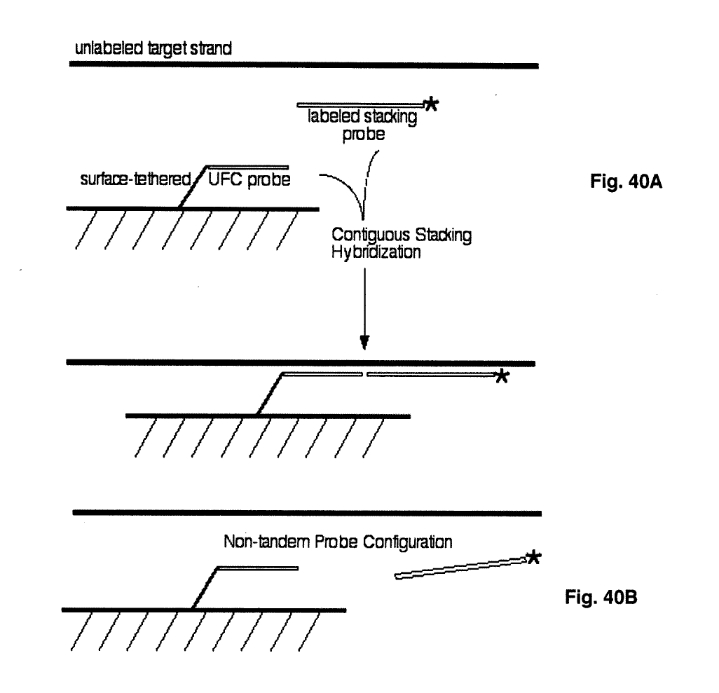

In the previous examples of UFC analysis the nucleic acid analyte is labeled, then hybridized with a UFC to create a hybridization fingerprint. In an alternative approach, described below, an unlabeled nucleic acid sample is hybridized with the UFC, together with a collection of labeled oligonucleotide “stacking probes.” As illustrated in FIG. 40, if the hybridization is carried out under conditions (typically, elevated temperature) where neither the surface-immobilized UFC probes, nor the labeled stacking probes by themselves will form a stable duplex with the target strands (lower panel), but where the longer duplex comprising UFC probe hybridized in tandem with stacking probe is stable due to the stacking interactions between the two contiguously hybridized probes (upper panel), then the pattern of hybridization across the array will reflect the tandem occurrence of UFC probes and labeled stacking probes within the target nucleic acid sequence. UFC tandem hybridization fingerprinting can be carried out in both target-independent and sequence-targeted embodiments, as explained below.

In the target-independent embodiment of tandem hybridization UFC analysis, a mixture of labeled stacking probes, representing a diversity of sequences but not designed according to any particular target sequence, are hybridized together with the nucleic acid sample on the UFC. These labeled stacking probes can be comprised of all or a portion of any given UFC probe set (of any desired probe length). Hybridization is carried out under conditions where only those labeled probes that hybridize in tandem with a UFC probe on the target will form a stable duplex, whereas neither UFC probes, nor labeled stacking probes in isolation will stably bind to the target. For example, it is known that hybridization conditions can be selected under which 10mer probes will not hybridize to the target, while a contiguous stretch of 10mer UFC probe+ 10mer labeled stacking probe, positioned in tandem to form 20 contiguous bases, is stabilized by base stacking interactions to yield a stable hybridization.

To further stabilize the tandem hybridization, if one set of probes (preferably the UFC probes attached to the chip surface at their 3′-end) is 5′-phosphorylated (either by chemical derivatization in the final step of chemical synthesis, or by action of polynucleotide kinase in the presence of ATP), to yield a 5′-phosphate adjacent to a 3′-OH terminus in the tandemly hybridizing probes, then DNA ligase can be used to form a covalent bond between the tandemly hybridized UFC and stacking probes. This procedure will allow washing at high temperature to remove all label except where tandem hybridization has occurred.

Using simple statistical equations to calculate the number of occurrences of a given n-mer sequence in a target sequence of given genetic complexity, one can predict the number of hybridization signals that will occur, on average, when a UFC of any given probe length is hybridized to a target nucleic acid of any given genetic complexity in the presence of any given mixture (number and length) of labeled stacking probes. For example, for a mixture of 1000 labeled 8mer stacking probes hybridized with a typical bacterial genome on a 10mer UFC, there should be on the order of 5,000-10,000 tandem hybridization signals. Similarly, for the same mixture of 1,000 labeled 8mer stacking probes hybridized to mammalian genomic DNA on a 15mer UFC, there should also be several thousand tandem hybridization signals.

The use of multiple labels can be particularly advantageous in tandem hybridization UFC analysis. Four different sets of stacking probes, each bearing a different fluorophore, can be mixed together and used to yield four distinguishable fingerprints in a single hybridization reaction. This “multi-color” strategy greatly increases the information content of a fingerprint.

Another attractive feature of the tandem hybridization UFC approach is the ability to adjust at will the length of UFC and labeled stacking probes and the number of labeled stacking probes used in the hybridization reaction, to achieve a “tunable” number of hybridization signals, thus allowing a single UFC to operate over a wide range of genetic complexity of target nucleic acids.

A sequence-targeted embodiment of tandem hybridization UFC analysis may be used for analysis of nucleic acid analytes (including genomes or transcriptomes) when the target sequences are known. Using genomic and expressed sequence databases, virtual hybridization analysis can be used to predict the binding locations of each member of a UFC probe set to the target sequence being analyzed, then a set of labeled stacking probes can be designed to hybridize in tandem with any desired UFC probe on the target. For transcriptional profiling, a UFC of appropriate probe length can be hybridized to the RNA sample (or cDNA), such that each transcript (or cDNA) hybridizes to at least one site in the UFC. Then, if the mixture of labeled stacking probes is targeted to the adjacent sites on each transcript (or cDNA) to yield tandem hybridization, then the relative expression levels of all targeted transcripts will be revealed by the pattern of hybridization intensities across the array. Similarly, the labeled stacking probes can be designed to interrogate sequences adjacent to UFC probe binding sites within genomic DNA, to achieve a variety of genomic analyses. In one example, the tandem hybridizations can be designed to detect unique species-specific sequences, enabling accurate species identification. In another example, the tandem hybridizations can be designed to interrogate specific DNA sequence polymorphisms such as SNPs, and sets of labeled stacking probes bearing different fluorophores can be designed to distinguish different SNP alleles. In the latter case, SNPs located at or near the junction between UFC probe and allele-specific labeled stacking probe can be easily distinguished when DNA ligase is used to covalently bond the probes, since it is known that both contiguous stacking hybridization and DNA ligation are disrupted by the presence of base mismatches.

### Example 23

### Uses of UFCs in Metagenomics

An emerging field of genomic analysis is “metagenomics” or the analysis of genetic materials extracted from environmental samples rather than from cultured organisms. Metagenomics involves the study of microbial communities in their natural environments, such as soil, water, sediment, sludge and industrial fermentation samples, without the need to isolate and cultivate individual organisms. Since environmental samples may contain hundreds to thousands of species, many of which may be unculturable and/or unsequenced, the emerging field of metagenomics is a significant area of application for UFCs since fingerprints do not depend on prior knowledge of the sequence and since comparison of any experimentally derived fingerprint with the Fingerprint Reference Datasets (as described in Example 13) can lead to species identification.

Several ways in which UFCs can be applied in metagenomics are envisioned. For example, following establishment of a Fingerprint Reference Data Set representing a comprehensive collection of microbial genomes, a set of species-specific UFC probes which uniquely hybridize with various microbial genomes can be specified. Then, upon analysis of nucleic acid (DNA or RNA) extracted from an environmental sample using one or more UFCs, the pattern of hybridization at species-specific probes across the UFCs will reveal the presence of specific species in the sample. Thus, the Fingerprint Reference Database can be used to select a specialized set of species-specific probes (representing the full range of microbial genomes) to be included in a “species-centric” UFC that can be used to detect the spectrum of organisms present in microbial communities in environmental samples. This approach is applicable to both the “regular” UFC fingerprinting approach as well as the “tandem hybridization” embodiments described in Example 22.

By querying a database of all sequenced microbial genomes, sets of species-specific probes hybridizing in tandem with UFC probes on different microbial DNA targets can be designed and used in a sequence-targeted tandem hybridization approach to detect and quantitate the presence of a wide variety of microbial species in an environmental sample. For example, in the case of a given n-mer UFC, hybridization with a complex mixture of labeled genomic DNA fragments (derived from an environmental sample) is expected to yield hybridization signals at most sites in the array, and the majority of the fingerprint will be uninformative except for the few probes that are known to be species-specific. However, for each n-mer UFC probe that is known to hybridize at a unique site within a given sequenced genome, the flanking sequence (adjacent to the probe binding site) may be used to design a probe (of m-mer length) that will hybridize in tandem with the UFC probe. Then, if the hybridized sample is unlabeled and a collection of labeled m-mer “tandem probes” are included in the hybridization reaction (with subsequent ligation used to optionally covalently bond the stacked hybrids), then the pattern of hybridization signals will reveal the presence of sequences of length, n+m, within the sample, which can uniquely detect the presence of known species.

### Example 24

### Experimental Fingerprints of Bacterial Genomes

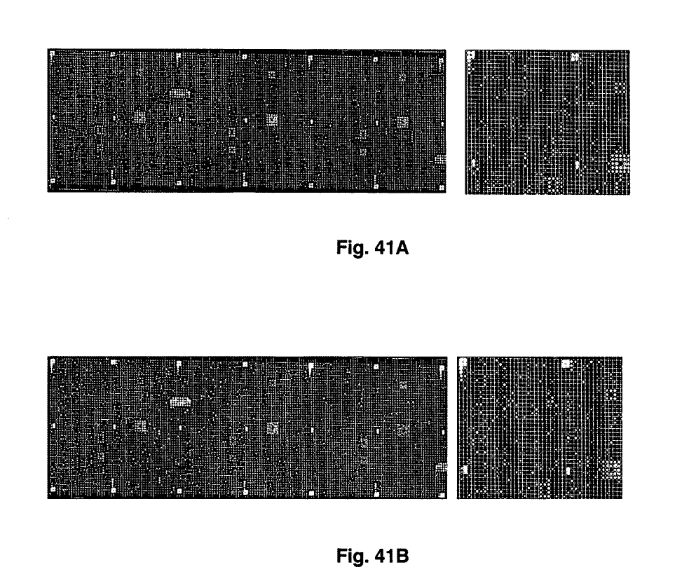

A 12,000-probe subset of the 15,624 13mer UFC probes designed as described in Example 9 were used to fingerprint bacterial genomic DNAs. “CustomArray 12K” microarrays containing the 12,000 UFC probes were fabricated by CombiMatrix Corporation (Mukilteo, Wash., USA) and used to fingerprint bacterial genomic DNAs. Purified genomic DNA from approximately 50 bacterial species was obtained from ATCC (Manassas, Va., USA). Approx. 1 microgram of bacterial genomic DNA was processed using the BioPrime Plus CGH Genomic Labeling System (Invitrogen, Carlsbad, Calif., USA), following the protocol recommended by Invitrogen and provided on their website. The Alexa Fluor 647-labeled product was hybridized with the CombiMatrix 12K chip overnight at 20 deg. C. in a Fisher hybridization oven, using the protocol recommended by CombiMatrix and provided on their website and slides were imaged using a ScanArray 5000 system. FIG. 41A-41B display a representative genomic fingerprint obtained with bacterial genomic DNA using the method described above. FIG. 41A shows the genomic fingerprint for Corynebacterium diphtheriae. The entire imaged slide is shown on the left and an expanded view of the upper left region of the slide is shown on the right. A 12,000-probe CustomArray containing probes with sequences complementary to those in the original set (arranged in the corresponding positions across the microarray) was also used to fingerprint various bacteria species, to obtain fingerprint data for both strands of the genome as suggested in Example 19. FIG. 41B displays the genomic fingerprint for Corynebacterium diphtheriae using the “complementary” probe set (entire slide on left, expanded view of upper left region on right). The two experimental fingerprints are clearly different, consistent with virtual hybridization fingerprint data for each strand of Escherichia coli (FIG. 39, Example 19). Thus, complementary UFC probe sets can be used to yield genomic fingerprints of the two complementary strands of a genome, which extends the information content of the genomic analysis and can provide additional statistical confidence in UFC-based species or strain identification. Fingerprints obtained using complementary UFC probe sets are expected to be most distinct when the hybridization is conducted under “nonstringent” conditions (such as low temperature, as done in the experimental fingerprinting described above). The rationale for this expectation is that mismatch-containing hybrids contribute substantially to the fingerprint under the “relaxed” hybridization conditions, and the distribution of stably mismatched probe-target binding sites is expected to differ along the two strands.

Further extending this line of reasoning, it is suggested that UFC-based genomic fingerprinting can be performed under two “operational modes” (employing both high and low stringency hybridization conditions to obtain substantially different fingerprints. Thus, when hybridization is carried out under stringent conditions (such as at a temperature near the Tm of the probe-target hybrids) the fingerprint should be dominated by perfect matches (high stringency mode), whereas when hybridization is carried out under low stringency conditions (such as lower temperature) the fingerprint should be dominated by mismatched hybrids (low stringency mode). Thus, it is anticipated that by using complementary probe sets and by conducting the hybridization under both high and low stringency conditions, four distinct genomic fingerprints may be obtained for a single genomic DNA sample, to significantly enhance the information content in the UFC analysis.

The strategy of conducting hybridization under reduced stringency conditions to yield fingerprints containing mismatched hybrids has two additional consequences which enhance the utility of the UFC approach. First, “reduced stringency” fingerprints, in which mismatched hybrids substantially contribute, are inherently more information-rich than “high stringency” fingerprints dominated by perfect matches. Due to the well known influence of nearest neighbor sequences on the stability of specific mismatch types, the “reduced stringency” mode of UFC analysis taps into a higher level of sequence-related effects (i.e., those related to mismatch occurrence and specificity) than the traditional “high stringency” hybridization strategy which seeks to avoid mismatches. Thus, a “mismatch-containing” fingerprint encompasses a wider range of target-probe interactions than a “perfect match-containing” fingerprint, and consequently represents a more complex reflection of the target sequence. In this way, by allowing the occurrence of the most stable mismatched hybrids, a reduced stringency fingerprint delves more deeply into the genomic sequence than the corresponding high stringency fingerprint.

Finally, performing UFC analysis under reduced stringency conditions may further alter the fingerprint pattern (compared with high stringency hybidization) due to effects on secondary or higher order structures that may form within the nucleic acid target, which may in some cases make certain potential probe binding sites inaccessible, or in other cases may create new binding sites by bringing noncontiguous sequences together or altering the nearest neighbor interactions.

A second consequence of allowing mismatch interactions relates to the number of hybridization signals, which will be inherently higher in a “low stringency” fingerprint than in a corresponding “high stringency” fingerprint due to the expanded repertoire of allowed interactions. This effect can be beneficial or detrimental, depending on the genetic complexity of the nucleic acid target that is being fingerprinted using UFC probes of a given length. For probes of a given length, if the genetic complexity of the target analyte is too low, the hybridization signals will populate only a small fraction of the array elements, making the information content correspondingly low. Conversely, if the genetic complexity of the target is too high the statistical occurrence of a given probe's perfect complement (as well as stably mismatched binding sites) within the target will be relatively high, and there will be too many hybridization signals (many due to binding of the probe to multiple sites within the target), effectively diminishing the information content of the fingerprint. Consequently, for high stringency hybridization fingerprinting, the range of genomic complexity (total length of unique target sequence) that can be analyzed using a probe set of a given length is limited. For example, a UFC comprised of 13mers would not be optimally suited to fingerprint the entire range of bacterial genome lengths (varying over an order of magnitude) if hybridization were conducted only under high stringency conditions. However, a UFC probe set of a certain probe length can effectively analyze a wider range of target sizes, by conducting hybridization at several degrees of stringency (utilizing changes in temperature or solution components) to vary the number of total hybridization signals that are produced. Therefore, since both perfectly matched and mismatched hybrids are informative in a fingerprint, it is possible to fine-tune the hybridization conditions to increase or decrease the number of stable mismatch-containing hybrids and thereby adjust the fraction of array elements that are populated in the fingerprint.

It is obvious that varying the probe length is another way to compensate for genome complexity. Another way is to create a reduced genetic complexity, for example by specifically amplifying and labeling a subset of the genome using PCR strategies. As discussed previously, yet another approach to increase the range of genome complexities that can be fingerprinted using a given UFC probe set is to vary the length and number of labeled stacking probes employed in the stacking hybridization fingerprinting approach described in Example 22.

### Example 25

### Design of UFCs Containing Alternative Probe Sets

It is within the scope of this invention to modify one or more steps in the basic UFC probe design strategy disclosed in Examples 1-9 and FIG. 2 to enable creation of numerous alternative UFC probe sets optimized for specific tasks. Individual design steps can be omitted, the order of steps can be rearranged, or compositional and clustering parameters can be adjusted, to generate probes varying in number, length, range of predicted Tm and thermodynamic stability, sequence diversity, and so on, in order to tailor the UFC probe set to function optimally in different UFC applications.

The latest version of the computer program implementing the UFC probe design strategy, named Universal3, enables user-defined options which can yield UFC probe sets containing higher numbers of probes, such as can be accommodated in the NimbleGen microarray platform, which currently holds 380,000 array elements. The following steps were followed to generate a UFC probe set consisting of 85,000 13mers (this number could be increased if desired).
1. Set the probe length.
2. Application of compositional parameters: Range of G+C content, absence of internal repeats and sequential entropy.
3. Build a list of all the available probes (list of available probes).
4. Define the desired number of probes.
5. Select by random a probe from the list of available probes.
6. Include the probe in a list of “selected probes”.
7. Select by random a new probe from the list of available probes.
8. Verify that the new probe is not listed yet in the list of “selected probes”. If it is, then reject this probe and select a new one from the list of available probes (step 7).
9. If the number of differences between the new probe and ALL the probes in the list of accepted probes is equal or higher than the minimum required (step 4), include this probe in the list of “selected probes”. If it is not, this probe is rejected.
10. Repeat steps 7 through 9 until obtaining the desired number of probes or manually stop the procedure (eg., if the run time is too long).
   The Delphi-Pascal source code for the Universal3 computer program achieving this task is attached, whereby associated program modules found in the folder named “Universal Probe Designer v3.”

The Universal Probe Designer program can be augmented by an auxiliary program called ProbeResizing to yield similarly large sets of probes having a narrow range of predicted Tm values, as exemplified below. A computer program named Resizing1 was developed which allows deriving a set of probes of different lengths and a narrow Tm range from a pre-existing set. In this example we start with a set of 85,000 13mers designed by the Universal3 program.

The set of probes is derived from an initial set of probes of a single length (in this case 85,000 13-mer probes). The new probes are built from the initial probes by adding bases to the 3′ and 5′ ends. The program uses a kind of algorithm called “greedy” because in each addition of bases selects from the four possibilities the base that gives the minimum difference between the Tm of the resized probe and a maximum allowed Tm. The maximum allowed Tm is defined by the user. The maximum length of the probes is fixed to 16-mer. Then, beginning with 13-mer probes, the program produces probes of 13mer, 14mer, 15mer and 16-mer. FIG. 41A is a graph showing the variation of the Tm vs the free energy for the original set of 13-mer probes, which consists of 85,000 probes with an initial Tm range from 53.9° C. to 65° C. (A Tm difference of 11.1° C.).

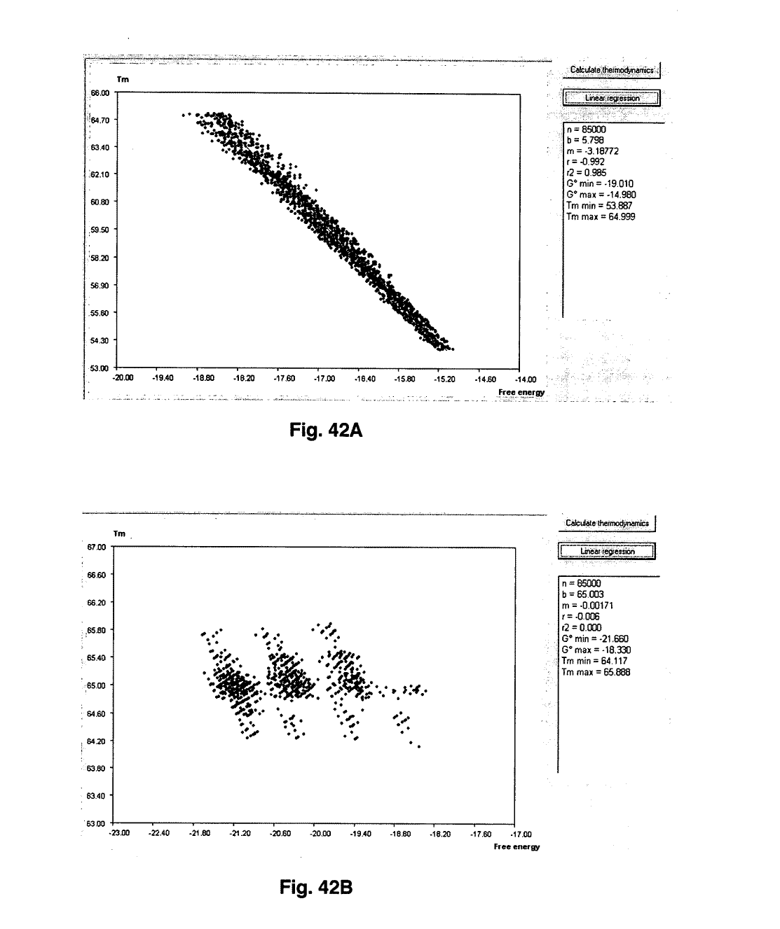

The use of the ProbeResizing program generates a new set of 85,000 probes of length, 13-16mer, with a Tm range of 64.12° C. to 65.89° C. (a Tm difference of 1.77° C.). FIG. 42A is a graph of Tm vs the free energy for the resized set, there is a narrow range of predicted Tm but four groupings of thermal stability. This is due to the fact that the linear relationship between Tm and thermal stability is different for different probe lengths. UFC probes sets of narrow predicted Tm range essentially provides a single degree of stringency for all members of the probe set, under a single hybridization condition. The source code for the Resizing1 computer program achieving the resizing/restricted Tm range task is attached, whereby associated program modules are found in the folder named “Probe Resizing v1.”

Applications of UFCs Containing Expanded Probe Sets

Implementation of UFCs in high density microarray platforms (such as those marketed by NimbleGen, Affymetrix and CombiMatrix) offers significant advantages in many fingerprinting applications. For example, NimbleGen microarrays can accommodate replicate probe sets (such as 4 copies of 95,000 probes), which provides increased statistical confidence in the hybridization results. Expansion of the number of probes in a UFC (eg., to 95,000 or 380,000 probes) also enables (due to increased numbers of hybridization signals) higher resolution detection of genomic sequence variations, thus facilitating identification of species or distinguishing closely related strains using UFCs.

High density UFCs can also enable the following “functional screening” strategy for optimizing a given UFC application. This functional screening approach begins with an initial discovery phase, in which a list of prospective UFC probes (generated by use of different adjustments in the design steps as outlined above) is incorporated into one or more high density microarrays, which are used in hybridization experiments to discover which probes work in the specific application. Next, the “nonfunctional” (“uninformative”) probes are discarded and the “functional” probes (identified through several rounds of functional screening) are combined into a UFC probe set that has optimal analytical power in the desired analysis. One example of how this functional screening strategy can work is as follows. First, the UFC probe design strategy could generate one or more prospective probe sets, each comprising 95,000 13mers. These could be incorporated into high density microarrays and used to fingerprint a collection of bacterial genomic DNA samples. Analysis of the fingerprints could reveal which prospective 13mer probes among the prospective probes are able to reproducibly distinguish between genomic DNAs within any given group of bacterial species or strains. Those probes that do not display species or strain-specific hybridization (and are therefore uninformative/nonfunctional in this application) would then be discarded, and the remaining, informative probes would be incorporated into an optimized UFC.

In the case of species whose genomic sequence is known, the above screening approach can be modified to employ virtual hybridization, rather than experimental hybridization, as the first step, to screen in silico numerous prospective probe sets and inexpensively and rapidly compile probe sets that are predicted to work optimally in the relevant UFC application.

The following references were cited herein:
Allawi and SantaLucia, Biochemistry 36:10581-10594 (1997).
Allawi and SantaLucia, Biochemistry 37:2170-2179 (1998a).
Allawi and SantaLucia, Nucl. Acids Res. 26:2694-2701 (1998b).
Allawi and SantaLucia, Biochemistry 37:9435-9444 (1998c).
Antonishyn et al., J. Clin. Microbiol. 38:4058-4065 (2000).
Baleiras-Couto et al., J. Appl. Bacteriol. 79:525-535 (1995).
Bart-Delabesse et al., J. Clin. Microbiol. 31:2933-2937 (1993).
Beattie, Genomic fingerprinting using oligonucleotide arrays. In Caetano-Anollés and Gresshoff (eds), DNA Markers. Protocols, Applications, and Overviews. Wiley-Liss, New York, pp. 213-224 (1997).
Belosludtsev et al., Biotechniques 37:654-660 (2004).
Bommarito et al., Nucl. Acids Res. 28:1929-1934 (2000).
Brunk et al., Appl. Environ. Microbiol. 62:872-879 (1996).
Burnie, J. Clin. Pathol. 45:324-327 (1992).
Busti et al., BMC Microbiol. 2:27 (2002).
Caetano-Anolles, Genome Res. 3:85-94 (1993).
Cangelosi et al., J. Clin. Microbiol. 42:2685-2693 (2004).
Cho and Tiedje, Applied and Environmental Microbiology 67:3677-3682 (2001).
Cormen et al., Introduction to algorithms, 2^{nd} Edition. MIT Press/McGraw-Hill, USA (2001).
Cormican et al., Diagn. Microbiol. Infect. Dis. 25:83-87 (1996).
Currie et al., J. Clin. Microbiol. 32:1188-1192 (1994).
Deplano et al., J. Clin. Microbiol. 38:3527-3533 (2000).
Desjardins et al., J. Mol. Evol. 41:440-448 (1995).
Diekema et al., Diagn. Microbiol. Infect. Dis. 29:147-153 (1997).
Drmanac et al., Genomics 37:29-40 (1996).
Elegado et al., Int. J. Food Microbiol. 95:11-18 (2004).
Felsenstein, Phylogeny Inference Package (Version 3.2). Cladistics 5:164-166 (1989).
Felsenstein, PHYLIP (Phylogeny Inference Package) version 3.6a3. Distributed by the author. Department of Genome Sciences, University of Washington, Seattle (2002).
Franzot et al., Infect. Immun. 66:89-97 (1988).
Gori et al., J. Clin. Microbiol. 34:2448-2453 (1996).
Gräser et al., J. Clin. Microbiol. 31:2417-2420 (1993).
Gusfield, Algorithms on strings, trees and sequences. Computer Science and Computational Biology. Cambridge Univ. Press (1997).
Hesselbarth and Schwarz, Vet. Microbiol. 45:11-17 (1995).
Hoheisel et al., Cell 73:109-120 (1993).
Jonas, J. Clin. Microbiol. 38:2284-2291 (2000).
Kersulyte et al., J. Clin. Microbiol. 33:2216-2219 (1995).
Kim et al., Proc. Natl. Acad. Sci, U.S.A. 96:13288-13293 (1999).
Kim et al., J. Bacteriol. 183:6585-6597 (2001).
Kingsley et al., Applied and Environmental Microbiology 68:6361-6370 (2002).
Kingsley et al., J. Clin. Microbiol. 33:2216-2219 (2002).
Koeleman et al., J. Clin. Microbiol. 36:2522-2529 (1998).
Kumar et al., Bioinformatics 17:1244-1245 (2001).
Lasker, J. Clin. Microbiol. 40:2886-2892 (2002).
Meier-Ewert et al., Nature 361:375-376 (1993).
Meier-Ewert et al., Nucleic Acids Res. 26:2216-2223 (1998).
Milosavljevic et al., Genome Res. 6:132-141 (1996).
Montesinos et al., J. Clin. Microbiol. 40:2119-2125 (2002).
Nguyen et al., Am. J. Med. 100:617-623 (1996).
Norman et al., JMB 292:251-262 (1999).
Otsuka et al., J. Clin. Microbiol. 42(8):3538-3548 (2004).
Page, Computer Applications in the Biosciences 12:357-358 (1996).
Pevzner, Computational Molecular Biology. An Algorithmic Approach. The MIT Press, USA, pp. 114-116 (2000).
Pontieri et al., J. Med. Microbiol. 45:173-178 (1996).
Priest et al., Microbiology 140:1015-1022 (1994).
Pujol et al., J. Clin. Microbiol. 35:2348-2358 (1997).
Pujol et al., Microbiology 145:2635-2646 (1999).
Reyes-Lopez et al., Nucleic Acids Res. 31:779-89 (2003).
Salazar et al., Nucleic Acids Res. 24:5056-5057 (1996).
SantaLucia, Proc. Natl. Acad. Sci. USA. 95:1460-1465 (1998).
Savelkoul et al., J. Clin. Microbiol. 37:3083-3091 (1999).
Schwartz and Cantor, Cell 37:67-75 (1984).
Skibsted et al., J. Hosp. Infect. 38:207-216 (1998).
Sullivan et al., J. Med. Microbiol. 44:399-408 (1996).
Theodoridis and Koutroumbas, Pattern recognition. Academic Press, USA. p 351-382 (1999).
Tyler et al., J. Clin. Microbiol. 35:339-346 (1997).
Valinsky et al., Appl. Envir. Microbiol. 68:3243-3250 (2002).
van Belkum et al., Bone Marrow Transplant. 13:811-815 (1994).
van Belkum et al., J. Infect. Dis. 169:1062-1070 (1994).
Vila et al., J. Med. Microbiol. 44:482-489 (1996).
Vincent et al., J. Bacteriol. 165:813-818 (1986).
Vos et al., Nucleic Acids Res. 23:4407-4414 (1995).
Wang et al., PLoS Biology 1:257-260 (2003).
Waterman, Introduction to computational biology: Maps, sequences and genomes. Chapman & Hall/CRC, USA (1995).
Welsh and McCelland, J. Clin. Microbiol. 33:1537-1547 (1995).
Willse et al., Nucleic Acids Res. 32:1848-1856 (2004).
Woods et al., J. Clin. Microbiol. 30:2921-2929 (1992).
Zhang et al., Nature Biotechnology 21:818-821 (2003).

What is claimed is:

1. A method of constructing a set of probes capable of analyzing the whole genomes of most prokaryotic and eukaryotic cells, said method comprising:
(a) selecting a length for the probes and generating a first list of all possible sequences for the selected probe length;
(b) generating a second list of sequences for the probes by selecting a set of compositional parameters selected from the group consisting of a range of G+C content, lack of internal base repetition longer than a specific length, a reasonable sequential entropy, avoiding the absence of any of the four bases, and avoiding sequences that form hairpin loops or dimers;
(c) applying substitution cluster to the second list of sequences, thereby generating a third list of sequences for the probes;
(d) randomizing the third list of sequences;
(e) removing terminal mismatches by a clustering method, thereby generating a fourth list of sequences for the probes;
(f) randomizing the fourth list of sequences;
(g) removing tandem mismatches by a clustering method, thereby generating a fifth list of sequences for the probes;
(h) performing base substitution to the fifth list of sequences to improve its mismatch discriminatory power, thereby generating a sixth list of sequences for the probes;
(i) narrowing the range of predicted Tm values for the probes when paired with their target sequences, thereby generating a seventh list of sequences for the probes; and
(j) optionally removing probe sequences that are likely to hybridize with abundant or repetitive sequences known to occur within prokaryotic and eukaryotic genomes, wherein the resulting probes are capable of analyzing the whole genomes of most prokaryotic and eukaryotic cells.

2. The method of claim 1, wherein the predicted Tm values for the probes are narrowed by removing sequences with low or high Tm values, or by dividing the probes into subsets of probes with a desired Tm range.

3. The method of claim 1, wherein the range of G+C content is 35% to 65%.

4. The method of claim 1, wherein the sequential entropy has a value greater than 0.5.

5. The method of claim 1, wherein the internal base repetition is not greater than 2 nucleotides.

6. The method of claim 1, wherein the substitution cluster generates a set of probes that have at least 3 nucleotide differences between each other.

7. The method of claim 1, wherein the terminal mismatches are removed by a method using block cluster.

8. The method of claim 7, wherein the block cluster has a block size of 10.

9. The method of claim 1, wherein the tandem mismatches are removed by a method using refined cluster.

10. The method of claim 1, wherein the base substitution results in sequences with the same G+C content but have a higher proportion of C and a lower proportion of G.

11. The method of claim 1, wherein the seventh list of probe sequences has a Tm variation of less than 20° C.

12. The method of claim 1, wherein the seventh list of probe sequences are divided into subsets, each having a Tm variation of less than 5° C.

13. The method of claim 1, wherein the abundant or repetitive sequences known to occur in a given biological sample is selected from the group consisting of sequences of rRNA genes, mitochondrial DNA, chloroplast DNA, Alu elements, LINE elements, insertion elements, and bacterial Rep sequences.

14. The method of claim 1, further comprises the step of validation by virtual hybridization.

15. The method of claim 1, wherein the length of the probes is from 8 nucleotides to 20 nucleotides.

16. The method of claim 1, wherein the probes are selected from the group consisting of DNA probes, RNA probes, and PNA probes.

17. A microarray comprising the probes generated according to the method of claim 1.

18. A microarray comprising the probes generated according to the method of claim 1 plus a corresponding set of complementary probes.

19. A method of identifying species within a biological sample, comprising:
(a) preparing a nucleic acid sample from the biological sample;
(b) labeling the nucleic acid sample;
(c) hybridizing the labeled nucleic acid sample with probes generated according to the method of claim 1;
(d) detecting and quantifying the label bound to each probe to generate a fingerprint image; and
(e) comparing the fingerprint image with a reference data set, wherein results from the comparison would identify the species in the biological sample.

20. The method of claim 19, wherein hybridization is conducted under reduced stringency whereby stably mismatched target-probe interactions contribute substantially to the fingerprint.

21. The method of claim 20, wherein the means for reducing the hybridization stringency is selected from the group consisting of reduced temperature, reduced counterion concentration and presence of formamide.

22. The method of claim 19, wherein the probes are arranged on a microarray.

23. The method of claim 19, wherein the probe set is augmented by addition of a complementary probe set.

24. The method of claim 19, wherein the nucleic acid sample is DNA or RNA.

25. A method of identifying species within a biological sample, comprising:
(a) preparing a nucleic acid sample from the biological sample;
(b) hybridizing the nucleic acid sample with probes generated according to the method of claim 1;
(c) using a DNA polymerase and fluorescently tagged 2′,3′-dideoxynucldoside triphosphate substrates to incorporate fluorescent tags onto the 3′-ends of said probes;
(d) detecting and quantifying the label incorporated into each probe to generate a fingerprint image; and
(e) comparing the fingerprint image with a reference data set, wherein results from the comparison would identify the species in the biological sample.

26. The method of claim 25, wherein hybridization is conducted under reduced stringency whereby stably mismatched target-probe interactions contribute substantially to the fingerprint.

27. The method of claim 26, wherein the means for reducing the hybridization stringency is selected from the group consisting of reduced temperature, reduced counterion concentration and presence of formamide.

28. The method of claim 25, wherein the probes are arranged on a microarray.

29. The method of claim 25, wherein the probe set is augmented by addition of a complementary probe set.

30. The method of claim 25, wherein the nucleic acid sample is DNA or RNA.

31. The method of claim 25, wherein a multiplicity of distinguishable fluorescent tags is used to simultaneously yield a multiplicity of distinguishable fingerprints.

32. A method of identifying species within a biological sample, comprising:
(a) preparing a nucleic sample from the biological sample;
(b) hybridizing the nucleic acid sample with the probes generated according to the method of claim 1 with a mixture of labeled stacking probes designed to hybridize in tandem with the probes generated according to the method of claim 1;
(c) optionally covalently linking tandemly hybridizing probes using DNA ligase;
(d) detecting and quantifying the label incorporated into each probe to generate a fingerprint image; and
(e) comparing the fingerprint image with a reference data set, wherein results from the comparison would identify the species in said biological sample.

33. The method of claim 32, wherein hybridization is conducted under reduced stringency whereby stably mismatched target-probe interactions contribute substantially to the fingerprint.

34. The method of claim 33, wherein the means for reducing the hybridization stringency is selected from the group consisting of reduced temperature, reduced counterion concentration and presence of formamide.

35. The method of claim 32, wherein the probes generated according to the method of claim 1 are arranged on a microarray.

36. The method of claim 32, wherein the probe set generated according to the method of claim 1 is augmented by addition of a complementary probe set.

37. The method of claim 32, wherein the mixture of labeled stacking probes comprises the entire set of probes or a subset thereof, generated according to the method of claim 1.

38. The method of claim 32, wherein a multiplicity of distinguishable labels are incorporated into different subsets of said stacking probes to simultaneously generate a multiplicity of fingerprint images.

39. The method of claim 32, wherein the hybridization conditions are selected such that tandem hybrids in which two probes hybridized to the target strand adjacent to each other in a contiguous stacking configuration are stable and wherein isolated probes do not stably hybridize to the target.

40. A method of defining phylogenetic relationships, comprising:
(a) preparing nucleic acid samples from a series of biological samples;
(b) hybridizing the nucleic acid samples with probes generated according to the method of claim 1 to generate fingerprints; and
(c) comparing the fingerprints with each other to create phylogenetic trees for the samples.

41. The method of claim 40, wherein hybridization is conducted under reduced stringency whereby stably mismatched target-probe interactions contribute substantially to the fingerprint.

42. The method of claim 41, wherein the means for reducing the hybridization stringency is selected from the group consisting of reduced temperature, reduced counterion concentration and presence of formamide.

43. The method of claim 40, wherein the probes are arranged on a microarray.

44. The method of claim 40, wherein the probe set is augmented by addition of a complementary probe set.

45. The method of claim 40, wherein the nucleic acid sample is DNA or RNA.

46. A method of differential gene expression profiling, comprising:
(a) preparing a first and a second nucleic acid samples from a first and second biological samples respectively;
(b) hybridizing the first and second nucleic acid samples with probes generated according to the method of claim 1, thereby generating a first and second fingerprint images; and
(c) comparing the first and second fingerprint images with each other to provide differential gene expression profiling.

47. The method of claim 46, wherein hybridization is conducted under reduced stringency whereby stably mismatched target-probe interactions contribute substantially to the fingerprint.

48. The method of claim 47, wherein the means for reducing the hybridization stringency is selected from the group consisting of reduced temperature, reduced counterion concentration and presence of formamide.

49. The method of claim 46, wherein the probes are arranged on a microarray.

50. The method of claim 46, wherein the probe set is augmented by addition of a complementary probe set.

51. The method of claim 46, wherein the nucleic acid samples are cDNA samples or RNA samples.

52. A method of detecting a single base change in a target nucleic acid, comprising:
(a) attaching onto a solid support probes generated according to the method of claim 1;
(b) hybridizing a first oligonucleotide probe with the target nucleic acid, wherein the first oligonucleotide probe comprises (i) a first end comprising sequences complementary to the probes attached to the solid support, and (ii) a second end comprising a nucleotide complementary to the single base change in the target nucleic acid;
(c) annealing a labeled second oligonucleotide probe to the target nucleic acid, wherein the second oligonucleotide probe is ligated to the second end of the first oligonucleotide probe, thereby generating a labeled ligated product; and
(d) hybridizing the labeled ligated product with the probes attached to the solid support, wherein detection of the labeled product on the solid support indicates the presence of the single base change in the target nucleic acid.

53. The method of claim 19, wherein hybridization is conducted under reduced stringency whereby stably mismatched target-probe interactions contribute substantially to the fingerprint.

54. The method of claim 53, wherein the means for reducing the hybridization stringency is selected from the group consisting of reduced temperature, reduced counterion concentration and presence of formamide.

55. The method of claim 52, wherein the solid support is a microarray substrate.

56. The method of claim 52, wherein the probe set is augmented by addition of a complementary probe set.

57. The method of claim 52, wherein the second oligonucleotide probe is labeled with a fluorescent tag.

58. The method of claim 52, wherein the probes to be attached to the solid support are selected according to the steps of:
performing virtual hybridization of said set of probes generated according to the method of claim 1 against the nucleotide sequences comprising said target nucleic acid sample to identify members of said set of oligonucleotide probes which may hybridize to said nucleic acid sample; and
eliminating from the set of oligonucleotide probes to be attached to the solid support those probes that are predicted to stably hybridize with said nucleic acid sample.


SEQUENCE LISTING (35 sequences)

SEQ ID NO: 1 - DNA, 12 bp, artificial sequence
  hybridization probe
ttcatcagtgtc

SEQ ID NO: 2 - DNA, 9 bp, artificial sequence
  example of a repeated sequence that can occur frequently in a microarray containing all 4n combinations of probes of length n
aaaaaaaaa

SEQ ID NO: 3 - DNA, 10 bp, artificial sequence
  example of a repeated sequence that can occur frequently in a microarray containing all 4n combinations of probes of length n
gcgcgcgcgc

SEQ ID NO: 4 - DNA, 13 bp, artificial sequence
  6..8: example of a oligonucleotide where n is a,t, g, or c at positions 6,7 and 8 and n at positions 6 and 8 perfectly pair with n at positions 6 and 8 in SEQ ID NO: 5
gatcgnnncgatc

SEQ ID NO: 5 - DNA, 13 bp, artificial sequence
  6..8: example of a oligonucleotide where n is a,t, g, or c at positions 6,7 and 8 and n at positions 6 and 8 perfectly pair with n at positions 6 and 8 in SEQ ID NO: 4
ctagcnnngctag

SEQ ID NO: 6 - DNA, 8 bp, artificial sequence
  example of a sequence used to demonstrate sequential entropy calculations
aaccggtt

SEQ ID NO: 7 - DNA, 8 bp, artificial sequence
  example of a sequence used to demonstrate sequential entropy calculations
aaaaaaaa

SEQ ID NO: 8 - DNA, 8 bp, artificial sequence
  example of a sequence used to demonstrate sequential entropy calculations
acacacac

SEQ ID NO: 9 - DNA, 8 bp, artificial sequence
  example of a sequence used to demonstrate sequential entropy calculations
acgtcgta

SEQ ID NO: 10 - DNA, 8 bp, artificial sequence
  sequence designed to have no matching nearest neighbors to demonstrate sequential entropy calculations
acagtcga

SEQ ID NO: 11 - DNA, 9 bp, artificial sequence
  example sequence designed to be substituted with adenosine using substitution pattern 010010000
actaagtat

SEQ ID NO: 12 - DNA, 9 bp, artificial sequence
  example of substituted sequence using the substitution pattern 010010000
aatacgtat

SEQ ID NO: 13 - DNA, 9 bp, artificial sequence <220
  example of substituted sequence using the substitution pattern 010010000
agtacgtat

SEQ ID NO: 14 - DNA, 9 bp, artificial sequence
  example of substituted sequence using the substitution pattern 010010000
attacgtat

SEQ ID NO: 15 - DNA, 9 bp, artificial sequence
  example of substituted sequence using the substitution pattern 010010000
aataggtat

SEQ ID NO: 16 - DNA, 9 bp, artificial sequence
  example of substituted sequence using the substitution pattern 010010000
agtaggtat

SEQ ID NO: 17 - DNA, 9 bp, artificial sequence
  example of substituted sequence using the substitution pattern 010010000
attaggtat

SEQ ID NO: 18 - DNA, 9 bp, artificial sequence
  example of substituted sequence using the substitution pattern 010010000
aatatgtat

SEQ ID NO: 19 - DNA, 9 bp, artificial sequence
  example of substituted sequence using the substitution pattern 010010000
agtatgtat

SEQ ID NO: 20 - DNA, 9 bp, artificial sequence
  example of substituted sequence using the substitution pattern 010010000
attatgtat

SEQ ID NO: 21 - DNA, 4 bp, artificial sequence
  example of a sequence with the same value of Shannon′s entropy based on dimer content as SEQ ID NO: 22
aatt

SEQ ID NO: 22 - DNA, 4 bp, artificial sequence
  example of a sequence with the same value of Shannon′s entropy based on dimer content as SEQ ID NO: 21
acgt

SEQ ID NO: 23 - DNA, 14 bp, artificial sequence
  example of a probe designed as a mark of the cluster for substitution clustering
acgtatgctggatc

SEQ ID NO: 24 - DNA, 14 bp, artificial sequence
  example of substituted probe derived from the mark with one substitution
acgtatgcaggatc

SEQ ID NO: 25 - DNA, 14 bp, artificial sequence
  example of substituted probe derived from the mark with one substitution
acgtatgccggatc

SEQ ID NO: 26 - DNA, 14 bp, artificial sequence
  example of substituted probe derived from the mark with one substitution
acgtatgcgggatc

SEQ ID NO: 27 - DNA, 11 bp, artificial sequence
  example of a probe sequence designed as a mark of the cluster for block clustering
ctcgtcgacgt

SEQ ID NO: 28 - DNA, 11 bp, artificial sequence
  example of a probe sequence designed to share a block of the mark of SEQ ID NO: 27
acgtcgacgtc

SEQ ID NO: 29 - DNA, 14 bp, artificial sequence
  example of a probe designed as a mark of the cluster for refining clustering
acaaatcgacgtcg

SEQ ID NO: 30 - DNA, 14 bp, artificial sequence
  example of probe sequence aligned to the mark
actcgtcgacgtcg

SEQ ID NO: 31 - DNA, 14 bp, artificial sequence
  example of probe sequence slid from the mark
tactcgtcgacgtc

SEQ ID NO: 32 - DNA, 13 bp, artificial sequence
  example sequence designed to share at least one block of three identical sequences with SEQ ID NO: 33 to demonstrate filtration rules for inexact sequence comparison
acgtgctatcctt

SEQ ID NO: 33 - DNA, 13 bp, artificial sequence
  example sequence designed to share at least one block of three identical sequences with SEQ ID NO: 32 to demonstrate filtration rules for inexact sequence comparison
acctgctagccat

SEQ ID NO: 34 - DNA, 32 bp, artificial sequence
  sequence used to verify hybridization
gtgcttgactgacactgatgaacgtacgtatg

SEQ ID NO: 35 - DNA, 32 bp, artificial sequence
  sequence used to verify hybridization
gcgctacactgacactgatgaacgaacgaatg